(19) United States
(12) Patent Application Publication
(10) Pub. No.: US 2026/0122614 A1
(43) Pub. Date: Apr. 30, 2026

(54) METHOD AND DEVICE FOR TRANSMITTING/RECEIVING PAGING INFORMATION IN SATELLITE COMMUNICATION SYSTEM

(71) Applicant: Samsung Electronics Co., Ltd., Gyeonggi-do (KR)

(72) Inventors: Sungjin PARK, Gyeonggi-do (KR); Youngbum KIM, Gyeonggi-do (KR); Younsun KIM, Gyeonggi-do (KR); Hyunsuk RYU, Gyeonggi-do (KR)

(21) Appl. No.: 19/003,199

(22) Filed: Dec. 27, 2024

(30) Foreign Application Priority Data
Dec. 27, 2023 (KR) 10-2023-0193730

(51) Int. Cl. H04W 68/02; H04W 84/06

(52) U.S. Cl. CPC H04W 68/02; H04W 84/06

(57) ABSTRACT

The disclosure relates to a fifth generation (5G) or sixth generation (6G) communication system for supporting a higher data transmission rate. A method and device for efficiently transmitting/receiving paging information in a satellite communication system. According to an embodiment, a method for receiving, from a network, first configuration information related to repeated transmission of paging information; receiving, from the network, DL control information (DCI) indicating the repeated transmissions of the paging information and a number of the repeated transmissions based on the first configuration information; and receiving, from the network, the paging information repeatedly transmitted by the number of the repeated transmissions based on the DCI.

### CROSS-REFERENCE TO RELATED APPLICATION(S)

This application is based on and claims priority under 35 U.S.C. § 119 to Korean Patent Application No. 10-2023-0193730, which was filed in the Korean Intellectual Property Office on Dec. 27, 2023, the entire disclosure of which is incorporated herein by reference.

### BACKGROUND

### 1. Field

The disclosure relates generally to the operation of a user equipment (UE) and a base station (BS) in a satellite communication system, and more particularly, to a method for transmitting/receiving paging information in a satellite communication system and a device capable of performing the same.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement sixth generation (6G) mobile communication technologies referred to as Beyond 5G systems in terahertz (THz) bands (for example, 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of the bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for NR to simplify RA procedures. There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Despite the advances in wireless communications, there is a need in the art for a method and apparatus for efficiently transmitting/receiving paging information in a satellite communication system.

### SUMMARY

The disclosure has been made to address at least the above-mentioned problems and/or disadvantages and to provide at least the advantages described below.

Accordingly, an aspect of the disclosure is to provide a method and device for efficiently transmitting/receiving paging information in a satellite communication system.

In accordance with an aspect of the disclosure, a method by a UE in a satellite communication system includes receiving, from a network, first configuration information related to repeated transmission of paging information, receiving, from the network, downlink control information (DCI) indicating the repeated transmission of the paging information and a number of the repeated transmissions including information related to repeated transmissions based on the first configuration information, and receiving, from the network, the paging information repeatedly transmitted by the number of the repeated transmissions based on the DCI.

In accordance with an aspect of the disclosure, a UE in a satellite communication system includes a transceiver, and at least one processor configured to receive, from a network, first configuration information related to repeated transmission of paging information, receive, from the network, DCI indicating the repeated transmissions of the paging information and a number of the repeated transmissions including information related to repeated transmissions based on the first configuration information, and receive, from the network, the paging information repeatedly transmitted by the number of the repeated transmissions based on the DCI.

In accordance with an aspect of the disclosure, a method by a BS in a satellite communication system includes transmitting, to a UE, first configuration information related to repeated transmission of paging information, transmitting, to the UE, DCI including information related to repeated transmissions indicating the repeated transmissions of the paging information and a number of repeated transmissions based on the first configuration information, and repeatedly transmitting, to the UE, the paging information by the number of repeated transmissions based on the DCI.

In accordance with an aspect of the disclosure, a BS in a satellite communication system includes a transceiver, and at least one processor configured to transmit, to a UE, first configuration information related to repeated transmission of paging information, transmit, to the UE, DCI indicating the repeated transmissions of the paging information and a number of the repeated transmissions based on the first configuration information, and repeatedly transmit, to the UE, the paging information by the number of repeated transmissions based on the DCI.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a basic structure of a time-frequency domain in a wireless communication system according to an embodiment;

FIG. 2 illustrates the structures of a frame, a subframe, and a slot in a wireless communication system according to an embodiment;

FIG. 3 illustrates an example of a BWP configuration in a wireless communication system according to an embodiment;

FIG. 4 illustrates an example configuration of a control region of a DL control channel in a wireless communication system according to an embodiment;

FIG. 5 illustrates a structure of a DL control channel in a wireless communication system according to an embodiment;

FIG. 6 illustrates, via span, when a UE may have a plurality of physical downlink control channel (PDCCH) monitoring positions in a slot in a wireless communication system according to an embodiment;

FIG. 7 illustrates an example of BS beam allocation according to a transmission configuration indication (TCI) state configuration in a wireless communication system according to an embodiment;

FIG. 8 illustrates an example of a TCI state allocation method for a PDCCH in a wireless communication system according to an embodiment;

FIG. 9 illustrates a TCI indication medium access control (MAC) control element (CE) signaling structure for a PDCCH demodulation reference signal (DMRS) in a wireless communication system according to an embodiment;

FIG. 10 illustrates an example of a beam configuration of a search space and a control resource set (CORESET) in a wireless communication system according to an embodiment;

FIG. 11 illustrates a method for transmitting/receiving data considering a DL data channel and rate matching resource by a BS and a UE in a wireless communication system according to an embodiment;

FIG. 12 illustrates a method for selecting a CORESET receivable considering priority when a UE receives a DL control channel in a wireless communication system according to an embodiment;

FIG. 13 illustrates an example of an aperiodic channel state information (CSI) reporting method according to an embodiment;

FIG. 14 illustrates an example of physical UL shared channel (PUSCH) repeated transmission type B in a wireless communication system according to an embodiment;

FIG. 15 illustrates radio protocol structures of a BS and a UE in single cell, carrier aggregation (CA), and dual connectivity situations in a wireless communication system according to an embodiment;

FIG. 16 illustrates an antenna port configuration and a resource allocation example for cooperative communication in a wireless communication system according to an embodiment;

FIG. 17 illustrates an example of a DCI configuration for cooperative communication in a wireless communication system according to an embodiment;

FIG. 18 illustrates a procedure of controlling UE transmission power by a BS in a cellular system;

FIG. 19 illustrates a process of generating type-1 (semi-static) HARQ-ACK codebook by a UE according to an embodiment;

FIG. 20 illustrates a process of generating type-2 (dynamic) HARQ-ACK codebook by a UE according to an embodiment;

FIG. 21 illustrates the Earth orbital period of a communication satellite depending on the altitude or height of the satellite according to an embodiment;

FIG. 22 illustrates a method for repetitively transmitting UE paging information according to an embodiment;

FIG. 23 is a flowchart illustrating a procedure of receiving PUSCH repeated transmission including paging information according to an embodiment;

FIG. 24 illustrates a structure of a UE in a wireless/satellite communication system according to an embodiment; and

FIG. 25 illustrates a structure of a BS in a wireless/satellite communication system according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Terms indicating a network entity or a network function and entities of an edge computing system, and terms indicating messages and identification information used in the disclosure are provided for convenience of description. Accordingly, the disclosure is not limited to the terms described below, and other terms indicating an object having an equivalent technical meaning may be used.

Hereinafter, embodiments of the disclosure are described in detail with reference to the accompanying drawings. Hereinafter, the BS may be an entity allocating resource to the UE and may be at least one of a satellite, gateway, ground station, gNode B, gNB, eNode B, Node B, BS, wireless access unit, BS controller, or node over network. Further, in the disclosure, the BS may be a BS included in the satellite or a BS on the ground. The terminal may include a UE, MS (mobile station), cellular phone, smartphone, computer, or multimedia system capable of performing communication functions. Although 5G or next-generation system is described herein, the disclosure may also apply to other communication systems with similar technical background or channel form. For example, LTE or LTE-A mobile communication and post-5G mobile communication technology may be included therein. Embodiments of the disclosure may be modified in such a range as not to significantly depart from the scope of the disclosure under the determination by one of ordinary skill in the art and such modifications may be applicable to other communication systems. The contents of the disclosure are applicable to FDD and TDD systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In the disclosure, higher layer signaling may correspond to at least one or a combination of one or more of the following signaling.
Master information block (MIB)
System information block (SIB) or SIB X (X=1, 2, . . . )
Radio resource control (RRC)
MAC CE

L1 signaling may correspond to at least one or a combination of one or more of the following physical layer channels or signaling methods using signaling.
PDCCH
DCI
UE-specific DCI
Group common DCI
Common DCI
Scheduling DCI used for scheduling downlink (DL) or uplink (UL) data
Non-scheduling DCI (e.g., DCI not for scheduling DL or UL data
Physical UL control channel (PUCCH)
UL control information (UCI)

Herein, the term UE may refer to any component, such as a mobile station, subscriber station, remote terminal, wireless terminal, receive point, or user device. For convenience, the term UE is used to refer to a device that accesses a BS regardless of whether it needs to be considered as a mobile device (such as a mobile phone or a smart phone) or a stationary device (such as a desktop computer or vending machine). For convenience of description below, the terminal is referred to as a UE.

Herein, the term timing advance (TA) may be used interchangeably with TA information, TA value, or TA index.

Data or control information transmitted by the BS to the UE may be referred to as a first signal, and an UL signal associated with the first signal may be referred to as a second signal. For example, the first signal may include a DCI, UL grant, PDCCH, physical DL shared channel (PDSCH), random access response (RAR), etc., and the second signal associated with the first signal may include a PUCCH, PUSCH, msg 3, etc.

There may be an association between the first signal and the second signal. For example, when the first signal is a PDCCH including a UL grant for UL data scheduling, the second signal corresponding to the first signal may be a PUSCH including UL data. Meanwhile, a gap between transmission/reception times of the first signal and the second signal may be a value predetermined between the UE and the BS. Alternatively, the difference between the transmission/reception times of the first signal and the second signal may be indicated and determined by the BS or may be determined by the value transferred by higher layer signaling. Hereinafter, the higher layer signaling may be simply referred to as a higher signal.

Hereinafter, the BS may be an entity allocating resource to terminal and may be at least one of gNode B, eNode B, Node B, wireless access unit, BS controller, or node over network. The UE may include a UE, MS (mobile station), cellular phone, smartphone, computer, or multimedia system capable of performing communication functions. The DL refers to a wireless transmission path of signal transmitted from the BS to the terminal, and the UL refers to a wireless transmission path of signal transmitted from the terminal to the BS. Although LTE or LTE-A systems may be described below as an example, the embodiments may be applied to other communication systems having a similar technical background or channel pattern. For example, 5G mobile communication technology (5G, new radio, NR) developed after LTE-A may be included therein, and 5G below may be a concept including legacy LTE, LTE-A and other similar services. The embodiments may be modified in such a range as not to significantly depart from the scope of the disclosure under the determination by one of ordinary skill in the art and such modifications may be applicable to other communication systems.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. The components and ‘units’ may be implemented to execute one or more CPUs in a device or secure multimedia card. According to embodiments, a “ . . . unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

Wireless communication systems evolve beyond voice-centered services to broadband wireless communication systems to provide high data rate and high-quality packet data services, such as 3rd generation partnership project (3GPP) high speed packet access (HSPA), long term evolution (LTE) or evolved universal terrestrial radio access (E-UTRA)), LTE-advanced (LTE-A), LTE-pro, 3GPP2 high rate packet data (HRPD), ultra mobile broadband (UMB), and institute of electrical and electronics engineers (IEEE) 802.16e communication standards.

As a representative example of such broadband wireless communication system, the LTE system adopts orthogonal frequency division multiplexing (OFDM) for DL and single carrier frequency division multiple access (SC-FDMA) for the UL, which is a wireless link where the UE or MS transmits data or control signals to the BS, or eNode B, and download means a wireless link where the BS transmits data or control signals to the UE. Such multiple access scheme may typically allocate and operate time-frequency resources carrying data or control information per user not to overlap, i.e., to maintain orthogonality, to thereby differentiate each user's data or control information.

Post-LTE communication systems, e.g., 5G communication systems, are required to freely reflect various needs of users and service providers and thus to support services that simultaneously meet various requirements. Services considered for 5G communication systems include, e.g., eMBB, mMTC, and URLLC.

eMBB aims to provide a further enhanced data transmission rate as compared with LTE, LTE-A, or LTE-pro. For example, eMBB for 5G communication systems needs to provide a peak data rate of 20 Gbps on download and a peak data rate of 10 Gbps on the UL in terms of one BS. 5G communication systems also need to provide an increased user perceived data rate while simultaneously providing such peak data rate. To meet such requirements, various transmit (TX)/receive (RX) techniques, as well as MIMO, should be further enhanced. While LTE adopts a TX bandwidth up to 20 MHz in the 2 GHz band to transmit signals, the 5G communication system employs a broader frequency bandwidth in a frequency band ranging from 3 GHz to 6 GHz or more than 6 GHz to meet the data rate required for 5G communication systems.

mMTC is also considered to support application services, such as internet of things (IoT) in the 5G communication system. To efficiently provide IoT, mMTC is required to support massive UEs in the cell, enhance the coverage of the UE and the battery time, and reduce UE costs. IoT terminals are attached to various sensors or devices to provide communication functionality, and thus, it needs to support a number of UEs in each cell (e.g., 1,000,000 UEs/km²). Since mMTC-supportive UEs, by the nature of service, are highly likely to be located in shadow areas not covered by the cell, such as the underground of a building, it may require much broader coverage as compared with other services that the 5G communication system provides. mMTC-supportive UEs, due to the need for being low cost and difficulty in frequently exchanging batteries, may be required to have a very long battery life, e.g., 10 years to 15 years.

URLLC is a mission-critical, cellular-based wireless communication service. For example, URLLC may be considered for use in remote control for robots or machinery, industrial automation, unmanned aerial vehicles, remote health care, or emergency alert. This requires that URLLC provide very low-latency and very high-reliability communication. For example, URLLC-supportive services need to meet an air interface latency of less than 0.5 milliseconds simultaneously with a packet error rate of 10- or less. Thus, for URLLC-supportive services, the 5G communication system may be required to provide a shorter transmit time interval (TTI) than those for other services while securing reliable communication links by allocating a broad resource in the frequency band.

The three 5G services, i.e., eMBB, URLLC, and mMTC, may be multiplexed in one system and be transmitted. In this case, the services may adopt different TX/RX schemes and TX/RX parameters to meet their different requirements. Of course, 5G is not limited to the above-described three services.

### NR Time-Frequency Resource

The frame structure of the 5G system is described below in more detail with reference to the drawings.

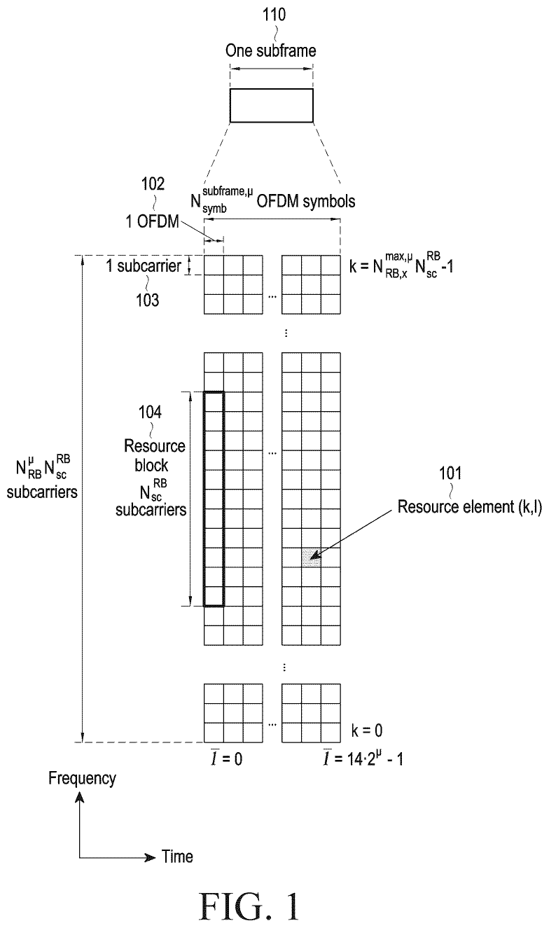

FIG. 1 illustrates a basic structure of a time-frequency domain, which is a radio resource region in which data or control channels are transmitted in a 5G system.

In FIG. 1, the horizontal axis refers to the time domain, and the vertical axis refers to the frequency domain. A basic unit of a resource in the time and frequency domain is a resource element (RE) 101, which may be defined by one OFDM symbol 102 on the time axis, and by one subcarrier 103 on the frequency axis. In the frequency domain.

$${N}_{SC}^{RB}$$

(e.g., 12) consecutive REs may constitute one resource block (RB) 104.

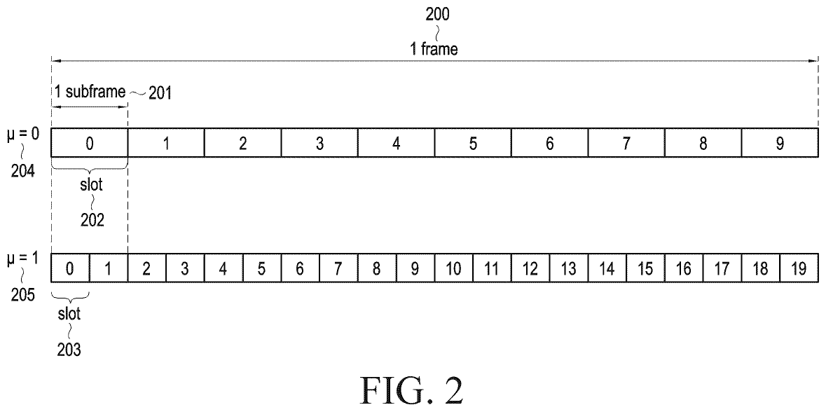

FIG. 2 illustrates the structures of a frame, a subframe, and a slot in a wireless communication system according to an embodiment.

FIG. 2 illustrates example structures of a frame 200, a subframe 201, and a slot 202. One frame 200 may be defined as 10 ms. One subframe 201 may be defined as 1 ms, and thus, one frame 200 may consist of a total of 10 subframes 201. One slot 202 or 203 may be defined as 14 OFDM symbols (that is, the number

$$( {N}_{symbol}^{slot} )$$

of symbols per slot=14). One subframe 201 may be composed of one or more slots 202 and 203, and the number of slots 202 and 203 per subframe 201 may differ depending on (204 or 205), which is a set value for the subcarrier spacing. FIG. 2 illustrates an example in which the subcarrier spacing setting value μ=0 (204) and an example in which the subcarrier spacing setting value μ=1 (205). When μ=0 (204), one subframe 201 may consist of one slot 202, and when μ=1 (205), one subframe 201 may consist of two slots (203). In other words, according to the set subcarrier spacing value μ, the number

$$( {N}_{slot}^{subframe , μ} )$$

of slots per subframe may vary, and accordingly, the number

$$( {N}_{slot}^{frame , μ} )$$

of slots per frame may differ. According to each subcarrier spacing, μ

$${N}_{slot}^{subframe , μ} and {N}_{slot}^{frame , μ}$$

may be defined in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

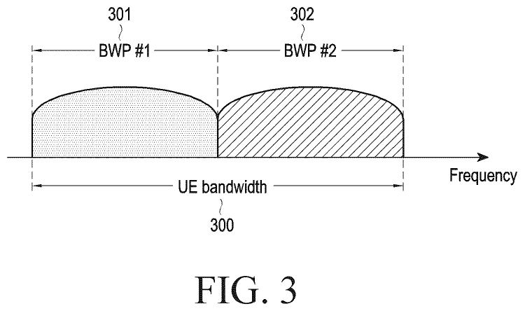

FIG. 3 illustrates an example of a BWP configuration in a wireless communication system according to an embodiment.

FIG. 3 illustrates an example in which a UE bandwidth 300 is divided into two BWPs, e.g., BWP #1 301 and BWP #2 302. The BS may configure one or more BWPs in the UE and may configure the following information shown below in Table 2 for each BWP.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |

}

However, without being limited thereto, other various BWP-related parameters than the above-described configuration information may be configured in the UE. The BS may transfer the information to the UE through higher layer signaling, e.g., RRC signaling. At least one BWP among one or more configured BWPs may be activated. Whether to activate the configured BWP may be transferred from the BS to the UE semi-statically through RRC signaling or dynamically through DCI.

Prior to RRC connected, the UE may be configured with an initial BWP for initial access by the BS via an MIB. More specifically, the UE may receive configuration information for a search space and CORESET in which a PDCCH may be transmitted to receive system information (SI) (e.g., remaining system information (RMSI) or SIB 1, which may correspond to SIB1) necessary for initial access through the MIB in the initial access phase. Each of the control region and search space configured with the MIB may be regarded as identifier (ID) 0. The BS may provide the UE with configuration information, such as frequency allocation information, time allocation information, and numerology for control region #0, via the MIB. The BS may provide the UE with configuration information for occasion and monitoring period for control region #0, i.e., configuration information for search space #0, via the MIB. The UE may regard the frequency range set as control region #0 obtained from the MIB, as the initial BWP for initial access. In this case, the ID of the initial BWP may be regarded as 0.

The configuration of the BWP supported in 5G described above may be used for various purposes.

According to an embodiment, when the bandwidth supported by the UE is smaller than the system bandwidth, this may be supported through the BWP configuration. For example, as the BS configures the UE with the frequency position (configuration information 2) of the BWP, the UE may transmit/receive data in a specific frequency position in the system bandwidth.

According to an embodiment, for the purpose of supporting different numerologies, the BS may configure the UE with a plurality of BWPs. For example, to support data transmission/reception using a subcarrier spacing of 15 kHz and a subcarrier spacing of 30 kHz for some UE, the BS may configure the UE with two bandwidths, as subcarrier spacings of 15 kHz and 30 kHz. The different BWPs may be frequency division multiplexed and, when data is transmitted/received at a specific subcarrier spacing, the BWP configured as the corresponding subcarrier spacing may be activated.

According to an embodiment, for the purpose of reducing power consumption of the UE, the BS may configure the UE with BWPs having different sizes of bandwidths. For example, when the UE supports a bandwidth exceeding a very large bandwidth, e.g., a bandwidth of 100 MHz, and transmits/receives data always using the bandwidth, significant power consumption may occur. In particular, it is very inefficient in terms of power consumption to monitor an unnecessary DL control channel using a large bandwidth of 100 MHz in a situation where there is no traffic. For the purpose of reducing power consumption of the UE, the BS may configure a BWP of a relatively small bandwidth to the UE, e.g., a BWP of 20 MHz, in the UE. In a no-traffic situation, the UE may perform monitoring in the 20 MHz bandwidth and, if data occurs, the UE may transmit/receive data in the 100 MHz bandwidth according to an instruction from the BS.

In a method for configuring a BWP, UEs before RRC connected may receive configuration information for an initial bandwidth via an MIB in the initial access phase. More specifically, the UE may be configured with a control region (e.g., a CORESET) for the DL control channel where the DCI scheduling the SIB may be transmitted from the MIB of the physical broadcast channel (PBCH). The bandwidth of the configured by the MIB may be regarded as the initial BWP, and the UE may receive the PDSCH, which transmits the SIB, via the configured initial BWP. The initial BWP may be utilized for other SI (OSI), paging, and RA as well as for receiving SIB.

### BWP Change

If the UE is configured with one or more BWPs, the BS may indicate, to the UE, a change (or switching or transition) in BWP using the BWP indicator in the DCI. As an example, when the currently activated BWP of the UE is BWP #1 301 in FIG. 3, the BS may indicate, to the UE, BWP #2 302 with the BWP indicator in the DCI, and the UE may change the BWP to BWP #2 302, indicated with the BWP indicator in the received DCI.

As described above, since DCI-based BWP changing may be indicated by the DCI scheduling PDSCH or PUSCH, the UE, if receiving a BWP change request, is supposed to be able to receive or transmit the PDSCH or PUSCH, scheduled by the DCI, in the changed BWP without trouble. To that end, the standard specified requirements for delay time T_{BWP} required upon changing BWP, which may be defined in Table 3 as follows.

TABLE 3

| | |
|---|---|
| | BWP switch delay |
| NR Slot | T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
^{Note 2}If the BWP switch involves changing of SCS, the BWP switch delay is determined by the larger one between the SCS before BWP switch and the SCS after BWP switch.

The requirement for delay of BWP change supports type 1 or type 2 according to the capability of the UE. The UE may report a supportable BWP delay time type to the BS.

If the UE receives, in slot n, DCI including a BWP change indicator according to the above-described requirements for BWP change delay time, the UE may complete a change to the new BWP, indicated by the BWP change indicator, at a time not later than slot n+T_{BWP}, and may perform transmission/reception on the data channel scheduled by the DCI in the changed, new BWP. Upon scheduling data channel in the new BWP, the BS may determine time domain resource allocation for data channel considering the UE's BWP change delay time T_{BWP}. In other words, when scheduling a data channel with the new BWP, in a method for determining a time domain resource allocation for the data channel, the BS may schedule a corresponding data channel after the BWP change delay time. Thus, the UE may not expect that the DCI indicating the BWP change indicates a slot offset (K0 or K2) smaller than the BWP change delay time (T_{BWP}).

If the UE has received the DCI (e.g., DCI format 1_1 or 0_1) indicating the BWP change, the UE may perform no transmission or reception during the time period from the third symbol of the slot in which the PDCCH including the DCI has been received to the start point of the slot indicated by the slot offset (K0 or K2) value indicated by the time domain resource allocation indicator field in the DCI. For example, if the UE receives the DCI indicating a BWP change in slot n, and the slot offset value indicated by the DCI is K, the UE may perform no transmission or reception from the third symbol of slot n to a symbol before slot n+K (i.e., the last symbol of slot n+K−1).

### SS/PBCH Block

The synchronization signal (SS)/PBCH block indicates a physical layer channel block composed of primary SS (PSS), secondary SS (SSS), and PBCH. Details are as follows.

PSS: A signal that serves as a reference for DL time/frequency synchronization and provides part of the information for cell ID

SSS: serves as a reference for DL time/frequency synchronization, and provides the rest of the information for cell ID, which PSS does not provide. Additionally, it may serve as a reference signal for demodulation of PBCH.

PBCH: provides essential SI necessary for the UE to transmit and receive data channel and control channel. The essential SI may include search space-related control information indicating radio resource mapping information for a control channel and scheduling control information for a separate data channel for transmitting SI.

SS/PBCH block: The SS/PBCH block is composed of a combination of PSS, SSS, and PBCH. One or more SS/PBCH blocks may be transmitted within 5 ms, and each transmitted SS/PBCH block may be distinguished with an index.

The UE may detect the PSS and SSS in the initial access phase and may decode the PBCH. The UE may obtain the MIB from the PBCH and may be therefrom configured with control region (e.g., a CORESET) #0 (which may correspond to a control region having a control region index of 0). The UE may perform monitoring on control region #0, assuming that the selected SS/PBCH block and the DMRS transmitted in control region #0 are quasi-co-located (QCLed). The UE may receive SI as DCI transmitted in control region #0. The UE may obtain configuration information related to RA channel (RACH) required for initial access from the received SI. The UE may transmit the physical RACH (PRACH) to the BS considering the selected SS/PBCH index, and the BS receiving the PRACH may obtain information for the SS/PBCH block index selected by the UE. The BS may know which block the UE has selected from the SS/PBCH blocks and monitors control region #0 related thereto.

### PDCCH: DCI

Scheduling information for a PUSCH or a PDSCH in the 5G system is transmitted from the BS through DCI to the UE. The UE may monitor the DCI format for fallback and the DCI format for non-fallback for PUSCH or PDSCH. The fallback DCI format may be composed of fixed fields predetermined between the BS and the UE, and the non-fallback DCI format may include configurable fields.

DCI may be transmitted through the PDCCH via channel coding and modulation. A cyclic redundancy check (CRC) is added to the DCI message payload, and the CRC is scrambled with the radio network temporary identifier (RNTI) that is the identity of the UE. Different RNTIs may be used for the purposes of the DCI message, e.g., UE-specific data transmission, power control command, or RA response (RAR). In other words, the RNTI is not explicitly transmitted, but the RNTI is included in the CRC calculation process and transmitted. Upon receiving the DCI message transmitted on the PDCCH, the UE identifies the CRC using the allocated RNTI, and when the CRC is correct, the UE may be aware that the message has been transmitted to the UE.

For example, DCI scheduling a PDSCH for SI may be scrambled to SI-RNTI. The DCI scheduling a PDSCH for an RAR message may be scrambled to RA-RNTI. DCI scheduling a PDSCH for a paging message may be scrambled with P-RNTI. The DCI providing a slot format indicator (SFI) may be scrambled to SFI-RNTI. The DCI providing transmit (or transmission) power control (TPC) may be scrambled to TPC-RNTI. The DCI for scheduling a UE-specific PDSCH or PUSCH may be scrambled with cell RNTI (C-RNTI).

DCI format 0_0 may be used as fallback DCI for scheduling PUSCH, and in this case, CRC may be scrambled to C-RNTI. DCI format 0_0 in which CRC is scrambled to C-RNTI may include the information in Table 4 below.

TABLE 4

Identifier for DCI formats- [1] bit
$\begin{matrix}Frequency domain resource \\ assignment - [ ⌈ {log}_{2} ( {N}_{RB}^{UL , BWP} ( {N}_{RB}^{UL , BWP} + 1 ) / 2 ) ⌉ ] bits\end{matrix}$
Time domain resource assignment - X bits
Frequency hopping flag- 1 bit.
Modulation and coding scheme - 5 bits
New data indicator- 1 bit
Redundancy version - 2 bits
HARQ process number - 4 bits
TPC command for scheduled - [2] bits
UL/SUL(supplementary UL) indicator - 0 or 1 bit

DCI format 0_1 may be used as non-fallback DCI for scheduling PUSCH, and in this case, CRC may be scrambled to C-RNTI. DCI format 0_1 in which CRC is scrambled to C-RNTI may include the information in Table 5 below.

```
TABLE 5
    Carrier indicator - 0 or 3 bits
    UL/SUL indicator - 0 or 1 bit
    Identifier for DCI formats - [1] bits
    Bandwidth part indicator - 0, 1 or 2 bits
    Frequency domain resource assignment
      $For resource allocation type 0 , ⌈ {N}_{RB}^{UL , BWP} / P ⌉ bits$
      $For resource allocation type 1 , ⌈ {log}_{2} ( {N}_{RB}^{UL , BWP} ( {N}_{RB}^{UL , BWP} + 1 ) / 2 ) ⌉ bits$
    Time domain resource assignment -1, 2, 3, or 4 bits
    VRB (virtual resource block)-to-PRB (physical resource block) mapping- 0 or 1 bit,
only for resource allocation type 1.
      0 bit if only resource allocation type 0 is configured;
      1 bit otherwise.
    Frequency hopping flag - 0 or 1 bit, only for resource allocation type 1.
      0 bit if only resource allocation type 0 is configured;
      1 bit otherwise.
    Frequency hopping flag - 0 or 1 bit, only for resource allocation type 1.
      0 bit if only resource allocation type 0 is configured;
      1 bit otherwise.
    Modulation and coding scheme - 5 bits
    New data indicator - 1 bit
    Redundancy version - 2 bits
    HARQ process number - 4 bits
    1st downlink assignment index - 1 or 2 bits
      1 bit for semi-static HARQ-ACK codebook;
      2 bits for dynamic HARQ-ACK codebook with single HARQ-ACK
      codebook.
    2nd downlink assignment index- 0 or 2 bits
      2 bits for dynamic HARQ-ACK codebook with two HARQ-ACK sub-
      codebooks;
      0 bit otherwise.
    TPC command for scheduled PUSCH - 2 bits
    $SRS resource indicator - ⌈ {log}_{2} ( {\sum }_{k = 1}^{{L}_{max} = \sum } ( \begin{matrix}{N}_{SRS} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max} = \sum } ( \begin{matrix}{N}_{SRS} \\ k\end{matrix} ) ) ⌉ bits for non - codebook based PUSCH transmission ;$
    ┌log₂(N_{SRS})┐ bits for codebook based PUSCH transmission.
  Precoding information and number of layers-up to 6 bits
  Antenna ports- up to 5 bits
  SRS request- 2 bits
  CSI request- 0, 1, 2, 3, 4, 5, or 6 bits
  CBG (code block group) transmission information-0, 2, 4, 6, or 8 bits
  PTRS-DMRS association- 0 or 2 bits.
  beta_offset indicator- 0 or 2 bits
  DMRS sequence initialization- 0 or 1 bit
```

DCI format 1_0 may be used as fallback DCI for scheduling PDSCH, and in this case, CRC may be scrambled to C-RNTI. DCI format 1_0 in which CRC is scrambled to C-RNTI may include the information in Table 6 below.

TABLE 6

Identifier for DCI formats - [1] bit
$\begin{matrix}Frequency domain resource \\ assignment - [ ⌈ {log}_{2} ( {N}_{RB}^{DL , BWP} ( {N}_{RB}^{DL , BWP} + 1 ) / 2 ) ⌉ ] bits\end{matrix}$
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH -[2] bits
PUCCH resource indicator- 3 bits
PDSCH-to-HARQ feedback timing indicator- [3] bits

DCI format 1_i may be used as non-fallback DCI for scheduling PDSCH, and in this case, CRC may be scrambled to C-RNTL. DCI format 1_1 in which CRC is scrambled to C-RNTI may include the information in Table 7 below.

```
TABLE 7
  Carrier indicator - 0 or 3 bits
  Identifier for DCI formats - [1] bits
  Bandwidth part indicator - 0, 1 or 2 bits
  Frequency domain resource assignment
    $For resource allocation type 0 , ⌈ {N}_{RB}^{UL , BWP} / P ⌉ bits$
    $\begin{matrix}For resource allocation type 1 , \\ ⌈ {log}_{2} ( {N}_{RB}^{UL , BWP} ( {N}_{RB}^{UL , BWP} + 1 ) / 2 ) ⌉ bits\end{matrix}$
  Time domain resource assignment -1, 2, 3, or 4 bits
  VRB-to-PRB mapping - 0 or 1 bit, only for resource allocation type 1.
    0 bit if only resource allocation type 0 is configured;
    1 bit otherwise.
  PRB bundling size indicator- 0 or 1 bit
  Rate matching indicator - 0, 1, or 2 bits
  ZP CSI-RS trigger- 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

### PDCCH: CORESET, REG, CCE, Search Space

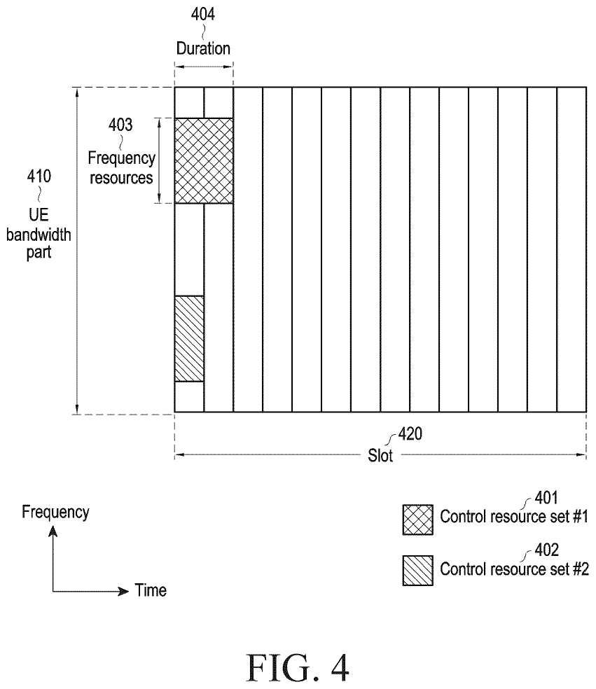

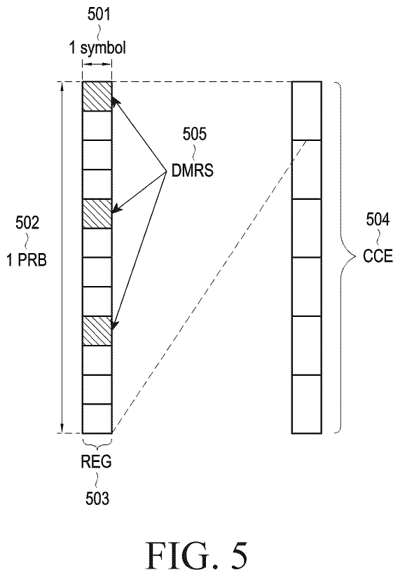

an example of a CORESET where the DL control channel is transmitted in the 5G wireless communication system. FIG. 4 illustrates an example in which two control regions (control region #1 401 and control region #2 402) are configured in one slot 420 on the time axis, and a UE BWP 410 is configured on the frequency axis. The control regions 401 and 402 may be configured to a particular frequency resource 403 in the overall system BWP 410 on the frequency axis. One or more OFDM symbols may be configured on the time axis, which may be defined as CORESET duration 404. In the example of FIG. 5, control region #1 401 is configured as a control region length of two symbols, and control region #4 402 is configured as a control region length of one symbol.

The control region in 5G described above may be configured in the UE by the BS through higher layer signaling (e.g., SIB, MIB, or RRC signaling). Configuring a UE with a control region means providing the UE with such information as the ID of the control region, the frequency position of the control region, and symbol length of the control region. For example, the information in Table 8 below may be included.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(CORESET identifier)

| | |
|---|---|
| frequencyDomainResources | BIT STRING (SIZE (45)), |

(frequency axis resource allocation information)

| | |
|---|---|
| duration | INTEGER (1..maxCoReSetDuration), |

(time axis resource allocation information)

| | |
|---|---|
| cce-REG-MappingType | CHOICE { |
| interleaved | SEQUENCE { |
| reg-BundleSize | ENUMERATED {n2, n3, n6}, |
| precoderGranularity | ENUMERATED { sameAsREG- |

bundle, allContiguousRBs},

| | |
|---|---|
| interleaverSize | ENUMERATED {n2, n3, n6} |

```
        shiftIndex
        INTEGER(0..maxNrofPhysicalResourceBlocks−1)
          OPTIONAL
        (interleaver shift)
      },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| | OPTIONAL, -- Need S |

}

In Table 8 above, tci-StatesPDCCH (which may simply be referred to as a TCI state) configuration information may include information for one or more SS/PBCH block indexes or channel state information reference signal (CSI-RS) index QCLed with the DMRS transmitted in the corresponding control region.

FIG. 5 illustrates an example of a basic unit of time and frequency resource constituting a DL control channel available in 5G. Referring to FIG. 5, the basic unit of time and frequency resources constituting the DL control channel may be referred to as a resource element group (REG) 503, and the REG 503 may be defined with one OFDM symbol 501 on the time axis and with one physical RB (PRB) 502, i.e., 12 subcarriers, on the frequency axis. The BS may configure a DL control channel allocation unit by concatenating REGs 503.

As shown in FIG. 5, if the basic unit for allocation of a DL control channel in 5G is a control channel element (CCE) 504, one CCE 504 may be composed of multiple REGs 503. In the example of the REG 503 illustrated in FIG. 5, the REG 503 may be constituted of 12 REs, and if one CCE 504 is constituted of six REGs 503, one CCE 504 may be constituted of 72 REs. When the download control region is set, the region may be constituted of multiple CCEs 504, and a particular download control channel may be mapped to one or more CCEs 504 according to the aggregation level (AL) in the control region and be transmitted. The CCEs 504 in the control region are distinguished with numbers, and in this case, the numbers of the CCEs 504 may be assigned according to a logical mapping scheme.

The basic unit, i.e., the REG 503, of the download control channel shown in FIG. 5 may contain REs to which the DCI is mapped and the region to which the DMRS 505, a reference signal for decoding the REs, is mapped. As shown in FIG. 5, three DMRSs 505 may be transmitted in one REG 503. The number of CCEs necessary to transmit a PDCCH may be, e.g., 1, 2, 4, 8, or 16 depending on the aggregation level (AL), and different numbers of CCEs may be used to implement link adaptation of DL control channel. For example, if AL=L, one DL control channel may be transmitted via L CCEs. The UE needs to detect a signal while being unaware of information for the DL control channel and, for blind decoding, a search space is defined which indicates a set of CCEs. The search space is a set of candidate control channels constituted of CCEs that the UE needs to attempt to decode on the given aggregation level, and since there are several aggregation levels to bundle up 1, 2, 4, 8, or 16 CCEs, the UE has a plurality of search spaces. A search space set (Set) may be defined as a set of search spaces at all set aggregation levels.

Search spaces may be classified into a common search space and a UE-specific search space. A predetermined group of UEs or all the UEs may search for the common search space of the PDCCH to receive cell-common control information, e.g., paging message, or dynamic scheduling for SI. For example, PDSCH scheduling allocation information for transmitting an SIB containing, e.g., cell service provider information may be received by investigating the common search space of the PDCCH. In the case of the common search space, since a certain group of UEs or all the UEs need receive the PDCCH, it may be defined as a set of CCEs previously agreed on. Scheduling allocation information for the UE-specific PDSCH or PUSCH may be received by inspecting the UE-specific search space of PDCCH. The UE-specific search space may be UE-specifically defined with a function of various system parameters and the identity of the UE.

In 5G, the parameters for the search space for the PDCCH may be configured in the UE by the BS through higher layer signaling (e.g., SIB, MIB, or RRC signaling). For example, the BS may configure the UE with, e.g., the number of PDCCH candidates at each aggregation level L, monitoring period for search space, monitoring occasion of symbol unit in slot for search space, search space type (common search space or UE-specific search space), combination of RNTI and DCI format to be monitored in the search space, and control region index to be monitored in the search space. For example, the information in Table 9 below may be included.

TABLE 9

| | |
|---|---|
| SearchSpace ::= | SEQUENCE { |

```
    -- Identity of the search space. SearchSpaceId = 0 identifies the SearchSpace
        configured via PBCH (MIB) or ServingCellConfigCommon.
```

| | |
|---|---|
| searchSpaceId | SearchSpaceId, |
| controlResourceSetId | ControlResourceSetId, |

```
  (CORESET identifier)
    monitoringSlotPeriodicityAndOffset CHOICE {
  (monitoring slot level periodicity)
```

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(monitoring length) | INTEGER (2..2559) |
| monitoringSymbolsWithinSlot | BIT STRING (SIZE (14)) |
| | OPTIONAL, |
| nrofCandidates | SEQUENCE { |

(number of PDCCH candidate groups per aggregation level)

| | |
|---|---|
| aggregationLevel1 | ENUMERATED {n0, n1, n2, n3, n4, |

n5, n6, n8},

| | |
|---|---|
| aggregationLevel2 | ENUMERATED {n0, n1, n2, n3, n4, |

n5, n6, n8},

| | |
|---|---|
| aggregationLevel4 | ENUMERATED {n0, n1, n2, n3, n4, |

n5, n6, n8},

| | |
|---|---|
| aggregationLevel8 | ENUMERATED {n0, n1, n2, n3, n4, |

n5, n6, n8},

| | |
|---|---|
| aggregationLevel16 | ENUMERATED {n0, n1, n2, n3, n4, |

```
        n5, n6, n8}
    },
```

| | |
|---|---|
| searchSpaceType | CHOICE { |

```
        -- Configures this search space as common search space (CSS) and DCI formats
        to monitor.
```

| | |
|---|---|
| common | SEQUENCE { |

```
      (common search space)
      }
```

| | |
|---|---|
| ue-Specific | SEQUENCE { |

```
      (UE-specific search space)
          -- Indicates whether the UE monitors in this USS for DCI formats 0-0 and 1-0
        or for formats 0-1 and 1-1.
```

| | |
|---|---|
| formats | ENUMERATED {formats0-0-And-1- |

```
        0, formats0-1-And-1-1},
          ...
        }
```

According to the configuration information, the BS may configure one or more search space sets to the terminal. According to an embodiment, the BS may configure the UE with search space set 1 and search space set 2 and configure it to monitor DCI format A, scrambled to X-RNTI in search space set 1, in the common search space and to monitor DCI format B, scrambled to Y-RNTI in search space set 2, in the UE-specific search space.

According to the above-described configuration information, one or more search space sets may be present in the common search space or the UE-specific search space. For example, search space set #1 and search space set #2 may be configured as the common search space, and search space set #3 and search space set #4 may be configured as the UE-specific search space.

In the common search space, a combination of DCI format and RNTI as follows may be monitored. Of course, it is not limited to the examples described below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, a combination of DCI format and RNTI as follows may be monitored. Of course, it is not limited to the examples described below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may be defined and used as follows.
Cell RNTI (C-RNTI): for scheduling UE-specific PDSCH
Temporary cell RNTI (TC-RNTI): for scheduling UE-specific PDSCH
Configured scheduling RNTI (CS-RNTI): for scheduling semi-statically configured UE-specific PDSCH
RA-RNTI: for scheduling PDSCH in the RA phase
Paging RNTI (P-RNTI): for scheduling PDSCH where paging is transmitted
SI RNTI (SI-RNTI): for scheduling PDSCH where SI is transmitted
Interruption RNTI (INT-RNTI): for indicating whether to puncture PDSCH
TPC for PUSCH RNTI (TPC-PUSCH-RNTI): for indicating power control command for PUSCH
TPC for PUCCH RNTI (TPC-PUCCH-RNTI): for indicating power control command for PUCCH
TPC for SRS RNTI (TPC-SRS-RNTI): for indicating power control command for SRS

The above-described DCI formats may follow the definitions in Table 10 below.

TABLE 10

| DCI_format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission |
| | is intended for the UE |
| 2_2 | Transmission of TPC commands for PUCCH and PUSCH |
| 2_3 | Transmission of a group of TPC commands for |
| | SRS transmissions by one or more UEs |

In 5G, the search space of the aggregation level L in the control region p and the search space set s may be expressed by Equation (1) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

L: aggregation level
n_{CI}: carrier index
N_{CCE,p}: total number of CCEs present in control region p

$${n}_{s , f}^{μ} ∶$$

slot index

$${M}_{s , max}^{( L )} ∶$$

Mnumber of PDCCH candidate groups of aggregation level L

$${m}_{s , {n}_{CI}} = 0 , … , {M}_{s , max}^{( L )} - 1 ∶$$

PDCCH candidate group index of aggregation level

$$i = 0 , … , L - 1$$

$${Y}_{p , {n}_{s , f}^{μ}} = ( {A}_{p} \cdot {Y}_{p , {n}_{s , f}^{μ} - 1} ) mod D ,$$

$${Y}_{p , - 1} = {n}_{RNTI} \neq 0 ,$$

$${A}_{p} = 39827 for p mod3 = 0 ,$$

$${A}_{p} = 39829 for p mod3 = 1 ,$$

$${A}_{p} = 39839 for p mod 3 = 2 ,$$

$$D = 65537$$

n_{RNTI}: UE identifier

$${Y}_{p , {n}_{s , f}^{μ}}$$

may be 0 in the case of the common search space.

In the case of the UE-specific search space,

$${Y}_{p , {n}_{s , f}^{μ}}$$

may be a value that changes depending on the UE's identity (C-RNTI or ID configured in the UE by the BS) and the time index.

In 5G, as a plurality of search space sets may be set with different parameters as shown in Table 10 below, the set of search space sets monitored by the UE at each point in time may be different. For example, when search space set #1 is set at the X-slot period, search space set #2 is set at the Y-slot period, and X differs from Y, the UE may monitor both search space set #1 and search space set #2 in a specific slot and monitor either search space set #1 or search space set #2 in a specific slot.

### PDCCH: Span

The UE may perform UE capability reporting for the case where there are a plurality of PDCCH monitoring positions in a slot, at each subcarrier spacing, and in this case, the concept “span” may be used. Span means contiguous symbols where the UE may monitor PDCCH in a slot, and each PDCCH monitoring position is within one span. The span may be represented as (X,Y). Here, x indicates the minimum number of symbols where the first symbols of two consecutive spans should be apart from each other, and Y indicates the number of symbols where the PDCCH may be monitored in one span. In this case, the UE may monitor the PDCCH in the period of Y symbols from the first symbol of a span.

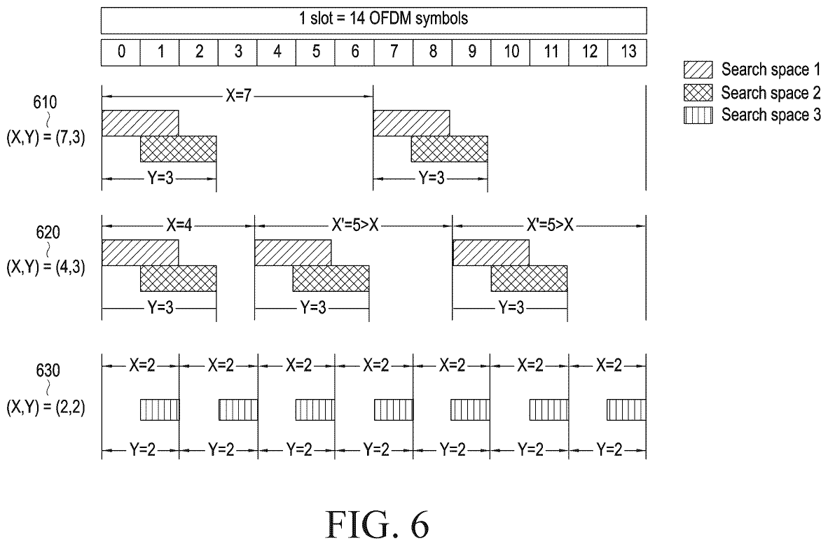

FIG. 6 illustrates, via span, when a UE may have a plurality of PDCCH monitoring positions in a slot in a wireless communication system. Span may be (X,Y)=(7,3) 610, (4,3) 620, and (2,2) 630. Specifically, (610) represents when there are two spans, which may be expressed as (7,3), in a slot. The interval between the first symbols of two spans is expressed as X=7, and a PDCCH monitoring position may exist within a total of Y=3 symbols from the first symbol of each span, and search spaces 1 and 2 are present within Y=3 symbols. In (620), when there are a total of three spans, which may be expressed as (4,3). The interval between the second and third spans is X′=5 symbols which are greater than X=4.

### PDCCH: UE Capability Report

The position of the slot where the above-described common search space and UE-specific search space are positioned is indicated by the monitoringSlotPeriodicityAndOffset parameter of Table 9 and the symbol position in the slot is indicated by a bitmap through the monitoringSymbolsWithinSlot parameter of Table 9 above. Meanwhile, the symbol position in the slot where the UE is capable of search space monitoring may be reported to the BS through the following UE capabilities.

UE capability 1 (hereafter referred to as FG 3-1). The UE capability indicates the capability of monitoring a corresponding monitoring occasion (MO) when the MO is positioned in the first three symbols of the slot when there is, in the slot, one MO for the UE-specific search space or type 1 and type 3 common search spaces as shown in Table 11 below. The UE capability is a mandatory capability that all UE supporting NR should support, and whether the capability is supported is not explicitly reported to the BS.

TABLE 11

| | | | Field name in |
|---|---|---|---|
| Index | Feature group | Components | TS. 38.331 [2] |
| 3-1 | Basic DL | 1) One configured CORESET per BWP per cell in addition to | n/a |
| | control | CORESET0 | |
| | channel | CORESET resource allocation of 6RB bit-map and duration | |
| | | of 1-3 OFDM symbols for FR1 | |
| | | For type 1 CSS without dedicated RRC configuration and for | |
| | | type 0, 0A, and 2 CSSs, CORESET resource allocation of 6RB | |
| | | bit-map and duration 1-3 OFDM symbols for FR2 | |
| | | For type 1 CSS with dedicated RRC configuration and for | |
| | | type 3 CSS, UE specific SS, CORESET resource allocation of | |
| | | 6RB bit-map and duration 1-2 OFDM symbols for FR2 | |
| | | REG-bundle sizes of 2/3 RBs or 6 RBs | |
| | | Interleaved and non-interleaved CCE-to-REG mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast PDCCH | |
| | | transmission per BWP per cell | |
| | | PDCCH aggregation levels 1, 2, 4, 8, 16 | |
| | | UP to 3 search space sets in a slot for a scheduled SCell per | |
| | | BWP | |
| | | This search space limit is before applying all dropping rules. | |
| | | For type 1 CSS with dedicated RRC configuration, type 3 | |
| | | CSS, and UE-SS, the monitoring occasion is within the first 3 | |
| | | OFDM symbols of a slot | |
| | | For type 1 CSS without dedicated RRC configuration and for | |
| | | type 0, 0A, and 2 CSS, the monitoring occasion can be any | |
| | | OFDM symbol(s) of a slot, with the monitoring occasions for | |
| | | any of Type 1- CSS without dedicated RRC configuration, or | |
| | | Types 0, 0A, or 2 CSS configurations within a single span of | |
| | | three consecutive OFDM symbols within a slot | |
| | | 3) Monitoring DCI formats 0_0, 1_0, 0_1, 1_1 | |
| | | 4) Number of PDCCH blind decodes per slot with a given SCS | |
| | | follows Case 1-1 table | |
| | | 5) Processing one unicast DCI scheduling DL and one unicast | |
| | | DCI scheduling UL per slot per scheduled CC for FDD | |
| | | 6) Processing one unicast DCI scheduling DL and 2 unicast | |
| | | DCI scheduling UL per slot per scheduled CC for TDD | |

UE capability 2 (hereafter referred to as FG 3-2). As shown in Table 12 below, the UE capability means a capability of monitoring regardless of where the start symbol of the corresponding MO is positioned when there is one MO for the common search space or UE-specific search space in the slot. This UE capability is optionally supported by the UE, and whether this capability is supported is explicitly reported to the BS.

TABLE 12

| | | | Field name in |
|---|---|---|---|
| Index | Feature group | Components | TS 38.331 [2] |
| 3-2 | PDCCH | For a given UE, all | pdcchMonitoringSingleOccasion |
| | monitoring on | search space configurations | |
| | any span of | are within the same | |
| | up to 3 | span of 3 consecutive OFDM | |
| | consecutive | symbols in the slot | |
| | OFDM | | |
| | symbols of | | |
| | a slot | | |

UE capability 3 (hereafter referred to as FG 3-5, 3-5a, or 3-5b). This UE capability indicates the pattern of the MO which may be monitored by the UE when there are a plurality of MOs for the common search space or UE-specific search space in the slot as shown in Table 13 below. The above-described pattern is constituted of the inter-start symbol interval X between different MOs and the maximum symbol length for one MO. The (X,Y) combination that is supported by the UE may be one or more of {(2,2), (4,3), (7,3)}. This UE capability is optionally supported by the UE, and whether this capability is supported and the above-described (X,Y) combination are explicitly reported to the BS.

TABLE 13

| Index | Feature group | Components | Field name in TS 38.331 [2] |
|---|---|---|---|
| 3-5 | For type 1 | For type 1 CSS with dedicated RRC configuration, | pdcch-MonitoringAnyOccasions |
| | CSS with | type 3 CSS, and UE-SS, monitoring occasion can | { |
| | dedicated RRC | be any OFDM symbol(s) of a slot for Case 2 | 3-5. withoutDCI-Gap |
| | configuration, | | 3-5a. withDCI-Gap |
| | type 3 CSS, | | } |
| | and UE-SS, | | |
| | monitoring | | |
| | occasion can | | |
| | be any OFDM | | |
| | symbol(s) of a | | |
| | slot for Case 2 | | |
| 3-5a | For type 1 | For type 1 CSS with dedicated RRC configuration, | |
| | CSS with | type 3 CSS and UE-SS, monitoring occasion can | |
| | dedicated RRC | be any OFDM symbol(s) of a slot for Case 2, with | |
| | configuration, | minimum time separation (including the cross-slot | |
| | type 3 CSS, | boundary case) between two DL unicast DCIs, | |
| | and UE-SS, | between two UL unicast DCIs, or between a DL | |
| | monitoring | and an UL unicast DCI in different monitoring | |
| | occasion can | occasions where at least one of them is not the | |
| | be any OFDM | monitoring occasions of FG-3-1, for a same UE as | |
| | symbol(s) of a | 2OFDM symbols for 15 kHz | |
| | slot for Case | 4OFDM symbols for 30 kHz | |
| | 2 with a DCI | 7OFDM symbols for 60 kHz with NCP | |
| | gap | 11OFDM symbols for 120 kHz | |
| | | Up to one unicast DL DCI and up to one unicast | |
| | | UL DCI in a monitoring occasion except for the | |
| | | monitoring occasions of FG 3-1. | |
| | | In addition for TDD the minimum separation | |
| | | between the first two UL unicast DCIs within the | |
| | | first 3 OFDM symbols of a slot can be zero OFDM | |
| | | symbols. | |
| 3-5b | All PDCCH | PDCCH monitoring occasions of FG-3-1, plus | |
| | monitoring | additional PDCCH monitoring occasion(s) can | |
| | occasion can | be any OFDM symbol(s) of a slot for Case 2, | |
| | be any OFDM | and for any two PDCCH monitoring occasions | |
| | symbol(s) of a | belonging to different spans, where at least one | |
| | slot for Case 2 | of them is not the monitoring occasions of FG-3-1, | |
| | with a span | in same or different search spaces, there is a | |
| | gap | minimum time separation of X OFDM symbols | |
| | | (including the cross-slot boundary case) | |
| | | between the start of two spans, where each | |
| | | span is of length up to Y consecutive OFDM | |
| | | symbols of a slot. Spans do not overlap. Every | |
| | | span is contained in a single slot. The same | |
| | | span pattern repeats in every slot. The | |
| | | separation between consecutive spans within | |
| | | and across slots may be unequal but the same | |
| | | (X, Y) limit must be satisfied by all spans. Every | |
| | | monitoring occasion is fully contained in one | |
| | | span. In order to determine a suitable span | |
| | | pattern, first a bitmap b(l), 0 <= l <= 13 is | |
| | | generated, where b(l) = 1 if symbol l of any slot is | |
| | | part of a monitoring occasion, b(l) = 0 otherwise. | |
| | | The first span in the span pattern begins at the | |
| | | smallest l for which b(l) = 1. The next span in the | |
| | | span pattern begins at the smallest l not included | |
| | | In the previous span(s) for which b(l) = 1. The | |
| | | span duration is max{maximum value of all | |
| | | CORESET durations, minimum value of Y in the | |
| | | UE reported candidate value} except possibly | |
| | | the last span in a slot which can be of shorter | |
| | | duration. A particular PDCCH monitoring | |
| | | configuration meets the UE capability limitation if | |
| | | the span arrangement satisfies the gap | |
| | | separation for at least one (X, Y) in the UE | |
| | | reported candidate value set in every slot, | |
| | | including cross slot boundary | |
| 3-5b | All PDCCH | For the set of monitoring occasions which are | |
| | monitoring | within the same span: | |
| | occasion can | Processing one unicast DCI | |
| | be any OFDM | scheduling DL and one unicast DCI scheduling | |
| | symbol(s) of a | UL per scheduled CC across this set of | |
| | slot for Case 2 | monitoring occasions for FDD | |
| | with a span | Processing one unicast DCI | |
| | gap | scheduling DL and two unicast DCI scheduling | |
| | | UL per scheduled CC across this set of | |
| | | monitoring occasions for TDD | |
| | | Processing two unicast DCI | |
| | | scheduling DL and one unicast DCI scheduling | |
| | | UL per scheduled CC across this set of | |
| | | monitoring occasions for TDD | |
| | | The number of different start symbol indices of | |
| | | spans for all PDCCH monitoring occasions per | |
| | | slot, including PDCCH monitoring occasions of | |
| | | FG-3-1, is no more than floor(14/X) (X Is | |
| | | minimum among values reported by UE), | |
| | | The number of different start symbol indices of | |
| | | PDCCH monitoring occasions per slot including | |
| | | PDCCH monitoring occasions of FG-3-1, is no | |
| | | more than 7. | |
| | | The number of different start symbol indices of | |
| | | PDCCH monitoring occasions per half-slot | |
| | | including PDCCH monitoring occasions of FG-3-1 | |
| | | is no more than 4 in SCell. | |

The UE may report, to the BS, whether UE capability 2 and/or UE capability 3 is supported and relevant parameters. The BS may perform time axis resource allocation on the common search space and UE-specific search space based on the UE capability. Upon resource allocation, the BS may prevent an MO from being positioned at a position where UE monitoring is impossible.

### QCL, TCJ State

In the wireless communication system, one or more different antenna ports (which may be replaced with one or more channels, signals, or combinations thereof, but are collectively referred to as different antenna ports for convenience of description in the following description of the disclosure) may be associated with each other through QCL configuration as shown in Table 14 below. The TCJ state is for announcing the QCL relationship between the PDCCH (or PDCCH DMRS) and another RS or between channels. When some reference antenna port A (reference RS #A) and another target antenna port B (target RS #B) are QCLed with each other, this means that the UE is allowed to apply all or some of the large-scale channel parameters estimated in antenna port A to channel measurement from antenna port B. QCL may require associating different parameters depending on contexts, such as 1) time tracking influenced by average delay and delay spread, 2) frequency tracking influenced by Doppler shift and Doppler spread, 3) radio resource management (RRM) influenced by average gain, and 4) beam management (BM) influenced by spatial parameter. Accordingly, NR supports four types of QCL relationships as shown in Table 14 below.

TABLE 14

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

Spatial RX parameter may collectively refer to all or some of various parameters, such as Angle of arrival (AoA), Power Angular Spectrum(PAS) of AoA, Angle of departure (AoD), PAS of AoD, transmit/receive channel correlation, transmit/receive beamforming, spatial channel correlation.

The QCL relationship may be configured to the UE through the RRC parameter TC-State and QCL-Info as shown in Table 15 below, in which the BS may configure the UE with one or more TCI states, indicating up to two QCL relationships (qcl-Type1 and qcl-Type2) for the RS referencing the ID of the TCI state, i.e., the target RS. In this case, the QCL information (QCL-Info) included in each TCI state includes the serving cell index and BWP index of the reference RS indicated by the QCL information, type and ID of the reference RS, and the QCL type as shown in Table 14 above.

TABLE 15

| | |
|---|---|
| TCI-State ::= | SEQUENCE { |
| tci-StateId | TCI-StateId, |
| qcl-Type1 | QCL-Info, |

(QCL information about first reference RS (target RS) of referring to corresponding
TCI state ID)

| | | |
|---|---|---|
| qcl-Type2 | QCL-Info | OPTIONAL, -- |

```
Need R
  (QCL information about second reference RS (target RS) of referring to corresponding
TCI state ID)
  ...
}
```

| QCL-Info ::= | SEQUENCE { | |
|---|---|---|
| cell | ServCellIndex | OPTIONAL, -- Need R |

(serving cell index of reference RS indicated by corresponding QCL information x)

| | | |
|---|---|---|
| bwp-Id | BWP-Id | OPTIONAL, -- |

Cond CSI-RS-Indicated
(BWP index of reference RS indicated by corresponding QCL information)

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL information)
  },
```

| | |
|---|---|
| qcl-Type | ENUMERATED {typeA, typeB, typeC, typeD}, |

...
}

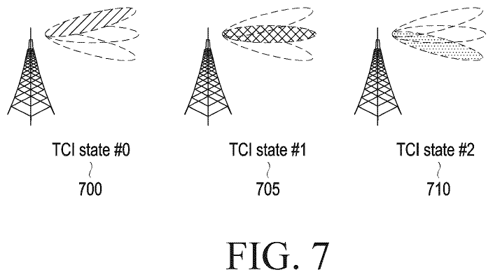

FIG. 7 illustrates an example of BS beam allocation according to a TCI state configuration. Referring to FIG. 7, the BS may transfer information about N different beams to the UE through N different TCI states. For example, when N=3 as shown in FIG. 7, the BS may announce/indicate that the qcl-Type2 parameter included in three TCI state #0 700, #1 705, and #2 710 is associated with the CSI-RSs or SSBs corresponding to different beams and is rendered to be set in QCL type D so that the antenna ports referencing the different TCI states 700, 705, and 710 are associated with different spatial RX parameters, i.e., different beams.

Tables 16 to 20 below show effective TCI state configurations according to target antenna port types.

Table 16 below shows the effective TCI state configuration when the target antenna port is CSI-RS for tracking, or in other words, a tracking reference signal (TRS). TRS refers to a non-zero power (NZP) CSI-RS in which no repetition parameter is set and trs-Info is set to true among CSI-RSs. Configuration No. 3 in Table 16 may be used for aperiodic TRS.

Table 16 below shows an example of the effective TCI state configuration when the target antenna port is a TRS.

TABLE 16

| Valid TCI | | | DL RS 2: | qcl-Type2 |
|---|---|---|---|---|
| state Configuration | DL RS 1 | qcl-Type1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS | QCL-TypeD |
| | (periodic) | | (same as DL RS1) | |

Table 17 below shows the effective TCI state configuration when the target antenna port is CSI-RS for CSI. The CSI-RS for CSI refers to an NZP CSI-RS in which no parameter indicating repetition (e.g., repetition parameter) is set and trs-Info is not set to true among the CSI-RSs.

Table 17 below shows an example of the effective TCI state configuration when the target antenna port is CSI-RS for CSI.

TABLE 17

| Valid TCI | | | DL RS 2 | qcl-Type2 |
|---|---|---|---|---|
| state Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS for BM | QCL-TypeD |
| 3 | TRS | QCL-TypeA | TRS | QCL-TypeD |
| | | | (same as DL RS1) | |
| 4 | TRS | QCL-TypeB | | |

Table 18 below shows effective TCI state configurations when the target antenna port is CSI-RS for beam management (BM), which may have the same meaning as CSI-RS for L1 RSRP reporting. The CSI-RS for BM refers to an NZP CSI-RS in which a repetition parameter is set and has a value of On or Off, and trs-Info is not set to true among the CSI-RSs.

Table 18 below shows an example of the effective TCI state configuration when the target antenna port is CSI-RS for BM (for L1 RSRP reporting).

TABLE 18

| Valid TCI | | | DL RS 2 | qcl-Type2 |
|---|---|---|---|---|
| state Configuration | DL RS 1 | qcl-Type1 | (if configured) | (if configured) |
| 1 | TRS | QCL-TypeA | TRS | QCL-TypeD |
| | | | (same as DL RS1) | |
| 2 | TRS | QCL-TypeA | CSI-RS | QCL-TypeD |
| | | | (BM) | |
| 3 | SS/PBCH Block | QCL-TypeC | SS/PBCH Block | QCL-TypeD |

Table 19 below shows the effective TCI state configuration when the target antenna port is PDCCH DMRS.

TABLE 19

| Valid TCI | | | DL RS 2 | qcl-Type2 |
|---|---|---|---|---|
| state Configuration | DL RS 1 | qcl-Type1 | (if configured) | (if configured) |
| 1 | TRS | QCL-TypeA | TRS | QCL-TypeD |
| | | | (same as DL RS1) | |
| 2 | TRS | QCL-TypeA | CSI-RS (BM) | QCL-TypeD |
| 3 | CSI-RS (CSI) | QCL-TypeA | CSI-RS | QCL-TypeD |
| | | | (same as DL RS1) | |

Table 20 below shows the effective TCI state configuration when the target antenna port is PDSCH DMRS.

TABLE 20

| Valid TCI | | | DL RS 2 | qcl-Type2 |
|---|---|---|---|---|
| state Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | CSI-RS (CSI) | QCL-TypeD |

A representative QCL configuration method according to Tables 16 to 20 above is to set and operate the target antenna port and reference antenna port for each step as “SSB”->“TRS”->“CSI-RS for CSI, or CSI-RS for BM, or PDCCH DMRS, or PDSCH DMRS”. This may help the UE's reception operation, with the statistical characteristics measurable from the SSB and TRS associated with the antenna ports.

### PDCCH: TCI State Related

Specifically, a combination of TCI states applicable to the PDCCH DMRS antenna port is as shown in Table 21 below. In Table 21, the fourth row is a combination assumed by the UE before RRC configuration, and configuration after RRC is not possible.

TABLE 21

| Valid TCI | | | DL RS 2 | qcl-Type2 |
|---|---|---|---|---|
| state Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | | |
| 4 | SS/PBCH Block | QCL-TypeA | SS/PBCH Block | QCL-TypeD |

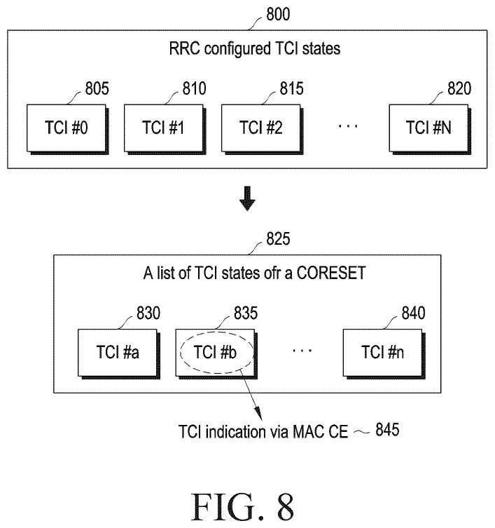

NR supports a hierarchical signaling method as shown in FIG. 8 for dynamic allocation of a PDCCH beam. Referring to FIG. 8, the BS may configure N TCI states 805, 810, 815 and 820 to the UE through RRC signaling 800 and set some of them as TCI states for CORESET (825). Thereafter, the BS may indicate one of the TCI states 830, 835, 840 for CORESET to the UE through MAC CE signaling (845). Thereafter, the UE receives the PDCCH based on the beam information included in the TCI state indicated by the MAC CE signaling.

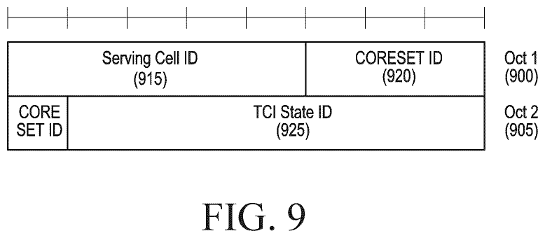

FIG. 9 illustrates a TCI indication MAC CE signaling structure for the PDCCH DMRS. Referring to FIG. 9, MAC CE is composed of octets, and Oct 1(900) and Oct 2(905) may contain different information depending on the fields of the respective MAC CE. TCI indication MAC CE signaling for PDCCH DMRS is constituted of, e.g., 2 bytes (16 bits) and includes five-bit serving cell ID 915, three-bit CORESET ID 920, and seven-bit TCI state ID 925.

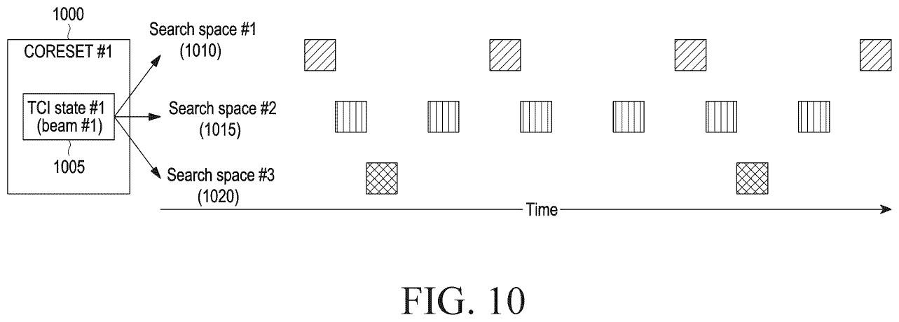

FIG. 10 illustrates an example of a beam configuration of a search space and a CORESET according to the above description. Referring to FIG. 10, the BS may indicate, through MAC CE signaling, one of TCI state lists included in the CORESET (1000) configuration (1005). Thereafter, until before another TCI state is indicated to the corresponding CORESET through other MAC CE signaling, the UE regards the same QCL information (beam #1, 1005) for one or more search space #1 1010, #2 1015, and #3 1020, associated with the CORESET. The above-described PDCCH beam allocation method has difficulty in indicating a quicker beam change than MAC CE signaling delay and applies the same beam to all the CORESETs regardless of the search space characteristics. Thus, flexible PDCCH beam operation may be difficult. A method for configuring and operating a PDCCH beam more flexibly is provided below in embodiments of the disclosure. In describing embodiments of the disclosure, for convenience of description, some separated examples are provided, but the example do not exclude each other, but rather, two or more thereof may be combined and applied depending on contexts.

The BS may configure, to the UE, one or more TCI states for a specific control region and activate one of the configured TCI states through a MAC CE activation command. For example, {TCI state #0, TCI state #1, TCI state #2} are set in control region #1 as TCI states. The BS may transmit, to the UE, a command to activate to assume TCI state #0 as the TCI state for control region #1, through the MAC CE. Based on the activation command for the TCI state received through the MAC CE, the UE may correctly receive the DMRS of the corresponding control region based on QCL information in the activated TCI state.

For the control region (control region #0) in which the index is set to 0, if the UE does not receive the MAC CE activation command for the TCI state of control region #0, the UE may assume that the DMRS transmitted in control region #0 is QCLed with the SS/PBCH block identified in an initial access process or a non-contention-based RA process that is not triggered by the PDCCH command.

For the control region (control region #X) in which the index is set to a non-zero value, if the TCI state for control region #X is not configured to the UE or if one or more TCI states are configured but a MAC CE activation command for activating one of them is not received, the UE may assume that the DMRS transmitted in control region #X has been QCLed with the SS/PBCH block identified in the initial access process.

### PDCCH: QCL Prioritization Rule

Hereinafter, the operation of determining the QCL priority for PDCCH is described in detail.

When the UE operates in CA in a band or a single cell, and a plurality of CORESETs present in the BWP activated in a single cell or a plurality of cells are equal to each other or overlap each other over time with the same or different QCL-TypeD characteristics in a specific PDCCH monitoring period, the UE may select a specific CORESET according to the QCL prioritization operation and monitor CORESETs having the same QCL-TypeD characteristics as those of the corresponding CORESET. In other words, when a plurality of CORESETs overlap over time, only one QCL-TypeD characteristic may be received. In this case, the criteria for determining the QCL priority may be as follows.

Criterion 1. A CORESET connected to the common search space having the lowest index, in the cell corresponding to the lowest index among cells including the common search space.

Criterion 2. A CORESET connected to the UE-specific search space having the lowest index in the cell corresponding to the lowest index among cells including the UE-specific search space.

As described above, when the above criteria are not met, the following criteria apply. For example, when CORESETs overlap over time in a specific PDCCH monitoring period, if all CORESETs are not connected to the common search space but are connected to the UE specific search space, i.e., if criterion 1 is not met, the UE may apply criterion 2 while omitting criterion 1.

When the UE selects the CORESET based on the above-described criteria, the UE may additionally consider two matters regarding the QCL information set in the CORESET as follows. First, when it has CSI-RS 1 as a reference signal in which CORESET 1 has the QCL-TypeD relationship, the reference signal in which CSI-RS 1 has the QCL-TypeD relationship is SSB1, and the reference signal in which another CORESET 2 has the QCL-TypeD relationship is SSB1, the UE may consider that the two CORESETs 1 and 2 have different QCL-TypeD characteristics. Second, when it has CSI-RS 1 configured in cell 1, as a reference signal in which CORESET 1 has the QCL-TypeD relationship, the reference signal in which CSI-RS 1 has the QCL-TypeD relationship is SSB1, and it has CSI-RS 2 configured in cell 2, as a reference signal in which CORESET 2 has the QCL-TypeD relationship, and the reference signal in which CSI-RS 2 has the QCL-TypeD relationship is SSB1, the UE may consider that the two CORESETs have the same QCL-TypeD characteristics.

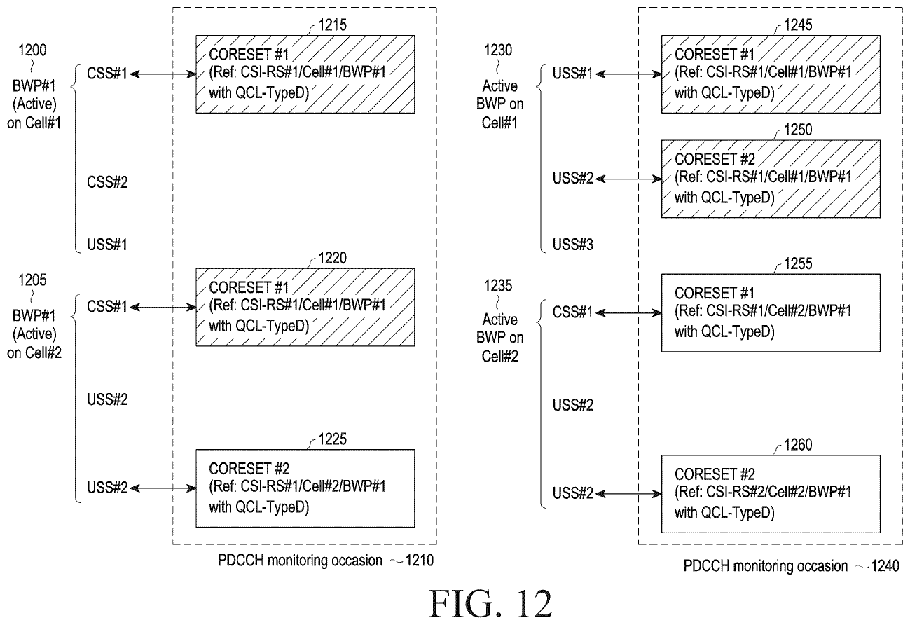

FIG. 12 illustrates a method for selecting a CORESET receivable considering priority when a UE receives a DL control channel in a wireless communication system according to an embodiment. For example, the UE may be configured to receive a plurality of CORESETs that overlap over time in a specific PDCCH monitoring occasion (period) 1210, and the plurality of CORESETs may be associated with the common search space or UE-specific search space for a plurality of cells. In the corresponding PDCCH monitoring period, CORESET 1 1215 associated with common search space 1 may be present in BWP 1 1200 of cell 1, and CORESET 1 1220 associated with common search space 1 and CORESET 2 1225 associated with UE-specific search space 2 may be present in BWP 1 1205 of cell 2. The CORESETs 1215 and 1220 may have the QCL-TypeD relationship with CSI-RS resource 1 configured in BWP 1 of cell 1, and the CORESET 1225 may have the QCL-TypeD relationship with CSI-RS resource 1 configured in BWP 1 of cell 2. Therefore, if criterion 1 applies to the corresponding PDCCH monitoring period 1210, all other CORESETs which have the same QCL-TypeD reference signal as CORESET 1 1215 may be received. Accordingly, the UE may receive the CORESETs 1215 and 1220 in the corresponding PDCCH monitoring period 1210. As another example, the UE may be configured to receive a plurality of CORESETs that overlap over time in a specific PDCCH monitoring period 1240, and the plurality of CORESETs may be associated with the common search space or UE-specific search space for a plurality of cells. In the corresponding PDCCH monitoring period, CORESET 1 1245 associated with UE-specific search space 1 and CORESET 2 1250 associated with UE-specific search space 2 may be present in BWP 1 1230 of cell 1, and CORESET 1 1255 associated with UE-specific search space 1 and CORESET 2 1260 associated with UE-specific search space 3 may be present in BWP 1 1235 of cell 2. The CORESETs 1245 and 1250 may have the QCL-TypeD relationship with CSI-RS resource 1 configured in BWP 1 of cell 1, the CORESET 1255 may have the QCL-TypeD relationship with CSI-RS resource 1 configured in BWP 1 of cell 2, and the CORESET 1260 may have the QCL-TypeD relationship with CSI-RS resource 2 configured in BWP 1 of cell 2. However, when criterion 1 is applied to the corresponding PDCCH monitoring period 1240, since there is no common search space, criterion 2, which is the next criterion, may be applied. If criterion 2 applies to the corresponding PDCCH monitoring period 1240, all other CORESETs which have the same QCL-TypeD reference signal as the CORESET 1245 may be received. Accordingly, the UE may receive the CORESETs 1245 and 1250 in the corresponding PDCCH monitoring period 1240.

### Rate Matching/Puncturing

When arbitrary time and frequency resource A to transmit arbitrary symbol sequence A overlaps time and frequency resource B, rate matching or puncturing may be considered as transmission/reception of channel A considering resource C in the overlapping area between resource A and resource B. The specific operation may follow the following contents.

### Rate Matching Operation

The BS may map channel A only to the remaining resource area except for resource C corresponding to the area overlapping resource B, of the entire resource A to transmit symbol sequence A to the UE and transmit it. For example, when symbol sequence A is composed of {symbol #1, symbol #2, symbol #3, symbol 4}, resource A is {resource #1, resource #2, resource #3, resource #4}, and resource B is {resource #3, resource #5}, the BS may sequentially map symbol sequence A to {resource #1, resource #2, resource #4}, which are the remaining resources except for {resource #3} corresponding to resource C from resource A and send it. As a result, the BS may map the symbol sequence {symbol #1, symbol #2, symbol #3} to {resource #1, resource #2, resource #4}, respectively, and transmit it.

The UE may determine resource A and resource B from the scheduling information for symbol sequence A from the BS and thus determine resource C which is the overlapping area between resource A and resource B. The UE may receive symbol sequence A assuming that symbol sequence A has been mapped and transmitted in the remaining area except for resource C of the entire resource A. For example, when symbol sequence A is composed of {symbol #1, symbol #2, symbol #3, symbol 4}, resource A is {resource #1, resource #2, resource #3, resource #4}, and resource B is {resource #3, resource #5}, the UE may may receive it assuming that symbol sequence A has been sequentially mapped to {resource #1, resource #2, resource #4}, which are the remaining resources except for {resource #3}corresponding to resource C from resource A. As a result, the UE may perform the subsequent series of reception operations assuming that the symbol sequence {symbol #1, symbol #2, symbol #3} is mapped to {resource #1, resource #2, resource #4}.

### Puncturing Operation

When there is resource C corresponding to the area, overlapping resource B, of the entire resource A to transmit symbol sequence A to the UE, the BS maps symbol sequence A to the entire resource A but does not perform transmission in the resource area corresponding to resource C but may perform transmission only in the remaining resource areas except for the resource C of resource A. For example, when symbol sequence A is composed of {symbol #1, symbol #2, symbol #3, symbol 4}, resource A is {resource #1, resource #2, resource #3, resource #4}, and resource B is {resource #3, resource #5}, the BS may respectively map symbol sequence A {symbol #1, symbol #2, symbol #3, symbol #4} to resource A {resource #1, resource #2, resource #3, resource #4} and may perform transmission only in the symbol sequence {symbol #1, symbol #2, symbol #4} corresponding to {resource #1, resource #2, resource #4}, which are the remaining resources except for {resource #3} corresponding to resource C, of resource A, but may not transmit {symbol #3} mapped to {resource #3} corresponding to resource C. As a result, the BS may map the symbol sequence {symbol #1, symbol #2, symbol #4} to {resource #1, resource #2, resource #4}, respectively, and transmit the symbol sequence.

The UE may determine resource A and resource B from the scheduling information for symbol sequence A from the BS and thus determine resource C which is the overlapping area between resource A and resource B. The UE may receive symbol sequence A assuming that symbol sequence A has been mapped to the entire resource A but transmission has been performed only in the remaining area except for resource C of resource area A. For example, when symbol sequence A is composed of {symbol #1, symbol #2, symbol #3, symbol 4}, resource A is {resource #1, resource #2, resource #3, resource #4}, and resource B is {resource #3, resource #5}, the UE may receive them assuming that symbol sequence A {symbol #1, symbol #2, symbol #3, symbol #4} is respectively mapped to resource A {resource #1, resource #2, resource #3, resource #4} but {symbol #3} mapped to {resource #3}corresponding to resource C is not transmitted and that the symbol sequence {symbol #1, symbol #2, symbol #4} corresponding to {resource #1, resource #2, resource #4}, which are the remaining resources except for {resource #3} corresponding to resource C, of resource A, are mapped. As a result, the UE may perform the subsequent series of reception operations assuming that the symbol sequence {symbol #1, symbol #2, symbol #4} is mapped to {resource #1, resource #2, resource #4}.

Described below is a method for configuring a rate matching resource for rate matching of a 5G communication system. Rate matching means that the size of a signal is adjusted considering the amount of resources available to transmit the signal. For example, rate matching of a data channel may mean the size of data is adjusted by refraining from mapping and transmitting a data channel for a specific time and frequency resource area.

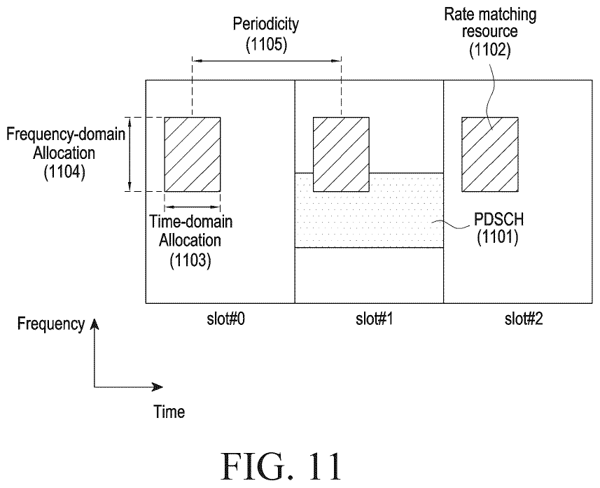

FIG. 11 illustrates a method for transmitting/receiving data considering a DL data channel and rate matching resource by a BS and a UE Referring to FIG. 11, a PDSCH 1101 and a rate matching resource 1102 are shown.

The BS may configure one or more rate matching resources 1102 to the UE through higher layer signaling (e.g., RRC signaling). The rate matching resource (1102) configuration information may include time axis resource allocation information 1103, frequency axis resource allocation information 1104, and period information 1105. In the following description, the bitmap corresponding to the frequency axis resource allocation information 1104 is referred to as a “first bitmap”, the bitmap corresponding to the time axis resource allocation information 1103 is referred to as a “second bitmap”, and the bitmap corresponding to the period information 1105 is referred to as a “third bitmap”. When the whole or part of the time and frequency resource of the scheduled data channel 1101 overlaps a configured rate matching resource 1102, the BS may rate-match the data channel 1101 in the rate matching resource (1102) portion and transmit it, and the UE may assume that in the rate matching resource (1102) portion, the data channel 1101 has been rate-matched and then perform reception and decoding.

The BS may dynamically notify the UE whether to rate-match the data channel in the configured rate matching resource portion through the DCI, through an additional configuration (this corresponds to the “rate matching indicator” in the above-described DCI format). Specifically, the BS may select some of the configured rate matching resources, group them into a rate matching resource group, and inform the UE whether the data channel is rate-matched for each rate matching resource group, through the DCI, using the bitmap scheme.

For example, when four rate matching resources, RMR #1, RMR #2, RMR #3, and RMR #4, are configured, the BS may configure rate matching groups RMG #1={RMR #1, RMR #2} and RMG #2={RMR #3, RMR #4} and may inform the UE whether rate-matching is done in RMG #1 and RMG #2, in two bits in the DCI field. For example, if rate matching is required, it may be indicated as “1”, and if rate matching is not required, it may be indicated as “0”.

5G supports granularity of “RB symbol level” and “RE level” as a method for configuring the above-described rate matching resource to the UE. More specifically, the following configuration method may be followed.

### RB Symbol Level

The UE may receive a configuration of up to four RateMatchPatterns per BWP, through higher layer signaling, and one RateMatchPattern may include the following content.
As a reserved resource in the BWP, a resource in which the time and frequency resource area of the corresponding reserved resource is configured, as a combination of the bitmap of the symbol level and the bitmap of the RB level on the frequency axis may be included. The reserved resource may span over one or two slots. A time domain pattern (periodicityAndPattern) in which the time and frequency areas configured in each RB level and symbol level bitmap pair are repeated may be additionally configured.

A time and frequency domain resource area configured as the CORESET in the BWP and the resource area corresponding to the time domain pattern configured as the search space configuration in which the corresponding resource area is repeated may be included.

### RE Level

The UE may receive a configuration of the following content through higher layer signaling.

The configuration information (lte-CRS-ToMatchAround) for the RE corresponding to the LTE CRS (e.g., cell-specific reference signal or common reference signal) pattern may include the number (nrofCRS-Ports) of LTE CRS ports and LTE-CRS-vshift(s) value (v-shift), LTE carrier center subcarrier position information (carrierFreqDL) from a reference frequency point (e.g., reference point A), LTE carrier bandwidth size (carrierBandwidthDL) information, and subframe configuration information (mbsfn-SubframeConfigList) corresponding to the multicast-broadcast single-frequency network (MBSFN). The UE may determine the position of the CRS in the NR slot corresponding to the LTE subframe based on the above-described information.

may include configuration information about the resource set corresponding to one or more zero power (ZP) CSI-RSs in the BWP may be included in the higher layer signaling.

### LTE CRS Rate Match-Related

For co-existence of LTE and new RAT (NR) (LTE-NR coexistence), NR provides a function of configuring the pattern of a cell specific reference signal (CRS) of LTE to the NR UE. More specifically, the CRS pattern may be provided by RRC signaling including at least one parameter in the ServingCellConfig IE(Information Element) or ServingCellConfigCommon IE. Examples of the parameter may include lte-CRS-ToMatchAround, lte-CRS-PatternList1-r16, lte-CRS-PatternList2-r16, and crs-RateMatch-PerCORESETPoolIndex-r16.

Rel-15 NR provides a function for configuring one CRS pattern per serving cell through the lte-CRS-ToMatchAround parameter. In Rel-16 NR, the function has been extended to allow multiple CRS patterns to be configured per serving cell. More specifically, one CRS pattern may be configured for one LTE carrier in the single-transmission and reception point (TRP) configuration UE and, in multi-TRP configuration UE, two CRS patterns may be configured for one LTE carrier. For example, in the single-TRP configuration UE, up to three CRS patterns may be configured per serving cell through the lte-CRS-PatternList1-r16 parameter. As another example, a CRS may be configured per TRP in the multi-TRP configuration UE. In other words, the CRS pattern for TRP1 may be set through the lte-CRS-PatternList1-r16 parameter, and the CRS pattern for TRP2 may be set through the lte-CRS-PatternList2-r16 parameter. However, if two TRPs are set as above, whether the CRS patterns of TRP1 and TRP2 all are applied to a specific PDSCH or only the CRS pattern for one TRP is applied is determined through the crs-RateMatch-PerCORESETPoolIndex-r16 parameter, and if the crs-RateMatch-PerCORESETPoolIndex-r16 parameter is set to enabled, only the CRS pattern of one TRP is applied, and in other cases, the CRS patterns of the two TRPs are applied.

Table 22 shows ServingCellConfig IE including the CRS pattern, and Table 23 shows RateMatchPatternLTE-CRS IE including at least one parameter for the CRS pattern.

TABLE 22
ServingCellConfig ::= SEQUENCE {

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF BWP- |

Id OPTIONAL, -- Need N

| | |
|---|---|
| downlinkBWP-ToAddModList | SEQUENCE (SIZE (1..maxNrofBWPs)) OF BWP- |

Downlink OPTIONAL, -- Need N

| | | |
|---|---|---|
| firstActiveDownlinkBWP-Id | BWP-Id | OPTIONAL, |

-- Cond SyncAndCellAdd

| | |
|---|---|
| bwp-InactivityTimer | ENUMERATED {ms2, ms3, ms4, ms5, ms6, ms8, ms10, |

ms20, ms30,

ms40,ms50, ms60, ms80,ms100, ms200,ms300, ms500,
ms750, ms1280, ms1920, ms2560, spare10, spare9, spare8,
spare7, spare6, spare5, spare4, spare3, spare2, spare1 }

OPTIONAL, -- Need R

| | | |
|---|---|---|
| defaultDownlinkBWP-Id | BWP-Id | OPTIONAL, |

-- Need S

| | |
|---|---|
| uplinkConfig UplinkConfig | OPTIONAL, |

-- Need M

| | |
|---|---|
| supplementaryUplink UplinkConfig | OPTIONAL, |

-- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, ms200, |

ms240,

ms320, ms400, ms480, ms520, ms640, ms720,
ms840, ms1280, spare2, spare1 } OPTIONAL, -- Cond

ServingCellWithoutPUCCH

| | |
|---|---|
| crossCarrierSchedulingConfig | CrossCarrierSchedulingConfig |

OPTIONAL, -- Need M
tag-Id TAG-Id,

| | |
|---|---|
| dummy ENUMERATED {enabled} | OPTIONAL, |

-- Need R

| | |
|---|---|
| pathlossReferenceLinking | ENUMERATED {spCell, sCell} |

OPTIONAL, -- Cond SCellOnly

| | |
|---|---|
| servingCellMO MeasObjectId | OPTIONAL, |

```
-- Cond MeasObject
  ...,
  [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE |

(1..maxNrofRateMatchPatterns)) OF RateMatchPattern OPTIONAL, -- Need N

| | |
|---|---|
| rateMatchPatternToReleaseList | SEQUENCE (SIZE (1..maxNrofRateMatchPatterns)) |

OF RateMatchPatternId OPTIONAL, -- Need N

| | |
|---|---|
| downlinkChannelBW-PerSCS-List | SEQUENCE (SIZE (1..maxSCSs)) OF SCS- |

```
SpecificCarrier OPTIONAL -- Need S
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL-ConfigDedicated- |

IAB-MT-r16 OPTIONAL, -- Cond TDD_IAB

| | |
|---|---|
| dormantBWP-Config-r16 | SetupRelease { DormantBWP-Config-r16 } |

```
OPTIONAL, -- Need M
  ca-SlotOffset-r16 CHOICE {
    refSCS15kHz INTEGER (−2..2),
    refSCS30KHz INTEGER (−5..5),
    refSCS60KHz INTEGER (−10..10),
    refSCS120KHz INTEGER (−20..20)
```

| | |
|---|---|
| } | OPTIONAL, -- Cond |

AsyncCA

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |

IntraCellGuardBandsPerSCS-r16 OPTIONAL, -- Need S

| | |
|---|---|
| intraCellGuardBandsUL-List-r16 | SEQUENCE (SIZE (1..maxSCSs)) OF |

IntraCellGuardBandsPerSCS-r16 OPTIONAL, -- Need S

| | |
|---|---|
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS-PatternList-r16 } |

OPTIONAL, -- Need M

| | |
|---|---|
| lte-CRS-PatternList2-r16 | SetupRelease { LTE-CRS-PatternList-r16 } |

OPTIONAL, -- Need M

| | |
|---|---|
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R

| | |
|---|---|
| enableDefaultTCI-StatePerCoresetPoolIndex-r16 | ENUMERATED {enabled} |

OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

```
TABLE 23
      - RateMatchPatternLTE-CRS
The IE RateMatchPatternLTE-CRS is used to configure a pattern to rate match around LTE
CRS. See TS 38.214 [19], clause 5.1.4.2.
RateMatchPatternLTE-CRS information element
-- ASN1START
-- TAG-RATEMATCHPATTERNLTE-CRS-START
RateMatchPatternLTE-CRS ::= SEQUENCE {
  carrierFreqDL INTEGER (0..16383),
  carrierBandwidthDL ENUMERATED {n6, n15, n25, n50, n75, n100, spare2,
spare1},
  mbsfn-SubframeConfigList EUTRA-MBSFN-SubframeConfigList
OPTIONAL, -- Need M
  nrofCRS-Ports ENUMERATED {n1, n2, n4},
  v-Shift ENUMERATED {n0, n1, n2, n3, n4, n5}
}
LTE-CRS-PatternList-r16 ::= SEQUENCE (SIZE (1..maxLTE-CRS-Patterns-r16))
OF RateMatchPatternLTE-CRS
-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19], clause
5.1.4.2).
```

### PDSCH: Processing Time

When the BS schedules the UE to transmit the PDSCH using DCI format 1_0, 1_1, or 1_2, the UE may need PDSCH processing time to receive the PDSCH by applying the transmission method directed through DCI (modulation/demodulation and coding indication index (MCS), information related to DMRSs, time and frequency resource allocation information, etc.). In NR, the PDSCH processing time was defined by considering this. The PDSCH processing time of the UE may be expressed in Equation (2) below.

$${T}_{proc , 1} = ( {N}_{1} + {d}_{1 , 1} + {d}_{2} ) ( 2048 + 144 ) {κ2}^{- μ} {T}_{c} + {T}_{ext} \qquad ( 2 )$$

In T_{proc,1} described above in Equation (2), each variable may have the following meaning.

N₁: The number of symbols determined according to UE processing capability 1 or 2 and numerology according to the capabilities of the UE. When UE processing capability 1 is reported according to the UE capability report, it may have the value of Table 24a below. When UE processing capability 2 is reported, and it is set through higher layer signaling to be able to use UE processing capability 2, it may have the value of Table 24b. The numerology may correspond to the minimum value of μ_{PDCCH}, μ_{PDSCH}, and μ_{UL} to maximize T_{proc,1}, and μ_{PDCCH}, μ_{PDSCH}, and μ_{UL} may mean the numerology of the PDCCH having scheduled the PDSCH, the numerology of the scheduled PDSCH, and the numerology of the UL channel where the HARQ-ACK is to be transmitted, respectively.

Table 24a below shows an example of a PDSCH processing time in the case of PDSCH processing capability 1.

TABLE 24a

| | PDSCH decoding time N₁ [symbols] | |
|---|---|---|
| | | When neither PDSCH mapping |
| | When both PDSCH mapping | type A nor B is dmrs- |
| | types A and B are dmrs- | AdditionalPosition = |
| | AdditionalPosition = | pos0 in higher layer |
| | pos0 in higher layer | signaling DMRS- |
| | signaling DMRS- | DownlinkConfig or higher |
| μ | DownlinkConfig. | layer parameter is not set. |
| 0 | 8 | N_{1, 0} |
| 1 | 10 | 13 |
| 2 | 17 | 20 |
| 3 | 20 | 24 |

Table 24b below shows an example of a PDSCH processing time in the case of PDSCH processing capability 2.

TABLE 24b

| | PDSCH decoding time N₁ [symbols] |
|---|---|
| | When both PDSCH mapping types A and |
| | B are dmrs-AdditionalPosition = |
| | pos0 in higher layer |
| μ | signaling DMRS-DownlinkConfig. |
| 0 | 3 |
| 1 | 4.5 |
| 2 | 9 for frequency |
| | range 1 |

κ: 64
Tₑₓₜ: When the UE uses a shared spectrum channel access scheme, the UE may calculate Tₑₓₜ and apply it to the PDSCH processing time. Otherwise, Tₑₓₜ is assumed to be 0.

If l₁ representing the PDSCH DMRS position value is 12, N1,0 in Table 24a has a value of 14, otherwise has a value of 13.

For PDSCH mapping type A, if the last symbol of PDSCH is the ith symbol in the slot where PDSCH is transmitted, and i<7, d_{1,1} is 7-i, otherwise d_{1,1} is 0.
d₂: When PUCCH with a high priority index overlaps PUCCH or PUSCH with a low priority index over time, d₂ of PUCCH with the high priority index may be set to a value reported from the UE. Otherwise, d₂ is 0.

When PDSCH mapping type B is used for UE processing capability 1, the d_{1,1} value may be determined according to L, which is the number of symbols of the PDSCH scheduled as follows, and the number d of symbols overlapping between the PDCCH scheduling PDSCH and the scheduled PDSCH.

$$if L \geq 7 , {d}_{1 , 1} = 0.$$

$$if L \geq 4 and L \leq 6 , {d}_{1 , 1} = 7 - L .$$

$$if L = 3 , {d}_{1 , 1} = min ( d , 1 ) .$$

$$if L = 2 , {d}_{1 , 1} = 3 + d .$$

When PDSCH mapping type B is used for UE processing capability 2, the d_{1,1} value may be determined according to L, which is the number of symbols of the PDSCH scheduled as follows, and the number d of symbols overlapping between the PDCCH scheduling PDSCH and the scheduled PDSCH.

$$i f L \geq 7 , {d}_{1 , 1} = 0.$$

$$if L \geq 4 and L \leq 6 , {d}_{1 , 1} = 7 - L .$$

When L=2,

When the scheduling PDCCH exists within a CORESET constituted of three symbols, and the CORESET and the scheduled PDSCH have the same start symbol, d_{1,1}=3.

Otherwise, d_{1,1}=d.

In the case of a UE supporting capability 2 within a given serving cell, the PDSCH processing time according to the UE processing capability 2 may be applied when the UE has higher layer signaling, processingType2Enabled, set to enabled for the cell.

If the position of the first UL transmission symbol of the PUCCH containing HARQ-ACK information (the corresponding position may consider K₁-defined at the transmission time of HARQ-ACK, the PUCCH resource used for HARQ-ACK transmission, and TA effect) does not start before the first UL transmission symbol appearing T_{proc,1} after the last symbol of PDSCH, the UE should transmit a valid HARQ-ACK message. In other words, the UE should transmit the PUCCH including the HARQ-ACK only when the PDSCH processing time is sufficient. Otherwise, the UE may not provide the BS with valid HARQ-ACK information corresponding to the scheduled PDSCH. T-_{proc,1} may be used for both normal and extended CP cases. For a PDSCH constituted of two PDSCH transmission positions within one slot, d_{1,1} is calculated with respect to the first PDSCH transmission position within the corresponding slot.

### PDSCH: Reception Preparation Time Upon Cross-Carrier Scheduling

Next, in the case of cross-carrier scheduling in which μ_{PDCCH} which is the numerology where PDCCH scheduled next is transmitted and μ_{PDSCH} which is the numerology where the PDSCH scheduled through the corresponding PDCCH is transmitted, N-pdsch which is the PDSCH reception preparation time of the UE defined form the time interval between PDCCH and PDSCH is described.

If μ_{PDCCH}<μ_{PDSCH}, the scheduled PDSCH may not be transmitted before the first symbol of the slot N_{pdsch} symbols after the last symbol of the PDCCH that has scheduled the PDSCH. The transmission symbol of the corresponding PDSCH may include a DM-RS.

If μ_{PDCCH}>μ_{PDSCH}, the scheduled PDSCH may be transmitted N_{pdsch} symbols after the last symbol of the PDCCH that has scheduled the PDSCH. The transmission symbol of the corresponding PDSCH may include a DM-RS.

Table 25 below illustrates an example of N_{pdsch} according to the scheduled PDCCH subcarrier interval.

TABLE 25

| μ_{PDCCH} | N_{pdsch} [symbols] |
|---|---|
| 0 | 4 |
| 1 | 5 |
| 2 | 10 |
| 3 | 14 |

### Sounding Reference Signal (SRS)

The BS may configure the UE with at least one SRS configuration for each UL BWP to transfer configuration information for SRS transmission and may configure the UE with at least one SRS resource set for each SRS configuration. As an example, the BS and the UE may exchange the following higher signaling information to transfer information regarding the SRS resource set.
srs-ResourceSetId: SRS resource set index
srs-ResourceldList: A set of SRS resource indexes referenced by SRS resource set
resourceType: A time-axis transmission configuration of the SRS resource referenced by SRS resource set. This may be set to one of ‘periodic’, ‘semi-persistent’, and ‘aperiodic’. When set to ‘periodic’ or ‘semi-persistent,’ associated CSI-RS information may be provided depending on the use of the SRS resource set. If set to ‘aperiodic’, aperiodic SRS resource trigger list and slot offset information may be provided, and associated CSI-RS information may be provided depending on the use of the SRS resource set.
usage: A configuration for the use of the SRS resource referenced by the SRS resource set and may be set to one of ‘beamManagement,’ ‘codebook,’ ‘nonCodebook,’ and ‘antennaSwitching.’
alpha, p0, pathlossReferenceRS, srs-PowerControlAdjustmentStates: This provides a parameter configuration for adjusting the transmit power of the SRS resource referenced by the SRS resource set.

The UE may understand that the SRS resource included in the set of SRS resource indexes referenced by the SRS resource set follows the information configured in the SRS resource set.

The BS and the UE may transmit/receive higher layer signaling information to transfer individual configuration information for the SRS resource. As an example, the individual configuration information for the SRS resource may include time-frequency axis mapping information in the slot of the SRS resource, which may include information for frequency hopping within or between slots of the SRS resource. The individual configuration information for the SRS resource may include the time axis transmission configuration of the SRS resource and may be set to one of ‘periodic’, ‘semi-persistent’, and ‘aperiodic’. This may pose a limitation to have the same time axis transmission configuration as the SRS resource set including the SRS resource. If the time axis transmission configuration of the SRS resource is set to ‘periodic’ or ‘semi-persistent,’ the SRS resource transmission period and slot offset (e.g., periodicityAndOffset) may be additionally included in the time axis transmission configuration.

The BS may trigger activation or deactivation for SRS transmission to the UE through RRC signaling or higher layer signaling including MAC CE signaling, or L1 signaling (e.g., DCI). For example, the BS may activate or deactivate periodic SRS transmission through higher layer signaling to the UE. The BS may instruct to activate the SRS resource set in which the resourceType is set to periodic through higher layer signaling, and the UE may transmit the SRS resource referenced by the activated SRS resource set. The time-frequency axis resource mapping in the slot of the transmitted SRS resource follows the resource mapping information configured in the SRS resource, and the slot mapping including the transmission period and the slot offset follows the periodicityAndOffset configured in the SRS resource. The spatial domain transmission filter applied to the transmitted SRS resource may reference the spatial relation info configured in the SRS resource or may reference the associated CSI-RS information configured in the SRS resource set including the SRS resource. The UE may transmit the SRS resource within the UL BWP activated for the periodic SRS resource activated through higher layer signaling.

For example, the BS may activate or deactivate semi-persistent SRS transmission through higher layer signaling to the UE. The BS may instruct to activate the SRS resource set through MAC CE signaling, and the UE may transmit the SRS resource referenced by the activated SRS resource set. The SRS resource set activated through MAC CE signaling may be limited to the SRS resource set in which the resourceType is set to semi-persistent. The time-frequency axis resource mapping in the slot of the transmitted SRS resource follows the resource mapping information configured in the SRS resource, and the slot mapping including the transmission period and the slot offset follows the periodicityAndOffset configured in the SRS resource. The spatial domain transmission filter applied to the transmitted SRS resource may reference the spatial relation info configured in the SRS resource or may reference the associated CSI-RS information configured in the SRS resource set including the SRS resource. If spatial relation info is configured in the SRS resource, rather than following it, the configuration information for the spatial relation info transferred through MAC CE signaling, which activates the semi-persistent SRS transmission, may be referenced to determine the spatial domain transmission filter. The UE may transmit the SRS resource within the UL BWP activated for the semi-persistent SRS resource activated through higher layer signaling.

For example, the BS may trigger the aperiodic SRS transmission through DCI to the UE. The BS may indicate one of aperiodic SRS resource triggers (aperiodicSRS-ResourceTrigger) through the SRS request field of DCI. The UE may understand that the SRS resource set including the aperiodic SRS resource trigger indicated through the DCI in the aperiodic SRS resource trigger list among the configuration information of the SRS resource set has been triggered. The UE may transmit the SRS resource referenced by the triggered SRS resource set. The time-frequency axis resource mapping in the slot of the transmitted SRS resource follows the resource mapping information configured in the SRS resource. The slot mapping of the transmitted SRS resource may be determined through a slot offset between the PDCCH including DCI and the SRS resource, and it may reference the value(s) included in the slot offset set configured in the SRS resource set. Specifically, as the slot offset between the PDCCH including DCI and the SRS resource, the value indicated by the time domain resource assignment field of DCI among the offset value(s) included in the slot offset set configured in the SRS resource set may be applied. The spatial domain transmission filter applied to the transmitted SRS resource may reference the spatial relation info configured in the SRS resource or may reference the associated CSI-RS information configured in the SRS resource set including the SRS resource. The UE may transmit an SRS resource within the UL BWP activated for aperiodic SRS resource triggered through DCI.

When the BS triggers aperiodic SRS transmission to the UE through DCI, the UE may require a minimum time interval between the transmitted SRS and the PDCCH including the DCI triggering the aperiodic SRS transmission so as to apply the configuration information for the SRS resource and transmit the SRS. The time interval for SRS transmission of the UE may be defined as the number of symbols between the last symbol of the PDCCH including the DCI triggering aperiodic SRS transmission and the first symbol mapped with the first SRS resource transmitted among the transmitted SRS resource(s). The minimum time interval may be determined with reference to PUSCH preparation procedure time required for UE to prepare PUSCH transmission. The minimum time interval may have a different value depending on the use of the SRS resource set including the transmitted SRS resource. For example, the minimum time interval may be determined as N2 symbols defined considering the UE processing capability according to the UE capability by referring to the UE's PUSCH preparation procedure time. When the use of the SRS resource set is set to ‘codebook’ or ‘antennaSwitching’ considering the use of the SRS resource set including the transmitted SRS resource, the minimum time interval may be determined as N2 and, when the use of SRS resource set is set to ‘nonCodebook’ or ‘beamManagement,’ the minimum time interval may be determined as N₂+14 symbols. The UE may transmit aperiodic SRS when the time interval for aperiodic SRS transmission is greater than or equal to the minimum time interval and may disregard DCI triggering aperiodic SRS when the time interval for aperiodic SRS transmission is smaller than the minimum time interval.

The spatialRelationInfo configuration information in Table 26 below is applied to the beam used for SRS transmission corresponding to the beam information about the corresponding reference signal by referring to one reference signal.

TABLE 26

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE { |

```
      ...
    },
```

| | |
|---|---|
| semi-persistent | SEQUENCE { |

| | |
|---|---|
| periodicityAndOffset-sp | SRS-PeriodicityAndOffset, |

```
      ...
    },
```

| | |
|---|---|
| periodic | SEQUENCE { |

| | |
|---|---|
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

OPTIONAL, -- Need R
...
}

For example, the configuration of spatialRelationInfo may include information such as those shown in Table 27 below.

TABLE 27

| | |
|---|---|
| SRS-SpatialRelationInfo ::= | SEQUENCE |
| servingCellId | ServCellIndex OPTIONAL, -- Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, the SS/PBCH block index, CSI-RS index, or SRS index may be set as reference signal index to be referenced for use of the beam information about a specific reference signal. The higher layer signaling referenceSignal is configuration information indicating which reference signal of beam information is to be referenced for corresponding SRS transmission, and ssb-Index, csi-RS-Index, and srs refer to the index of the SS/PBCH block, the index of the CSI-RS, and the index of the SRS, respectively. If the value of the higher layer signaling referenceSignal is set to ‘ssb-Index,’ the UE may apply the reception beam which has been used for reception of the SS/PBCH block corresponding to the ssb-Index, as the transmission beam of corresponding SRS transmission. If the value of the higher layer signaling referenceSignal is set to ‘csi-RS-Index,’ the UE may apply the reception beam which has been used for reception of the CSI-RS corresponding to the csi-RS-Index, as the transmission beam of corresponding SRS transmission. If the value of the higher layer signaling referenceSignal is set to ‘srs,’ the UE may apply the transmission beam which has been used for transmission of the SRS corresponding to the srs, as the transmission beam of corresponding SRS transmission.

### PUSCH: Transmission Scheme

Next, a scheduling method for PUSCH transmission is described. PUSCH transmission may be dynamically scheduled by UL grant in DCI or operated by configured grant type 1 or type 2. Dynamic scheduling indication for PUSCH transmission is available in DCI format 0_0 or 0_1.

Configured grant Type 1 PUSCH transmission may be semi-statically configured through reception of configuredGrantConfig including rrc-ConfiguredUplinkGrant of Table 28 below through higher layer signaling without reception of the UL grant in the DCI. Configured grant Type 2 PUSCH transmission may be semi-persistently scheduled by the UL grant in the DCI after receiving the configuredGrantConfig that does not include rrc-ConfiguredUplinkGrant of Table 28 through higher layer signaling. When PUSCH transmission is operated by the configured grant, the parameters applied to PUSCH transmission are applied through configuredGrantConfig which is the higher layer signaling of Table 28 except for the dataScramblingIdentityPUSCH, txConfig, codebookSubset, maxRank, and scaling of UCI-OnPUSCH which are provided through the pusch-Config of Table 29 below which is higher layer signaling. If the UE receives transformPrecoder through configuredGrantConfig, which is higher layer signaling of Table 28, the UE applies tp-pi2BPSK in push-Config of Table 29 for PUSCH transmission operated by the configured grant.

TABLE 28

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocation Type0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |

| | |
|---|---|
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |

| | |
|---|---|
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |

| | |
|---|---|
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method is described. The DMRS antenna port for PUSCH transmission is the same as the antenna port for SRS transmission. PUSCH transmission may follow a codebook-based transmission method and a non-codebook-based transmission method, respectively, depending on whether the value of txConfig in push-Config of Table 29, which is higher signaling, is ‘codebook’ or ‘nonCodebook’.

As described above, PUSCH transmission may be dynamically scheduled through DCI format 0_0 or 0_1 or be semi-statically configured by the configured grant. If the UE receives an instruction of scheduling on PUSCH transmission through DCI format 0_0, the UE performs beam configuration for PUSCH transmission using pucch-spatialRelationInfoID corresponding to the UE-specific PUCCH resource corresponding to the minimum ID in the UL BWP activated in the serving cell and, in this case, the PUSCH transmission is based on a single antenna port. The UE does not expect scheduling for PUSCH transmission through DCI format 0_0 in a BWP in which PUCCH resource including pucch-spatialRelationInfo is not configured. If the U has not had txConfig in push-Config of Table 29 configured thereto, the UE does not expect to be scheduled through DCI format 0_1.

TABLE 29

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)

OPTIONAL, --

Need M

| | |
|---|---|
| resourceAllocation | ENUMERATED { resourceAllocation Type0, |

resourceAllocation Type1, dynamicSwitch },

| | |
|---|---|
| pusch-TimeDomainAllocationList | SetupRelease { PUSCH- |

| | |
|---|---|
| TimeDomainResourceAllocationList } | OPTIONAL, -- Need M |

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fully AndPartialAndNonCoherent, |

partialAndNonCoherent,nonCoherent}

OPTIONAL, -- Cond

codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission is described. Codebook-based PUSCH transmission may be dynamically operated through DCI format 0_0 or 0_1 or be semi-statically configured by the configured grant. if dynamically scheduled by codebook-based PUSCH DCI format 0_1 or semi-statically configured by configured grant, the UE determines a precoder for PUSCH transmission based on the SRS resource indicator (SRI), transmission precoding matrix indicator (TPMI), and transmission rank (number of PUSCH transmission layers).

In this case, the SRI may be given through a field SRI in the DCI or configured through srs-ResourceIndicator which is higher layer signaling. The UE may have at least one SRS resource, up to two SRS resources, configured thereto upon codebook-based PUSCH transmission. When the UE receives the SRI through the DCI, the SRS resource indicated by the corresponding SRI indicates the SRS resource corresponding to the SRI among SRS resources transmitted prior to the PDCCH including the SRI. The TPMI and transmission rank may be given through the field precoding information and number of layers in the DCI or configured through precodingAndNumberOfLayers, which is higher level signaling. The TPMI is used to indicate the precoder applied to PUSCH transmission. If the UE is configured with one SRS resource, the TPMI is used to indicate a precoder to be applied in the configured one SRS resource. If the UE is configured with a plurality of SRS resources, the TPMI is used to indicate a precoder to be applied in the SRS resource indicated through the SRI.

The precoder to be used for PUSCH transmission is selected from a UL codebook having the same number of antenna ports as the nrofSRS-Ports value in SRS-Config, which is higher layer signaling. In codebook-based PUSCH transmission, the UE determines a codebook subset based on the TPMI and codebookSubset in push-Config, which is higher layer signaling. codebookSubset in push-Config, which is higher layer signaling, may be set to one of ‘fullyAndPartialAndNonCoherent’, ‘partialAndNonCoherent’, or ‘nonCoherent’ based on the UE capability reported by the UE to the BS. If the UE reports ‘partialAndNonCoherent’ as the UE capability, the UE does not expect the value of codebookSubset, which is higher layer signaling, to be set to ‘fullyAndPartialAndNonCoherent’. Further, if the UE reports ‘nonCoherent’ as the UE capability, the UE does not expect the value of codebookSubset, which is higher signaling, to be set to ‘fullyAndPartialAndNonCoherent’ or ‘partialAndNonCoherent’. If nrofSRS-Ports in SRS-ResourceSet, which is higher layer signaling, indicates two SRS antenna ports, the UE does not expect the value of codebookSubset, which is higher layer signaling, to be set to ‘partialAndNonCoherent’.

The UE may have one SRS resource set, in which the value of usage in SRS-ResourceSet, which is higher layer signaling, is set to ‘codebook,’ configured thereto, and one SRS resource in the corresponding SRS resource set may be indicated through the SRI. If several SRS resources are configured in the SRS resource set in which the usage value in the SRS-ResourceSet, which is higher layer signaling, is set to ‘codebook’, the UE expects the same value to be set for all SRS resources in the nrofSRS-Ports value in the SRS-Resource which is higher signaling.

The UE may transmit one or more SRS resources included in the SRS resource set in which the value of usage is set to ‘codebook’ according to higher layer signaling to the BS, and the BS selects one of the SRS resources transmitted by the UE and instructs the UE to perform PUSCH transmission using transmission beam information about the corresponding SRS resource. In this case, in codebook-based PUSCH transmission, the SRI is used as information for selecting an index of one SRS resource and is included in the DCI. Additionally, the BS includes information indicating the TPMI and rank to be used by the UE for PUSCH transmission in the DCI. The UE performs PUSCH transmission by applying the precoder indicated by the rank and TPMI indicated by the transmission beam of the SRS resource using the SRS resource indicated by the SRI.

Next, non-codebook-based PUSCH transmission is described. Non-codebook-based PUSCH transmission may be dynamically operated through DCI format 0_0 or 0_1 or be semi-statically configured by the configured grant. When at least one SRS resource is configured in the SRS resource set in which the value of usage in the SRS-ResourceSet, which is higher signaling, is set to ‘nonCodebook’, the UE may be scheduled for non-codebook based PUSCH transmission through DCI format 0_1.

For the SRS resource set in which the value of usage in the SRS-ResourceSet, which is higher layer signaling, is set to ‘nonCodebook’, the UE may be configured with one NZP CSI-RS. The UE may perform calculation on the precoder for SRS transmission through measurement of the NZP CSI-RS resource connected with the SRS resource set. If the difference between the last received symbol of the aperiodic NZP CSI-RS resource connected with the SRS resource set and the first symbol of aperiodic SRS transmission in the UE is smaller than 42 symbols, the UE does not expect that information about the precoder for SRS transmission is updated.

If the value of resourceType in SRS-ResourceSet, which is higher signaling, is set to ‘aperiodic’, the connected NZP CSI-RS may be indicated by an SRS request, which is a field in DCI format 0_1 or 1_1. In this case, if the connected NZP CSI-RS resource is an aperiodic NZP CSI resource, it indicates that there is a connected NZP CSI-RS for the case where the value of the field SRS request in DCI format 0_1 or 1_1 is not ‘00.’ In this case, the DCI should not indicate cross carrier or cross BWP scheduling. Further, if the value of the SRS request indicates the presence of the NZP CSI-RS, the NZP CSI-RS is positioned in the slot in which the PDCCH including the SRS request field is transmitted. In this case, the TCI states configured for the scheduled subcarriers are not set to QCL-typeD.

If a periodic or semi-persistent SRS resource set is configured, the connected NZP CSI-RS may be indicated through associatedCSI-RS in the SRS-ResourceSet, which is higher layer signaling. For non-codebook-based transmission, the UE does not expect spatialRelationInfo, which is higher signaling for SRS resource, and associatedCSI-RS in SRS-ResourceSet, which is higher layer signaling, to be configured together.

When a plurality of SRS resources are configured to the UE, the UE may determine the precoder and transmission rank to be applied to PUSCH transmission based on the SRI indicated by the BS. In this case, the SRI may be indicated through a field SRI in the DCI or be configured through srs-ResourceIndicator which is higher signaling. Like the above-described codebook-based PUSCH transmission, when the UE receives the SRI through the DCI, the SRS resource indicated by the corresponding SRI indicates the SRS resource corresponding to the SRI among SRS resources transmitted prior to the PDCCH including the SRI. The UE may use one or more SRS resources for SRS transmission. The maximum number of SRS resources and the maximum number of SRS resources that may be simultaneously transmitted in the same symbol within one SRS resource set are determined by the e UE capability reported by the UE to the BS. In this case, SRS resources transmitted simultaneously by the UE occupy the same RB. The UE configures one SRS port for each SRS resource. Only one SRS resource set in which the value of usage in the SRS-ResourceSet, which is higher signaling, is set to ‘nonCodebook’ may be configured, and up to 4 SRS resources are configured for non-codebook-based PUSCH transmission.

The BS transmits one NZP CSI-RS connected with the SRS resource set to the UE, and the UE calculates the precoder to be used for transmission of one or more SRS resources in the SRS resource set based on the measurement result upon NZP CSI-RS reception. The UE may apply the calculated precoder when transmitting one or more SRS resources in the SRS resource set with usage set to ‘nonCodebook’ to the BS, and the BS selects one or more SRS resources among one or more SRS resources received. In this case, in non-codebook based PUSCH transmission, the SRI indicates an index that may represent a combination of one or a plurality of SRS resources, and the SRI is included in the DCI. In this case, the number of SRS resources indicated by the SRI transmitted by the BS may be the number of transmission layers of the PUSCH. The UE applies the precoder applied to SRS resource transmission to each layer and transmits the PUSCH.

### PUSCH: Preparation Procedure Time

When the BS schedules the UE to transmit the PUSCH using DCI format 0_0, 0_1, or 0_2, the UE may require a PUSCH preparation procedure time to apply the transmission precoding method, number of transmission layers, and spatial domain transmission filter to the transmission method (SRS resource) indicated through the DCI and transmit the PUSCH. Given this, NR defines the PUSCH preparation procedure time. The PUSCH preparation procedure time of the UE may be expressed in Equation (3) below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{switch} , {d}_{2 , 2} ) \qquad ( 3 )$$

In T_{proc,2} described above in Equation (3), each variable may have the following meaning.

N₂: The number of symbols determined according to UE processing capability 1 or 2 and numerology according to the capabilities of the UE. When UE processing capability 1 is reported according to the UE capability report, it may have the value of Table 30 below. When UE processing capability 2 is reported, and it is set through higher layer signaling to be able to use UE processing capability 2, it may have the value of Table 31 below.

TABLE 30

| | PUSCH preparation time N₂ |
|---|---|
| μ | [symbols] |
| 0 | 10 |
| 1 | 12 |
| 2 | 23 |
| 3 | 36 |

TABLE 31

| | PUSCH preparation time N₂ |
|---|---|
| μ | [symbols] |
| 0 | 5 |
| 1 | 5.5 |
| 2 | 11 for frequency range 1 |

d_{2,1}: The number of symbols set to 0 if all of the resource elements of the first OFDM symbol of the PUSCH transmission are configured to consist only of DM-RS, and 1 otherwise.
κ: 64
μ: Of μ_{DL} or μ_{UL}, this follows the value where T_{proc,2} is bigger. μ_{DL} indicates the numerology of the DL where the PDCCH including the DCI scheduling PUSCH is transmitted, and μ_{UL} indicates the numerology of the UL where the PUSCH is transmitted.
T_{c}: This has 1/(Δfₘₐₓ·N_{f}), Δfₘₐₓ=480·10³ Hz N_{f}=4096.
d_{2,2}: This follows the BWP switching time when the DCI scheduling PUSCH indicates BWP switching and, otherwise, is 0.
d₂: When the PUCCH overlaps, in OFDM symbols on the time axis, the PUSCH having a high priority index and the PUCCH having a low priority index, the d₂ value of the PUSCH having a high priority index is used. Otherwise, d₂ is 0.
Tₑₓₜ: When the UE uses a shared spectrum channel access scheme, the UE may calculate Tₑₓₜ and apply it to the PUSCH preparation procedure time. Otherwise, Tₑₓₜ is assumed to be 0.
T_{switch}: When a UL switching interval is triggered, T_{switch} is assumed to be the switching interval time. Otherwise, it is assumed to be 0.

Considering the time axis resource mapping information for the PUSCH scheduled through DCI and the effect of the TA between UL and DL, if the first symbol of the PUSCH starts before the first UL symbol for which the CP starts T_{proc,2} after the last symbol of the PDCCH including the DCI scheduling the PUSCH, the BS and the UE determine that the PUSCH preparation procedure time is insufficient. Otherwise, the BS and the UE determine that the PUSCH preparation procedure time is sufficient. The UE may transmit the PUSCH only when the PUSCH preparation procedure time is sufficient and may disregard DCI scheduling PUSCH when the PUSCH preparation procedure time is insufficient.

### PUSCH: Repeated Transmission

Repeated transmission of a UL data channel in a 5G system is described below in detail. The 5G system supports two types, PUSCH repeated transmission type A and PUSCH repeated transmission type B, as repeated transmission methods of a UL data channel. The UE may have either PUSCH repeated transmission type A or B configured thereto by higher layer signaling.

### PUSCH Repeated Transmission Type A

As described above, by the time domain resource allocation method in one slot, the symbol length and start symbol position of the UL data channel may be transmitted, and the BS may notify the UE of the number of repeated transmissions through higher layer signaling (e.g., RRC signaling) or L1 signaling (e.g., DCI).
The UE may repeatedly transmit UL data channels, which are identical in length and start symbol to the configured UL data channel, in consecutive slots based on the number of repeated transmissions received from the BS. In this case, when at least one symbol among the symbols of the UL data channel configured to the UE or the slot configured to the UE through the DL by the BS is configured through DL, the UE omits UL data channel transmission but counts the number of UL data channel repeated transmissions.

### PUSCH Repeated Transmission Type B

As described above, as the time domain resource allocation method in one slot, the start symbol and length of the UL data channel may be transmitted, and the BS may notify the UE of the number of repeated transmissions, numberofrepetitions, through higher layer signaling (e.g., RRC signaling) or L1 signaling (e.g., DCI).

First, the nominal repetition of the UL data channel is determined as follows based on the start symbol and length of the UL data channel configured above. The slot where the nth nominal repetition starts is given by

$${K}_{s} + ⌊ \frac{S + n \cdot L}{{N}_{symb}^{slot}} ⌋ ,$$

and the symbol which starts in the slot is given by

$$mod ( S + n \cdot L , {N}_{symb}^{slot} ) .$$

The slot where the nth nominal repetition starts is given by

$$K \text{?} + ⌊ \frac{S + ( n + 1 ) \cdot L - 1}{{N}_{symb}^{slot}} ⌋ ,$$

$$\text{?} \text{indicates text missing or illegible when filed}$$

and the symbol which ends in the slot is given by

$$mod ( S + ( n + 1 ) \cdot L - 1 , {N}_{symb}^{slot} ) .$$

Here, n=0, . . . , numberofrepetitions−1, S indicates the start symbol of the configured UL data channel, and L indicates the symbol length of the configured UL data channel. κₛ indicates the slot where PUSCH transmission starts, and

$${N}_{symb}^{slot}$$

indicates the number of symbols per slot.

The UE determines an invalid symbol for PUSCH repeated transmission type B. The symbol configured through the DL by tdd-UL-DL-ConfigurationCommon or tdd-UL-DL-ConfigurationDedicated is determined to be an invalid symbol for PUSCH repeated transmission type B. Additionally, invalid symbols may be configured in higher layer parameters (e.g., InvalidSymbolPattern). As the higher layer parameter (e.g., InvalidSymbolPattern) provides a symbol level bitmap over one or two slots, an invalid symbol may be configured. 1 in the bitmap represents an invalid symbol. Additionally, the periodicity and pattern of the bitmap may be configured through the higher layer parameter (e.g. periodicityAndPattern). If the higher layer parameter (e.g. InvalidSymbolPattern) is configured, and InvalidSymbolPatternIndicator-ForDCIFormat0_1 or InvalidSymbolPatternIndicator-ForDCIFormat0_2 parameter indicates 1, the UE applies the invalid symbol pattern and, if it indicates 0, the UE does not apply the invalid symbol pattern. If the higher layer parameter (e.g. InvalidSymbolPattern) is configured, and InvalidSymbolPatternlndicator-ForDCIFormat0_1 or InvalidSymbolPatternlndicator-ForDCIFormat0_2 parameter is not configured, the UE applies the invalid symbol pattern.

After the invalid symbol is determined, for each nominal repetition, the UE may consider symbols other than the invalid symbol as valid symbols. If each nominal repetition includes one or more valid symbols, the nominal repetition may include one or more actual repetitions. Here, each actual repetition includes a contiguous set of valid symbols that may be used for PUSCH repeated transmission type B in one slot.

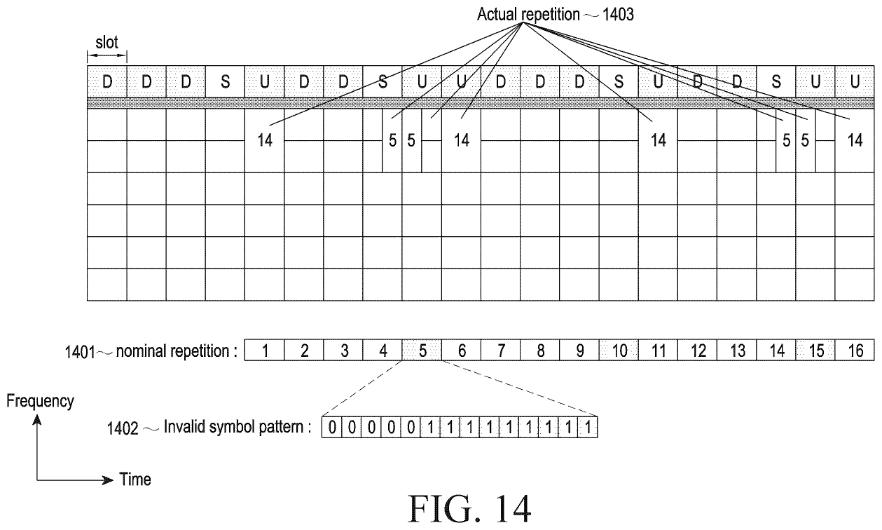

FIG. 14 illustrates an example of PUSCH repeated transmission type B in a wireless communication system according to an embodiment. The UE may have the start symbol set to 0 and the UL data channel length L set to 14 and may have the number of repeated transmissions set to 16. In this case, nominal repetition is indicated in 16 contiguous slots (1401). Thereafter, the UE may determine symbols set as DL symbols in each nominal repetition 1401 as invalid symbols. The UE determines symbols set to 1 in the invalid symbol pattern 1402 as invalid symbols. In each nominal repetition, when valid symbols, not invalid symbols, are constituted of one or more contiguous symbols in one slot, they are set as actual repetitions and transmitted (1403).

For repeated PUSCH transmission, NR Release 16 may define the following additional methods for UL grant-based PUSCH transmission and configured grant-based PUSCH transmission across slot boundaries.

Method 1 (mini-slot level repetition): Through one UL grant, two or more PUSCH repeated transmissions are scheduled within one slot or across the boundary of contiguous slots. For method 1, time domain resource allocation information in DCI indicates resources of the first repeated transmission. The time domain resource information of the remaining repeated transmissions may be determined according to the UL or DL direction that is determined for each symbol in each slot and the time domain resource information of the first repeated transmission. Each repeated transmission occupies contiguous symbols.

Method 2 (multi-segment transmission): Two or more repeated PUSCH transmissions are scheduled in contiguous slots through one UL grant. In this case, one transmission is designated for each slot, and the start point or repetition length may differ for each transmission. Further, in method 2, time domain resource allocation information in DCI indicates the start point and repetition length of all repeated transmissions. When repeated transmission is performed within a single slot through method 2, if there are several bundles of contiguous symbols in the corresponding slot, each repeated transmission is performed for each UL symbol bundle. If a unique bundle of contiguous UL symbols is present in the corresponding slot, one PUSCH repeated transmission is performed according to the method of NR release 15.

Method 3: Two or more repeated PUSCH transmissions are scheduled in contiguous slots through two or more UL grants. In this case, one transmission is designated for each slot, and the nth UL grant may be received before the PUSCH transmission scheduled by the n−1th UL grant is ended.

Method 4: Through one UL grant or one configured grant, one or more PUSCH repeated transmissions in a single slot or two or more PUSCH repeated transmissions over the boundary of consecutive slots may be supported. The number of repetitions indicated by the BS to the UE is only a nominal value, and the number of repeated PUSCH transmissions actually performed by the UE may be greater than the nominal number of repetitions. The time domain resource allocation information in DCI or configured grant indicates the resource of the first repeated transmission indicated by the BS. The time domain resource information about the remaining repeated transmissions may be determined by referring to the UL or DL direction of symbols and the resource information about at least the first repeated transmission. If the time domain resource information about the repeated transmission indicated by the BS is over the slot boundary or includes the UL/DL switching point, the corresponding repeated transmission may be divided into a plurality of repeated transmissions. In this case, one repeated transmission may be included for each UL period in one slot.

### PUSCH: Frequency Hopping Process

Frequency hopping of the UL data channel (physical UL shared channel (PUSCH)) in the 5G system is described below in detail.

5G supports two methods supported for each PUSCH repeated transmission type, as a frequency hopping method for an UL data channel. First, PUSCH repeated transmission type A supports intra-slot frequency hopping and inter-slot frequency hopping, and PUSCH repeated transmission type B supports inter-repetition frequency hopping and inter-slot frequency hopping.

The intra-slot frequency hopping method supported by PUSCH repeated transmission type A is a method in which the UE changes and transmits the allocated resources of the frequency domain by a set frequency offset in two hops within one slot. In intra-slot frequency hopping, the start RB of each hop may be expressed in Equation (4) below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad ( 4 )$$

In Equation (4), i=0 and i=1 represent the first hop and the second hop, respectively, and RBsₜₐᵣₜ denotes the start RB in the UL BWP and is calculated from the frequency resource allocation method. RB_{offset} denotes the frequency offset between two hops through the higher

layer parameter. The number of symbols in the first hop may be represented as

$$⌊ {N}_{s y m b}^{P U SCH , s} / 2 ⌋ ,$$

and the number of symbols in the second hop may be represented as

$${N}_{s y m b}^{P U SCH , s} - ⌊ {N}_{s y m b}^{P U SCH , s} / 2 ⌋ . {N}_{s y m b}^{P U S C H , s}$$

is the length of PUSCH transmission within one slot and is represented as the number of OFDM symbols.

Next, the inter-slot frequency hopping method supported by PUSCH repeated transmission types A and B is a method in which the UE changes and transmits the allocated resources of the frequency domain by a set frequency offset in each slot. In inter-slot frequency hopping, the start RB during

$${n}_{s}^{μ}$$

slot may be expressed in Equation (5) below.

$${RB}_{start} = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( 5 )$$

In Equation (5),

$${n}_{s}^{μ}$$

denotes the current slot number in multi-slot PUSCH transmission, RBₛₜₐᵣₜ denotes the start RB in the UL BWP and is calculated from the frequency resource allocation method. RB_{offset} denotes the frequency offset between two hops through the higher layer parameter.

Next, the inter-repetition frequency hopping method supported by PUSCH repeated transmission type B moves and transmits resources allocated in the frequency domain for one or more actual repetitions within each nominal repetition by a set frequency offset. RBₛₜₐᵣₜ(n) that is the index of the start RB in the frequency domain for one or more actual repetitions within the nth nominal repetition may be expressed in Equation (6) below.

$${RB}_{start} = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad ( 6 )$$

In Equation (6), n denotes the index of nominal repetition, and RB_{offset} denotes the RB offset between two hops through a higher layer parameter.

### PUSCH: Multiplexing Rule Upon AP/SP CSI Reporting

A method for measuring and reporting the channel state in a 5G communication system is described below in detail. CSI may include a channel quality information (CQI), precoding matric indicator (PMI), CSI-RS resource indicator (CRI), SS/PBCH block resource indicator (SSBRI), layer indicator (LI), rank indicator (RI), and/or L1-reference signal received power (RSRP). The BS may control time and frequency resources for the above-described CSI measurement and reporting of the UE.

For CSI measurement and reporting, the UE may receive a configuration of at least one of configuration information (CSI-ReportConfig) for N(≥1) CSI reports, configuration information (CSI-ResourceConfig) for M(≥1) RS transmission resources, or list information (CSI-AperiodicTriggerStateList, CSI-SemiPersistentOnPUSCH-TriggerStateList) for one or two trigger states through higher layer signaling. More specifically, the above-described configuration information for CSI measurement and reporting may be as shown below in Tables 32 to 38

Table 32 below shows a CSI-ReportConFG.

TABLE 32
The IE CSI-ReportConfig is used to configure a periodic or semi-
persistent report sent on PUCCH on the cell in which the CSI-
ReportConfig is included, or to configure a semi-persistent or
aperiodic report sent on PUSCH triggered by DCI received on the
cell in which the CSI-ReportConfig is included (in this case, the
cell on which the report is sent is determined by the received
DCI). See TS 38.214 [19], clause 5.2.1.
CSI-ReportConfig information element

-- ASN1START
-- TAG-CSI-REPORTCONFIG-START

| CSI-ReportConfig ::= | SEQUENCE { | | |
|---|---|---|---|
| reportConfigId | CSI-ReportConfigId, | | |
| carrier | ServCellIndex | OPTIONAL, | -- Need S |

| | |
|---|---|
| resourcesForChannelMeasurement | CSI-ResourceConfigId, |

| | | |
|---|---|---|
| csi-IM-ResourcesForInterference | CSI-ResourceConfigId | OPTIONAL, -- |

Need R

| | | |
|---|---|---|
| nzp-CSI-RS-ResourcesForInterference | CSI-ResourceConfigId | OPTIONAL, - |

- Need R

| | |
|---|---|
| reportConfigType | CHOICE { |

| | |
|---|---|
| periodic | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUCCH | SEQUENCE { |
| reportSlotConfig | CSI-ReportPeriodicityAndOffset, |

| | |
|---|---|
| pucch-CSI-ResourceList | SEQUENCE (SIZE (1..maxNrofBWPs)) OF |

PUCCH-CSI-Resource
}

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) |

OF INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1..maxNrofUL-Allocations)) |

```
OF INTEGER(0..32)
      }
  },
```

| | |
|---|---|
| reportQuantity | CHOICE { |
| none | NULL, |

| | |
|---|---|
| cri-RI-PMI-CQI | NULL, |

| | |
|---|---|
| cri-RI-i1 | NULL, |

| | |
|---|---|
| cri-RI-i1-CQI | SEQUENCE { |

| | |
|---|---|
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |

| | |
|---|---|
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, -- |

Need R

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | |
|---|---|
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |

| | |
|---|---|
| enabled | NULL, |
| disabled | SEQUENCE { |

| | |
|---|---|
| nrofReportedRS | ENUMERATED {n1, n2, n3, n4} |

```
OPTIONAL -- Need S
      }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |

| | |
|---|---|
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |

| | |
|---|---|
| reportSlotConfig-v1530 | ENUMERATED {sl4, sl8, sl16} |

| | |
|---|---|
| } | OPTIONAL -- |

```
Need R
  ]],
  [[
```

| | |
|---|---|
| semiPersistentOnPUSCH-v1610 | SEQUENCE { |
| reportSlotOffsetListDCI-0-2-r16 | SEQUENCE (SIZE (1..maxNrofUL-Allocations- |

| | | |
|---|---|---|
| r16)) OF INTEGER(0..32) | OPTIONAL, | -- Need R |

| | |
|---|---|
| reportSlotOffsetListDCI-0-1-r16 | SEQUENCE (SIZE (1..maxNrofUL-Allocations- |

| | | |
|---|---|---|
| r16)) OF INTEGER(0..32) | OPTIONAL | -- Need R |

| | |
|---|---|
| } | OPTIONAL, -- |

Need R

| | |
|---|---|
| aperiodic-v1610 | SEQUENCE { |

| | |
|---|---|
| reportSlotOffsetListDCI-0-2-r16 | SEQUENCE (SIZE (1.. maxNrofUL-Allocations- |

| | | |
|---|---|---|
| r16)) OF INTEGER(0..32) | OPTIONAL, | -- Need R |

| | |
|---|---|
| reportSlotOffsetListDCI-0-1-r16 | SEQUENCE (SIZE (1.. maxNrofUL-Allocations- |

| | | |
|---|---|---|
| r16)) OF INTEGER(0..32) | OPTIONAL | -- Need R |

| | |
|---|---|
| } | OPTIONAL, -- |

Need R

| | |
|---|---|
| reportQuantity-r16 | CHOICE { |
| cri-SINR-r16 | NULL, |

| | |
|---|---|
| ssb-Index-SINR-r16 | NULL |

| | |
|---|---|
| } | OPTIONAL, -- |

Need R

| | |
|---|---|
| codebookConfig-r16 | CodebookConfig-r16 |

OPTIONAL -- Need R
]]
}
CSI-ReportPeriodicity AndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |

| | |
|---|---|
| pucch-Resource | PUCCH-ResourceId |

}

| PortIndex For8Ranks ::= | CHOICE { | |
|---|---|---|
| portIndex8 | SEQUENCE{ | |
| rank1-8 | PortIndex8 | OPTIONAL, |

-- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| portIndex4 | SEQUENCE{ | |
|---|---|---|
| rank1-4 | PortIndex4 | OPTIONAL, |

-- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| portIndex2 | SEQUENCE{ | |
|---|---|---|
| rank1-2 | PortIndex2 | OPTIONAL, |

-- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

CSI-ReportConfig field descriptions
carrier
Indicates in which serving cell the CSI-ResourceConfig indicated below are to be found. If
the field is absent, the resources are on the same serving cell as this report configuration.
codebookConfig
Codebook configuration for Type-1 or Type-2 including codebook subset restriction.
Network does not configure codebookConfig and codebookConfig-r16 simultaneously to
a UE
cqi-FormatIndicator
Indicates whether the UE shall report a single (wideband) or multiple (subband) CQI. (see
TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the field
“carrier” above. The CSI-ResourceConfig indicated here contains only CSI-IM resources.
The bwp-Id in that CSI-ResourceConfig is the same value as the bwp-Id in the CSI-
Resource Config indicated by resourcesForChannelMeasurement.
csi-ReportingBand
Indicates a contiguous or non-contiguous subset of subbands in the bandwidth part which
CSI shall be reported for. Each bit in the bit-string represents one subband. The right-most
bit in the bit string represents the lowest subband in the BWP. The choice determines the
number of subbands (subbands3 for 3 subbands, subbands4 for 4 subbands, and so on)
(see TS 38.214 [19], clause 5.2.1.4). This field is absent if there are less than 24 PRBs (no
sub band) and present otherwise, the number of sub bands can be from 3 (24 PRBs, sub
band size 8) to 18 (72 PRBs, sub band size 4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked
ResourceConfig for channel measurement, a port indication for each rank R, indicating
which R ports to use. Applicable only for non-PMI feedback (see TS 38.214 [19], clause
5.2.1.4.2).
The first entry in non-PMI-PortIndication corresponds to the NZP-CSI-RS-Resource
indicated by the first entry in nzp-CSI-RS-Resources in the NZP-CSI-RS-ResourceSet
indicated in the first entry of nzp-CSI-RS-ResourceSetList of the CSI-ResourceConfig
whose CSI-ResourceConfigId is indicated in a CSI-MeasId together with the above CSI-
ReportConfigId; the second entry in non-PMI-PortIndication corresponds to the NZP-
CSI-RS-Resource indicated by the second entry in nzp-CSI-RS-Resources in the NZP-CSI-
RS-ResourceSet indicated in the first entry of nzp-CSI-RS-ResourceSetList of the same
CSI-ResourceConfig, and so on until the NZP-CSI-RS-Resource indicated by the last
entry in nzp-CSI-RS-Resources in the in the NZP-CSI-RS-ResourceSet indicated in the
first entry of nzp-CSI-RS-ResourceSetList of the same CSI-ResourceConfig. Then the next
entry corresponds to the NZP-CSI-RS-Resource indicated by the first entry in nzp-CSI-
RS-Resources in the NZP-CSI-RS-ResourceSet indicated in the second entry of nzp-CSI-
RS-ResourceSetList of the same CSI-ResourceConfig and so on.
nrofReportedRS
The number (N) of measured RS resources to be reported per report setting in a non-
group-based report. N <= N_max, where N_max is either 2 or 4 depending on UE
capability.
(see TS 38.214 [19], clause 5.2.1.4) When the field is absent the UE applies the value 1.
nzp-CSI-RS-ResourcesForInterference
NZP CSI RS resources for interference measurement. csi-ResourceConfigId of a CSI-
ResourceConfig included in the configuration of the serving cell indicated with the field
“carrier” above. The CSI-ResourceConfig indicated here contains only NZP-CSI-RS
resources. The bwp-Id in that CSI-ResourceConfig is the same value as the bwp-Id in the
CSI-ResourceConfig indicated by resourcesForChannelMeasurement.
p0alpha
Index of the p0-alpha set determining the power control for this CSI report transmission
(see TS 38.214 [19], clause 6.2.1.2).
pdsch-Bundle Size ForCSI
PRB bundling size to assume for CQI calculation when reportQuantity is CRI/RI/i1/CQI.
If the field is absent, the UE assumes that no PRB bundling is applied (see TS 38.214
[19], clause 5.2.1.4.2).
pmi-FormatIndicator
Indicates whether the UE shall report a single (wideband) or multiple (subband) PMI. (see
TS 38.214 [19], clause 5.2.1.4).
pucch-CSI-Resource List
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1. If the field
reportQuantity-r16 is present, UE shall ignore reportQuantity (without suffix).
reportSlotConfig
Periodicity and slot offset (see TS 38.214 [19], clause 5.2.1.4). If the field
reportSlotConfig-v1530 is present, the UE shall ignore the value provided in
reportSlotConfig (without suffix).
reportSlotOffsetList, reportSlotOffsetListDCI-0-1, reportSlotOffsetListDCI-0-2
Timing offset Y for semi persistent reporting using PUSCH. This field lists the allowed
offset values. This list must have the same number of entries as the pusch-
TimeDomainAllocationList in PUSCH-Config. A particular value is indicated in DCI. The
network indicates in the DCI field of the UL grant, which of the configured report slot
offsets the UE shall apply. The DCI value 0 corresponds to the first report slot offset in
this list, the DCI value 1 corresponds to the second report slot offset in this list, and so on.
The first report is transmitted in slot n + Y, second report in n + Y + P, where P is the
configured periodicity.
Timing offset Y for aperiodic reporting using PUSCH. This field lists the allowed offset
values. This list must have the same number of entries as the pusch-
TimeDomainAllocationList in PUSCH-Config. A particular value is indicated in DCI. The
network indicates in the DCI field of the UL grant, which of the configured report slot
offsets the UE shall apply. The DCI value 0 corresponds to the first report slot offset in
this list, the DCI value 1 corresponds to the second report slot offset in this list, and so on
(see TS 38.214 [19], clause 6.1.2.1). The field reportSlotOffsetList applies to DCI format
0_0, the field reportSlotOffsetListDCI-0-1 applies to DCI format 0_1 and the field
reportSlotOffsetListDCI-0-2 applies to DCI format 0_2 (see TS 38.214 [19], clause
6.1.2.1).
resourcesForChannelMeasurement
Resources for channel measurement. csi-ResourceConfigId of a CSI-ResourceConfig
included in the configuration of the serving cell indicated with the field “carrier” above.
The CSI-ResourceConfig indicated here contains only NZP-CSI-RS resources and/or SSB
resources. This CSI-ReportConfig is associated with the DL BWP indicated by bwp-Id in
that CSI-ResourceConfig.
subbandSize
Indicates one out of two possible BWP-dependent values for the subband size as indicated
in TS 38.214 [19], table 5.2.1.4-2. If csi-ReportingBand is absent, the UE shall ignore this
field.
timeRestrictionForChannelMeasurements
Time domain measurement restriction for the channel (signal) measurements (see TS
38.214 [19], clause 5.2.1.1).
timeRestrictionForInterferenceMeasurements
Time domain measurement restriction for interference measurements (see TS 38.214 [19],
clause 5.2.1.1).

### Table 33

The IL CSI-ResourceConfig defines a group of one or more NZP-CSI-RS-ResourceSet, CSI-IM-ResourceSet and/or CSI-SSB-ResourceSet.

### CSI-ResourceConfig Information Element

TABLE 33
The IE CSI-ResourceConfig defines a group of one or more NZP-CSI-
RS-ResourceSet, CSI-IM-ResourceSet and/or CSI-SSB-ResourceSet.
CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

OPTIONAL,

-- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

CSI-ResourceConfig field descriptions
bwp-Id
The DL BWP which the CSI-RS associated with this CSI-ResourceConfig are located in
(see TS 38.214 [19], clause 5.2.1.2.
csi-IM-ResourceSetList
List of references to CSI-IM resources used for beam measurement and reporting in a CSI-
RS resource set. Contains up to maxNrofCSI-IM-ResourceSetsPerConfig resource sets if
resourceType is ‘aperiodic’ and 1 otherwise (see TS 38.214 [19], clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and reporting in a CSI-RS
resource set (see TS 38.214 [19], clause 5.2.1.2).
nzp-CSI-RS-ResourceSetList
List of references to NZP CSI-RS resources used for beam measurement and reporting in a
CSI-RS resource set. Contains up to maxNrofNZP-CSI-RS-ResourceSetsPerConfig
resource sets if resourceType is ‘aperiodic’ and 1 otherwise (see TS 38.214 [19], clause
5.2.1.2).
resourceType
Time domain behavior of resource configuration (see TS 38.214 [19], clause 5.2.1.2). It
does not apply to resources provided in the csi-SSB-ResourceSetList.

Table 34 below shows an NZP-CSI-RS-ResourceSet.

TABLE 34
The IE NZP-CSI-RS-ResourceSet is a set of Non-Zero-Power
(NZP) CSI-RS resources (their IDs) and set-specific parameters.
NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

| ResourcesPerSet)) OF NZP-CSI-RS-ResourceId, | |
|---|---|
| repetition | ENUMERATED { on, off } |

OPTIONAL, -- Need S

| | |
|---|---|
| aperiodicTriggeringOffset | INTEGER(0..6) |

| OPTIONAL, -- Need S | |
|---|---|
| trs-Info | ENUMERATED {true} |

```
OPTIONAL, -- Need R
  ...,
  [[
```

| | |
|---|---|
| aperiodicTriggeringOffset-r16 | INTEGER(0..31) |

OPTIONAL -- Need S
]]
}
-- TAG-NZP-CSI-RS-RESOURCESET-STOP
-- ASN1STOP

NZP-CSI-RS-ResourceSet field descriptions
aperiodicTriggeringOffset, aperiodicTriggeringOffset-r16
Offset X between the slot containing the DCI that triggers a set of aperiodic NZP CSI-RS
resources and the slot in which the CSI-RS resource set is transmitted. For
aperiodicTriggeringOffset, the value 0 corresponds to 0 slots, value 1 corresponds to 1
slot, value 2 corresponds to 2 slots, value 3 corresponds to 3 slots, value 4 corresponds to 4
slots, value 5 corresponds to 16 slots, value 6 corresponds to 24 slots. For
aperiodicTriggeringOffset-r16, the value indicates the number of slots. The network
configures only one of the fields. When neither field is included, the UE applies the value
0.
nzp-CSI-RS-Resources
NZP-CSI-RS-Resources associated with this NZP-CSI-RS resource set (see TS 38.214
[19], clause 5.2). For CSI, there are at most 8 NZP CSI RS resources per resource set.
repetition
Indicates whether repetition is on/off. If the field is set to off or if the field is absent, the
UE may not assume that the NZP-CSI-RS resources within the resource set are transmitted
with the same downlink spatial domain transmission filter (see TS 38.214 [19], clauses
5.2.2.3.1 and 5.1.6.1.2). It can only be configured for CSI-RS resource sets which are
associated with CSI-ReportConfig with report of L1 RSRP or “no report”.
trs-Info
Indicates that the antenna port for all NZP-CSI-RS resources in the CSI-RS resource set is
same. If the field is absent or released the UE applies the value false (see TS 38.214 [19],
clause 5.2.2.3.1).

### Table 35

The IE CSI-SSB-ResourceSet is used to configure one SS/PBCH block resource set which refers to SS/PBCH as indicated in ServingCellConfigCommon.

### CSI-SSB-ResourceSet Information Element

TABLE 35
The IE CSI-SSB-ResourceSet is used to configure
one SS/PBCH block resource set which refers to
SS/PBCH as indicated in ServingCellConfigCommon.
CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

ResourcePerSet)) OF SSB-Index,
...
}
-- TAG-CSI-SSB-RESOURCESET-STOP
-- ASN1STOP

Table 36 below shows a CSI-IM-ResourceSet.

TABLE 36
The IE CSI-IM-ResourceSet is used to configure a set
of one or more CSI Interference Management (IM)
resources (their IDs) and set-specific parameters.
CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

ResourcesPerSet)) OF CSI-IM-ResourceId,
...
}
-- TAG-CSI-IM-RESOURCESET-STOP
-- ASN1STOP

CSI-IM-ResourceSet field descriptions
csi-IM-Resources
CSI-IM-Resources associated with this CSI-IM-ResourceSet (see TS
38.214 [19], clause 5.2)

Table 37 below shows a CSI-AperiodicTriggerStateList.

TABLE 37
The CSI-AperiodicTriggerStateList IE is used to configure the UE with
a list of aperiodic trigger states. Each codepoint of the DCI field “CSI
request” is associated with one trigger state. Upon reception of the
value associated with a trigger state, the UE will perform measurement of
CSI-RS (reference signals) and aperiodic reporting on L1 according to
all entries in the associatedReportConfigInfoList for that trigger state.
CSI-Aperiodic TriggerState List information element

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-
AssociatedReportConfigInfo,
...
}

| | |
|---|---|
| CSI-AssociatedReportConfigInfo ::= | SEQUENCE { |

| | |
|---|---|
| reportConfigId | CSI-ReportConfigId, |

| | |
|---|---|
| resourcesForChannel | CHOICE { |

| | |
|---|---|
| nzp-CSI-RS | SEQUENCE { |

| | |
|---|---|
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-Stateld OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |

| | |
|---|---|
| ResourceSetsPerConfig) | OPTIONAL, -- Cond CSI-IM-ForInterference |

nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

...
}
-- TAG-CSI-APERIODICTRIGGERSTATELIST-STOP
-- ASN1STOP

CSI-AssociatedReportConfigInfo field descriptions
csi-IM-ResourcesForInterference
CSI-IM-ResourceSet for interference measurement. Entry number in csi-IM-
ResourceSetList in the CSI-ResourceConfig indicated by csi-IM-
ResourcesForInterference in the CSI-ReportConfig indicated by reportConfigId above (1
corresponds to the first entry, 2 to the second entry, and so on). The indicated CSI-IM-
ResourceSet should have exactly the same number of resources like the NZP-CSI-RS-
ResourceSet indicated in nzp-CSI-RS-ResourcesforChannel.
csi-SSB-ResourceSet
CSI-SSB-ResourceSet for channel measurements. Entry number in csi-SSB-
ResourceSetList in the CSI-ResourceConfig indicated by
resourcesForChannelMeasurement in the CSI-ReportConfig indicated by reportConfigId
above (1 corresponds to the first entry, 2 to the second entry, and so on).
nzp-CSI-RS-ResourcesForInterference
NZP-CSI-RS-ResourceSet for interference measurement. Entry number in nzp-CSI-RS-
ResourceSetList in the CSI-ResourceConfig indicated by nzp-CSI-RS-
ResourcesForInterference in the CSI-ReportConfig indicated by reportConfigId above (1
corresponds to the first entry, 2 to the second entry, and so on).
qcl-info
List of references to TCI-States for providing the QCL source and QCL type for each
NZP-CSI-RS-Resource listed in nzp-CSI-RS-Resources of the NZP-CSI-RS-
ResourceSet indicated by nzp-CSI-RS-ResourcesforChannel. Each TCI-StateId refers to
the TCI-State which has this value for tci-StateId and is defined in tci-
StatesToAddModList in the PDSCH-Config included in the BWP-Downlink
corresponding to the serving cell and to the DL BWP to which the
resourcesForChannelMeasurement (in the CSI-ReportConfig indicated by
reportConfigId above) belong to. First entry in qcl-info-forChannel corresponds to first
entry in nzp-CSI-RS-Resources of that NZP-CSI-RS-ResourceSet, second entry in qcl-
info-forChannel corresponds to second entry in nzp-CSI-RS-Resources, and so on (see
TS 38.214 [19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-RS-
ResourceSetList in the CSI-ResourceConfig indicated by
resourcesForChannelMeasurement in the CSI-ReportConfig indicated by reportConfigId
above (1 corresponds to the first entry, 2 to the second entry, and so on).

| Conditional Presence | Explanation |
|---|---|
| Aperiodic | The field is mandatory present if the NZP-CSI-RS- |
| | Resources in the associated resourceSet have the |
| | resourceType aperiodic. The field is absent otherwise. |
| CSI-IM-ForInterference | This field is optional need M if the CSI-ReportConfig |
| | identified by reportConfigId is configured with csi-IM- |
| | ResourcesForInterference; otherwise it is absent. |
| NZP-CSI-RS- | This field is optional need M if the CSI-ReportConfig |
| ForInterference | identified by reportConfigId is configured with nzp-CSI- |
| | RS-ResourcesForInterference; otherwise it is absent. |

Table 38 below shows a CSI-SemiPersistentOnPUSCH-TriggerStateList.

TABLE 38
The CSI-SemiPersistentOnPUSCH-TriggerStateList IE is used to configure
the UE with list of trigger states for semi-persistent reporting of
channel state information on L1. See also TS 38.214 [19], clause 5.2.
CSI-SemiPersistentOnPUSCH-TriggerStateList information element

```
-- ASN1START
-- TAG-CSI-SEMIPERSISTENTONPUSCHTRIGGERSTATELIST-START
CSI-SemiPersistentOnPUSCH-TriggerStateList ::= SEQUENCE(SIZE
(1..maxNrOfSemiPersistentPUSCH-Triggers)) OF CSI-SemiPersistentOnPUSCH-
TriggerState
CSI-SemiPersistentOnPUSCH-TriggerState ::= SEQUENCE {
  associatedReportConfigInfo CSI-ReportConfigId,
  ...
}
-- TAG-CSI-SEMIPERSISTENTONPUSCHTRIGGERSTATELIST-STOP
-- ASN1STOP
```

For the above-described CSI report configuration (CSI-ReportConfig), each report configuration CSI-ReportConfig may be associated with the CSI resource configuration associated with the report configuration and one DL BWP identified by the higher layer parameter BWP ID (bwp-id) given as CSI-ResourceConFIG. As time domain reporting for each report configuration CSI-ReportConfig, ‘aperiodic,’ ‘semi-persistent,’ and ‘periodic’ schemes may be supported, and be configured from the BS to the UE by the reportConfigType parameter configured from the higher layer. The semi-persistent CSI reporting method supports ‘PUCCH-based semi-persistent (semi-PersistentOnPUCCH)’ and ‘PUSCH-based semi-persistent (semi-PersistentOnPUSCH)’. In the case of the periodic or semi-persistent CSI reporting method, the UE may receive a configuration of a PUCCH or PUSCH resource for transmitting CSI from the BS through higher layer signaling. The period and slot offset of the PUCCH or PUSCH resource to transmit CSI may be given as a numerology of a UL BWP configured to transmit a CSI report. In the case of the aperiodic CSI reporting method, the UE may receive a scheduling of a PUSCH resource for transmitting the CSI from the BS through L1 signaling (above-described DCI format 0_1).

For the above-described CSI resource configuration (CSI-ResourceConfig), each CSI resource configuration CSI-ReportConfig may include S (≥1) CSI resource sets (given as the higher layer parameter csi-RS-ResourceSetlist). The CSI resource set list may be composed of an NZP CSI-RS resource set and an SS/PBCH block set or of a CSI-interference measurement (CSI-IM) resource set. Each CSI resource configuration may be positioned in the DL BWP identified by the higher layer parameter bwp-id. The CSI resource configuration may be connected to CSI report configuration of the same DL BWP. The time domain operation of the CSI-RS resource in the CSI resource configuration may be set to one of ‘aperiodic’, ‘periodic’ or ‘semi-persistent’ from the higher layer parameter resourcetype. For periodic or semi-persistent CSI resource configuration, the number of CSI-RS resource sets may be limited to S=1. The configured period and slot offset may be given as a numerology of the DL BWP identified by bwp-id. The UE may receive a configuration of one or more CSI resource configurations for channel or interference measurement from the BS through higher layer signaling. For example, the following CSI resources may be included.
CSI-IM resource for interference measurement
NZP CSI-RS resource for interference measurement
NZP CSI-RS resource for channel measurement

For CSI-RS resource sets associated with the resource in which the higher layer parameter resourceType is configured as ‘aperiodic’, ‘periodic’, or ‘semi-persistent’, the resource configuration for channel or interference measurement for one or more component cells (CCs) and the trigger state for the CSI report configuration in which the reportType is set to ‘aperiodic’ may be configured by the higher layer parameter CSI-AperiodicTriggerStateList.

The aperiodic CSI reporting of the UE may use the PUSCH, and the periodic CSI reporting may use the PUCCH. The semi-persistent CSI reporting may be performed using the PUSCH when triggered or activated by the DCI or using the PUCCH after activated by the MAC control element (CE). As described above, CSI resource configuration may also be configured aperiodically, periodically, or semi-persistently. The combination between the CSI report configuration and the CSI resource configuration may be supported based on Table 39 below.

TABLE 39
Table 5.2.1.4-1: Triggering/Activation of CSI Reporting
for the possible CSI-RS Configurations.

| CSI-RS | Periodic CSI | Semi-Persistent CSI | Aperiodic CSI |
|---|---|---|---|
| Configuration | Reporting | Reporting | Reporting |
| Periodic CSI-RS | No dynamic | For reporting on PUCCH, | Triggered by DCI; |
| | triggering/ | the UE receives an | additionally, activation |
| | activation | activation command [10, TS | command [10, TS 38.321] |
| | | 38.321]; for reporting on | possible as defined in |
| | | PUSCH, the UE receives | Subclause: 5.2.1.5.1. |
| | | triggering on DCI | |
| Semi-Persistent | Not Supported | For reporting on PUCCH, | Triggered by DCI; |
| CSI-RS | | the UE receives an | additionally, activation |
| | | activation command [10, TS | command [10, TS 38.321] |
| | | 38.321]; for reporting on | possible as defined in |
| | | PUSCH, the UE receives | Subclause 5.2.1.5.1. |
| | | triggering on DCI | |
| Aperiodic CSI-RS | Not Supported | Not Supported | Triggered by DCI; |
| | | | additionally, activation |
| | | | command [10, TS 38.321] |
| | | | possible as defined in |
| | | | Subclause 5.2.1.5.1. |

The aperiodic CSI reporting may be triggered with the above-described DCI format 0_1 “CSI request” corresponding to the scheduling DCI for the PUSCH. The UE may monitor the PDCCH, obtain DCI format 0_1, and obtain scheduling information for PUSCH and a CSI request indicator. The CSI request indicator may be set with NTS(=0, 1, 2, 3, 4, 5, or 6) bits and be determined by the higher layer signaling (reportTriggerSize). One trigger state among one or a plurality of aperiodic CSI reporting trigger states that may be configured by higher layer signaling (CSI-AperiodicTriggerStatelist) may be triggered by the CSI request indicator.

When all bits of the CSI request field are 0, this may mean that no CSI report is requested.

If the number M of CSI trigger states in the configured CSI-AperiodicTriggerStateLite is greater than 2NTs-1, M CSI trigger states may be mapped to 2NTs-1 according to a predefined mapping relationship, and one trigger state among the 2NTs-1 trigger states may be indicated by the CSI request field.

If the number M of CSI trigger states in the configured CSI-AperiodicTriggerStateLite is equal to or smaller than 2NTs-1, one of the M CSI trigger states may be indicated by the CSI request field.

Table 40 below illustrates an example of a relationship between the CSI request indicator and the CSI trigger state that may be indicated by the indicator.

TABLE 40

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

For the CSI resource in the CSI trigger state triggered by the CSI request field, the UE may perform measurement, generating CSI (including at least one or more of above-described CQI, PMI, CRI, SSBRI, LI, RI, or L1-RSRP). The UE may transmit the obtained CSI by the PUSCH scheduled by the corresponding DCI format 0_1. When one bit corresponding to the UL data indicator (UL-SCH indicator) in DCI format 0_1 indicates “1”, UL data (UL-SCH) and the obtained CSI may be multiplexed to the PUSCH resource scheduled by DCI format 0_1 and be transmitted. When one bit corresponding to the UL data indicator (UL-SCH indicator) in DCI format 0_1 indicates “0”, only CSI, without the UL data (UL-SCH), may be mapped to the PUSCH resource scheduled by DCI format 0_1 and be transmitted.

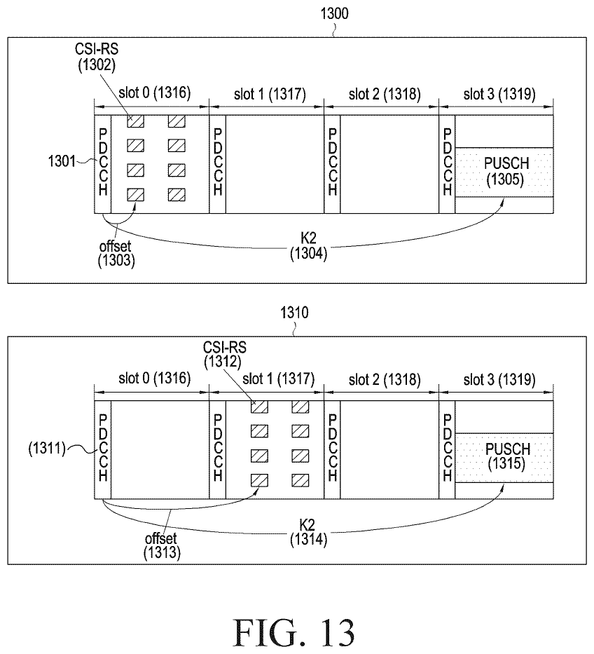

FIG. 13 illustrates an example of an aperiodic CSI reporting method.

In the example 1300 of FIG. 13, the UE may obtain DCI format 01 by monitoring the PDCCH 1301, obtaining scheduling information and CSI request information for the PUSCH 1305. The UE may obtain resource information for the CSI-RS 1302 to be measured from the received CSI request indicator. The UE may determine to perform measurement on the CSI-RS (1302) resource transmitted at what time, based on the time of reception of DCI format 0_1 and parameter (above-described aperiodicTriggringOffset) for the offset in the CSI resource set configuration (e.g., NZP CSI-RS resource set configuration (NZP-CSI-RS-ResourceSet)). Specifically, the UE may receive a configuration of offset value X of the parameter aperiodicTriggeringOffset in the NZP-CSI-RS resource set configuration from the BS by higher layer signaling, and the configured offset value X may mean an offset between the slot where the DCI for triggering aperiodic CSI reporting is received and the slot where the CSI-RS resource is transmitted. For example, the aperiodicTriggeringOffset parameter value and offset value X may have a mapping relationship shown in Table 41 below.

TABLE 41

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

In the example 1300 of FIG. 13, an example in which the above-described offset value is set as X=0 is shown. In this case, the UE may receive the CSI-RS 1302 in the slot where DCI format 0_1 for triggering aperiodic CSI reporting is received (corresponding to slot 0 1306 of FIG. 13) and report the CSI information measured with the received CSI-RS to the BS through the PUSCH 1305. The UE may obtain scheduling information (information corresponding to each field of the above-described DCI format 0_1) for the PUSCH 1305 for CSI reporting from DCI format 0_1. As an example, the UE may obtain information about the slot to transmit the PUSCH 1305 from the above-described time domain resource allocation information for the PUSCH 1305. In the example 1300 of FIG. 13, the UE obtains 3 as the K2 value corresponding to the slot offset value for PDCCH-to-PUSCH so that the PUSCH 1305 may be transmitted in slot 3 1309 which is three slots away from slot 0 1306 which is the time of reception of the PDCCH 1301.

In the example 1310 of FIG. 13, the UE may obtain DCI format 0_1 by monitoring the PDCCH 1311, obtaining scheduling information and CSI request information for the PUSCH 1315. The UE may obtain resource information for the CSI-RS 1312 to be measured from the received CSI request indicator. In the example 1310 of FIG. 13, an example in which the above-described offset value for the CSI-RS is set as X=1 is shown. In this case, the UE may receive the CSI-RS 1312 in the next slot (corresponding to slot 1 1317) following the slot where DCI format 0_1 for triggering aperiodic CSI reporting is received (corresponding to slot 0 1316 of FIG. 13) and report the CSI information measured with the received CSI-RS to the BS through the PUSCH 1315. The UE may obtain scheduling information (information corresponding to each field of the above-described DCI format 0_1) for the PUSCH 1315 for CSI reporting from DCI format 0_1. As an example, the UE may obtain information about the slot to transmit the PUSCH 1315 from the above-described time domain resource allocation information for the PUSCH 1315. In the example 1310 of FIG. 13, the UE obtains 3 as the K2 value corresponding to the slot offset value for PDCCH-to-PUSCH so that the PUSCH 1315 may be transmitted in slot 3 1319 which is three slots away from slot 0 1306 which is the time of reception of the PDCCH 1301.

The aperiodic CSI reporting may include at least one or both of CSI part 1 or CSI part 2 and, when the aperiodic CSI reporting is transmitted through PUSCH, it may be multiplexed with the transport block. For multiplexing, the CRC may be inserted into the input bit of the aperiodic CSI, then undergo encoding and rate matching, and be then mapped to the resource element in the PUSCH in a specific pattern and transmitted. The CRC insertion may be omitted according to the coding method or length of the input bits. Upon multiplexing CSI part 1 or CSI part 2 included in the aperiodic CSI reporting, the number of modulation symbols calculated for rate matching may be calculated as shown in Table 42 below.

```
TABLE 42
For CSI part 1 transmission on PUSCH not using repetition type B with UL-SCH, the
number of coded modulation symbols per layer for CSI part 1 transmission, denoted as
${Q}_{CSI - part 1}^{′} , is determined as follows :$
${Q}_{CSI - 1}^{′} = min \{ ⌈ \frac{\begin{matrix}( {O}_{CSI - 1} + {L}_{CSI - 1} ) \cdot \\ {β}_{offset}^{PUSCH} \cdot {\sum }_{l = 0}^{{N}_{symb , all}^{PUSCH} - 1} {M}_{sc}^{UCI} ( l )\end{matrix}}{{\sum }_{r = 0}^{{C}_{UL - SCH}^{} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
. . .
For CSI part 1 transmission on an actual repetition of a PUSCH with repetition Type B
with UL-SCH, the number of coded modulation symbols per layer for CSI part 1
$transmission , denoted as {Q}_{CSI - part 1}^{′} , is determined as follows :$
$\begin{matrix}{Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH}^{} - 1} {K}_{r}} ⌉ , \\ ⌈ α \cdot {{{\sum }^{{N}_{symb , nominal}^{PUSCH} - 1}}_{l = 0}}_{}^{} {M}_{sc , nominal}^{UCI} ( l ) ⌉ - {Q}_{ACK / CG - UCI}^{′} , {{{\sum }^{{N}_{symb , actual}^{PUSCH} - 1}}_{l = 0}}_{}^{} {M}_{sc , actual}^{UCI} ( l ) - {Q}_{ACK / CG - UCI}^{′} \}\end{matrix}$
. . .
For CSI part 1 transmission on PUSCH without UL-SCH, the number of coded modulation
symbols per layer for CSI part 1 transmission, denoted as QCSI-part1, is determined as
follows:
if there is CSI part 2 to be transmitted on the PUSCH,
      ${Q}_{CSI - 1}^{′} = min \{ ⌈ \frac{( {o}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
else
          ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
. . .
For CSI part 2 transmission on PUSCH not using repetition type B with UL-SCH, the
number of coded modulation symbols per layer for CSI part 2 transmission, denoted as
${Q}_{CSI - part 2}^{′} , is determined as follows :$
${Q}_{CSI - 2}^{′} = min \{ ⌈ \frac{\begin{matrix}( {O}_{CSI - 2} + {L}_{CSI - 2} ) \cdot \\ {β}_{offset}^{PUSCH} \cdot {\sum }_{l = 0}^{{N}_{symb , all}^{PUSCH} - 1} {M}_{sc}^{UCI} ( l )\end{matrix}}{{\sum }_{r = 0}^{{C}_{UL - SCH}^{} - 1} {K}_{r}} ⌉ , ⌈ α \cdot {{\sum }_{l = 0}^{{N}_{symb , all}^{PUSCH} - 1}}_{}^{} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition Type B
with UL-SCH, the number of coded modulation symbols per layer for CSI part 2
$transmission , denoted as {Q}_{CSI - part 2}^{′} , is determined as follows :$
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH}^{} - 1} {K}_{r}} ⌉ , ⌈ α \cdot {{{\sum }^{{N}_{symb , nominal}^{PUSCH} - 1}}_{l = 0}}_{}^{} {M}_{sc , nominal}^{UCI} ( l ) ⌉ - {Q}_{ACK / CG - UCI}^{′} - {Q}_{CSI - 1}^{′} , {{{\sum }^{{N}_{symb , actual}^{PUSCH} - 1}}_{l = 0}}_{}^{} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of coded modulation
$symbols per layer for CSI part 2 transmission , denoted as {Q}_{CSI - part 2}^{′} , is determined as follows :$
follows:
      ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

In particular, in PUSCH repeated transmission schemes A and B, the UE may multiplex the aperiodic CSI reporting only upon the first repeated transmission among the PUSCH repeated transmissions and transmit it. For this reason, the aperiodic CSI reporting information multiplexed is encoded in a polar code scheme. In this case, for multiplexing to several PUSCH repetitions, each PUSCH repetition should have the same frequency and time resource allocation. In particular, in PUSCH repetition type B, each actual repetition may have a different OFDM symbol length, so that the aperiodic CSI reporting may be multiplexed only in the first PUSCH repetition and transmitted.

When, for the PUSCH repeated transmission scheme B, the UE receives the DCI for activating the semi-permanent CSI reporting or scheduling the aperiodic CSI reporting without scheduling the transport block, although the number of PUSCH repeated transmissions set by higher layer signaling is greater than 1, the value of nominal repetition may be assumed to be 1. When the UE schedules or activates aperiodic or semi-permanent CSI reporting without scheduling the transport block based on PUSCH repeated transmission scheme B, the UE may expect that the first nominal repetition is the same as the first actual repetition. If the first nominal repetition differs from the first actual repetition for the PUSCH transmitted including the semi-permanent CSI based on PUSCH repeated transmission scheme B without scheduling the DCI after the second CLI-RS is activated with DCI, transmission of the first nominal repetition may be disregarded.

### UE Capability Report

In LTE and NR, the UE may perform a procedure for reporting the capability supported by the UE to the corresponding BS while connected to the serving BS. In the description below, this is referred to as a UE capability report.

The BS may transfer a UE capability enquiry message for requesting capability report to the UE in the connected state. The message may include a UE capability request for each radio access technology (RAT) type of the BS. The request for each RAT type may include supported frequency band combination information. In the case of the UE capability enquiry message, the respective UE capabilities of the plurality of RAT types may be requested through one RRC message container, or the BS may include a plurality of UE capability enquiry messages containing the per-RAT type UE capability requests and transfer them to the UE. In other words, a plurality of UE capability enquiries may be repeated in one message, and the UE may configure a UE capability information message corresponding thereto and report it multiple times. In the next-generation mobile communication system, UE capability requests for multi-RAT dual connectivity (MR-DC) as well as NR, LTE, E-UTRA-NR dual connectivity (EN-DC) may be made. Although it is common that the UE capability enquiry message is transmitted at an early time after the UE is connected to the BS, it may also be requested under any condition when required by the BS.

Upon receiving a request for UE capability report from the BS in the above step, the UE configures UE capability according to the RAT type and band information requested from the BS. A method for the UE to configure UE capability in the NR system is described below.

1. If the UE is provided with a list of LTE and/or NR bands at the request for UE capability from the BS, the UE configures a band combination (BC) for EN-DC and NR standalone (SA). In other words, the UE configures a BC candidate list for EN-DC and NR SA based on the bands requested to the BS through FreqBandlist. Band priorities may have priorities in the order listed in FreqBandlist.

2. If the BS sets “eutra-nr-only” flag or “eutra” flag and requests UE capability report, the UE completely removes those for NR SA BCs from the configured BC candidate list. This operation may occur only when the LTE BS (eNB) requests “eutra” capability.

3. Then, the UE removes fallback BCs from the BC candidate list configured in the above step. Here, fallback BC means a BC that may be obtained by removing the band corresponding to at least one SCell from any BCs and, since the BC before removing the band corresponding to at least one SCell is able to cover the fallback BC, it may be omitted. This step applies to MR-DC, i.e., LTE bands also apply. The BCs remaining after this step are the final “candidate BC list.”

4. The UE selects BCs fitting the requested RAT type in the final “candidate BC list” to select BCs to be reported. In this step, the UE configures the supportedBandCombinationlist in a predetermined order. In other words, the UE configures the BCs and UE capabilities to be reported according to the preset rat-Type order. (nr->eutra-nr->eutra). The UE configures a featureSetCombination for the configured supportedBandCombinationList and configures a “candidate feature set combination” list in the candidate BC list where the list of fallback BCs (including the capability of the same or lower step) has been removed. The “candidate feature set combination” may include the whole feature set combination for NR and EUTRA-NR BC and be obtained from the feature set combination of the UE-MRDC-Capabilities container and the UE-NR-Capabilities.

5. Further, if the requested rat type is eutra-nr and has an effect, featureSetCombinations is included in both containers of UE-MRDC-Capabilities and UE-NR-Capabilities. However, the NR feature set includes only the UE-NR-Capabilities.

After the UE capability is configured, the UE transfers a UE capability information message including the UE capability to the BS. The BS performs appropriate scheduling and transmission/reception management on the UE based on the UE capability received from the UE.

### CA/DC

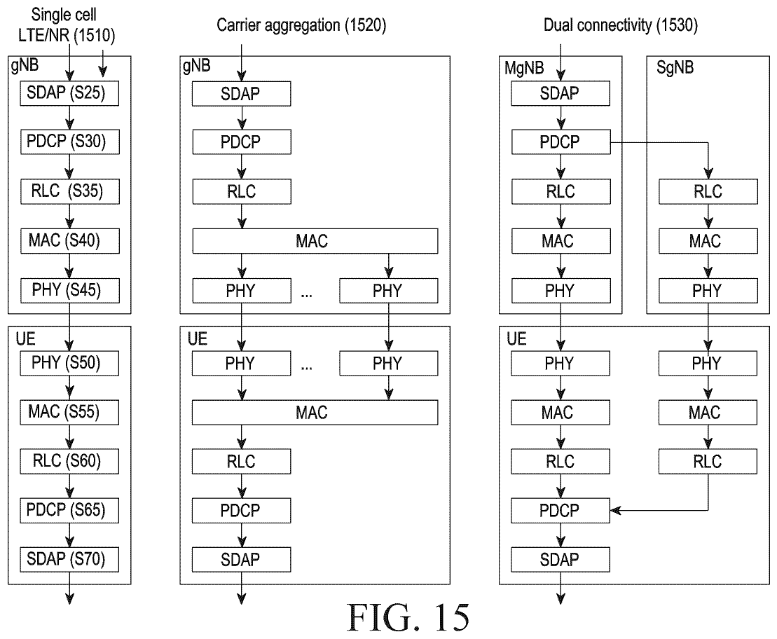

FIG. 15 illustrates radio protocol structures of a BS and a UE in single cell 1510, CA 1520, and dual connectivity 1530 situations according to an embodiment.

Referring to FIG. 15, the radio protocol of the next-generation mobile communication system includes an NR service data adaptation protocol (NR SDAP) S25 or S70, an NR packet data convergence protocol (NR PDCP) S30 or S65, an NR radio link control (NR RLC) S35 or S60, and an NR medium access control (NR MAC) S40 or S55 in each of the UE and the BS.

The main functions of the NR SDAPs S25 and S70 may include some of the following functions.
Transfer of user plane data
Mapping between a QoS flow and a DRB for both DL and UL
Marking QoS flow ID in both DL and UL packets
Reflective QoS flow to DRB mapping for the UL SDAP PDUs

For the SDAP layer device, the UE may be set, via an RRC message, for whether to use the functions of the SDAP layer or the header of the SDAP layer device per PDCP layer device, per bearer, or per logical channel. If an SDAP header has been set, the UE may be instructed to update or reset mapping information for the data bearer and QoS flow of the UL and DL, by a one-bit NAS reflective QoS indicator and a one-bit AS reflective QoS indicator.

The SDAP header may include QoS flow ID information indicating QoS. The QoS information may be used as data priority handling or scheduling information for seamlessly supporting a service.

The main functions of the NR PDCPs S30 and S65 may include some of the following functions.
Robust header compression and decompression
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in the UL

In the foregoing, the reordering by the NR PDCP device refers to the function of reordering PDCP PDUs received from a lower layer in order based on the PDCP sequence number (SN) and may include the function of transferring data to a higher layer in the reordered order. The reordering by the NR PDCP device may include transferring immediately without considering order, recording PDCP PDUs missed by reordering, reporting the state of the missing PDCP PDUs to the transmit part, and requesting to retransmit the missing PDCP PDUs.

The main functions of the NR RLCs S35 and S60 may include some of the following functions.
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

In the foregoing, the in-sequence delivery of the NR RLC device refers to a function of sequentially delivering RLC SDUs received from a lower layer to an upper layer. The in-sequence delivery of the NR RLC device may include a function of reassembling and transferring several RLC SDUs to which one RLC SDU has been divided and received and may include a function of reordering the received RLC PDUs based on an RLC SN or a PDCP SN, a function of reordering and recording the lost RLC PDUs, a function of reporting the status of the lost RLC PDUs to the transmitting side, and a function of requesting retransmission of the lost RLC PDUs. The in-sequence delivery of the NR RLC device may include a function of transferring, in sequence, only the RLC SDUs before a missed RLC SDU, if any, or may include a function of transferring, in sequence, to the higher layer, all RLC SDUs received before a predetermined timer starts, if the timer has expired although there is a missed RLC SDU. The in-sequence delivery of the NR RLC device may include a function of sequentially delivering all RLC SDUs received so far to the upper layer if the predetermined timer expires even when there is a lost RLC SDU. The RLC PDUs may be processed in order of reception (in order of arrival regardless of the SN order) and delivered to the PDCP device regardless of order (out-of-sequence delivery). For segments, segments which are stored in a buffer or are to be received later may be received and reconstructed into a single whole RLC PDU, and then, the whole RLC PDU is processed and transferred to the PDCP device. The NR RLC layer may not include the concatenation function, and the function may be performed by the NR MAC layer or replaced with a multiplexing function of the NR MAC layer.

The out-of-sequence delivery by the NR RLC device refers to immediately transferring the RLC SDUs received from the lower layer to the higher layer regardless of order and, if one original RLC SDU is split into several RLC SDUs that are then received, the out-of-sequence delivery may include reassembling and transferring them and storing the RLC SNs or PDCP SNs of the received RLC PDUs, ordering them, and recording missing RLC PDUs.

The NR MACs S40 and S55 may be connected to several NR RLC layer devices configured in one UE, and the major functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layers S45 and S50 may channel-code and modulate higher layer data into OFDM symbols, transmit the OFDM symbols through a wireless channel or demodulates OFDM symbols received through a wireless channel, channel-decodes and transfers the same to a higher layer.

The detailed structure of the radio protocol structure may be varied depending on the carrier (or cell) operating scheme. As an example, when the BS transmits data to the UE based on a single carrier (or cell), the BS and the UE use the protocol structure having a single structure for each layer like reference number S00. However, when the BS transmits data to the UE based on CA which uses multiple carriers in a single TRP, the BS and the UE use the protocol structure that has a single structure up to the RLC like reference number S10 but performs multiplexing on the PHY layer through the MAC layer. As another example, when the BS transmits data to the UE based on dual connectivity (DC) which uses multiple carriers in multiple TRPs, the BS and the UE use the protocol structure that has a single structure up to the RLC like reference number S20 but performs multiplexing on the PHY layer through the MAC layer.

Referring to the above-described PDCCH and beam configuration-related descriptions, current Rel-15 and Rel-16 have difficulty in achieving the reliability required in scenarios that require high reliability, such as URLLC, because of not supporting PDCCH repeated transmission. The disclosure provides a PDCCH repeated transmission method through multiple TRPs, enhancing the UE's PDCCH reception reliability. Specific methods are described below in detail in the following embodiments.

Hereinafter, embodiments of the disclosure are described in detail with reference to the accompanying drawings. The contents of the disclosure are applicable to FDD and TDD systems. As used herein, the term “higher signaling” (or higher layer signaling) may refer to a method for transmitting signals from the BS to the UE using a DL data channel of the physical layer or from the UE to the BS using a UL data channel of the physical layer and may be interchangeably used with RRC signaling, PDCP signaling, or MAC CE.

In the disclosure, in determining whether cooperative communication applies, the UE may use various methods, such as allowing the PDCCH(s) allocating the PDSCH where cooperative communication applies to have a specific format, or allowing the PDCCH(s) allocating the PDSCH where cooperative communication applies to include a specific indicator for indicating whether cooperative communication applies, allowing the PDCCH(s) allocating toe PDSCH where cooperative communication applies to be scrambled with a specific RNTI, or assuming application of cooperative communication in a specific period indicated by a higher layer. Thereafter, for convenience of description, that the UE receives cooperative communication-applied PDSCH based on similar conditions is referred to as an NC-JT case.

Hereinafter, in the disclosure, ‘determine priority between A and B’ may be referred to in other various manners, e.g., as selecting one with higher priority according to a predetermined priority rule and performing an operation according thereto or omitting or dropping the operation for the one with lower priority.

Hereinafter, in the disclosure, the above-described examples are described in connection with various embodiments. One or more embodiments may be applied simultaneously or in combination, rather than independently.

### NC-JT

According to an embodiment, non-coherent joint transmission (NC-JT) may be used for the UE to receive PDSCH from multiple TRPs.

Unlike conventional, the 5G wireless communication system may support all of a service requiring a high transmission rate, a service having very short transmission latency, and a service requiring a high connection density. In a wireless communication network including a plurality of cells, TRPs, or beams, coordinated transmission between cells, TRPs, and/or beams may increase the strength of the signal received by the UE or efficiently perform interference control between cells, TRPs, and/or beams to thereby meet various service requirements.

Joint transmission (JT) is a representative transmission technology for the coordinated communication and is a technology for increasing the strength or throughput of the signal received by the UE by transmitting signals to one UE through multiple different cells, TRPs, and/or beams. In this case, inter-cell, TRP, and/or beam-UE channels may have significantly different characteristics. In particular, NC-JT supporting inter-cell, TRP, and/or inter-beam non-coherent precoding may require individual precoding, MCS, resource allocation, and TCI indication according to inter-cell, TRP, and/or beam-UE per-link characteristics.

The above-described NC-JT transmission may be applied to at least one channel among a PDSCH, PDCCH, PUSCH, and PUCCH). During PDSCH transmission, transmission information such as precoding, MCS, resource allocation, and TCI is indicated by the DL DCI and, for NC-JT transmission, the transmission information should be indicated independently per cell, TRP, and/or beam. This becomes a major factor to increase the payload necessary for DL DCI transmission, which may negatively affect the reception performance of the PDCCH transmitting the DCI. Accordingly, for supporting the JT of PDSCH, the tradeoff between DCI information quantity and control information reception performance needs to be carefully designed.

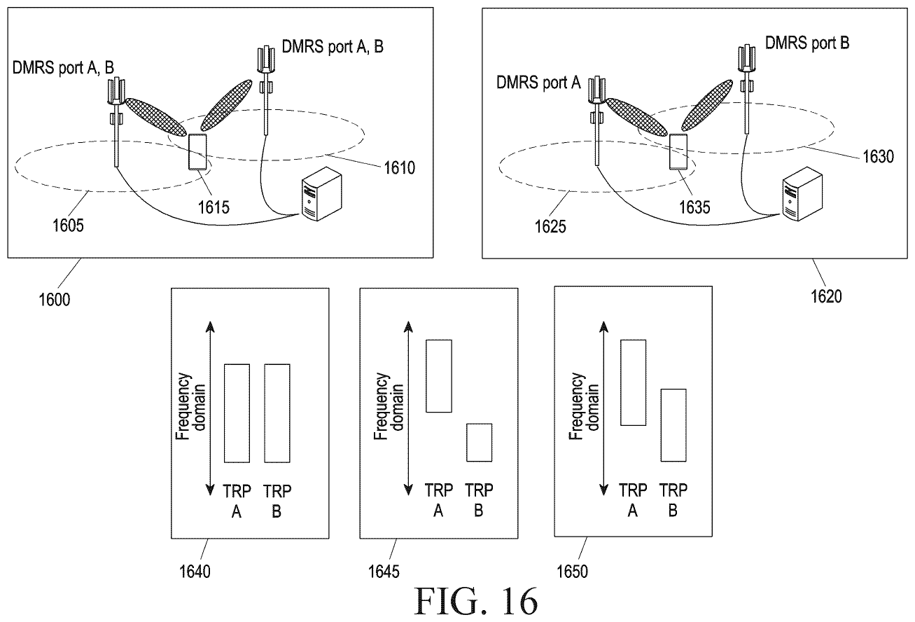

FIG. 16 illustrates an antenna port configuration and a resource allocation example for transmitting a PDSCH using cooperative communication in a wireless communication system according to an embodiment.

Referring to FIG. 16, examples for PDSCH transmission are described for each technique of JT, and examples for allocating radio resources for each TRP are shown.

Referring to FIG. 16, an example 1600 of coherent JT (C-JT) supporting inter-cell, TRP, and/or inter-beam coherent precoding is shown.

In the case of the C-JT, TRP A 1605 and TRP B 1610 transmit single data (e.g., a PDSCH) to the UE 1615, and joint precoding may be performed in multiple TRPs. This may mean that DMRS is transmitted through the same DMRS ports so that TRP A 1605 and TRP B 1610 transmit the same PDSCH. For example, TRP A 1605 and TRP B 1610 may transmit DMRS to the UE through DMRS port A and DMRS B, respectively. In this case, the UE may receive one DCI information for receiving one PDSCH to be demodulated based on the DMRSs transmitted through DMRS port A and DMRS B.

FIG. 16 also illustrates an example 1620 of NC-JT supporting inter-cell, TRP, and/or inter-beam non-coherent precoding for PDSCH transmission.

In the case of NC-JT, a PDSCH is transmitted to the UE 1635 (N035) for each cell, TRP 1625, 1630 or/and beam, and individual-precoding may be applied to each PDSCH. As each cell, TRP, and/or beam transmits a different PDSCH or a different PDSCH layer to the UE, it is possible to enhance the throughput relative to the single cell, TRP, and/or beam transmission. It is also possible to enhance the reliability relative to single cell, TRP, and/or beam transmission as each cell, TRP, and/or beam repeatedly transmits the same PDSCH to the UE. For convenience of description, the cell, TRP, and/or beam are collectively referred to as a TRP.

In this case, various radio resource allocations may be considered, such as when the frequency and time resources used in multiple TRPs for PDSCH transmission are the same (1640), when the frequency and time resources used in multiple TRPs do not overlap (1645), and when some of the frequency and time resources used in multiple TRPs overlap (1650).

For NC-JT support, DCIs in various forms, structures, and relationships may be considered to simultaneously allocate multiple PDSCHs to one UE.

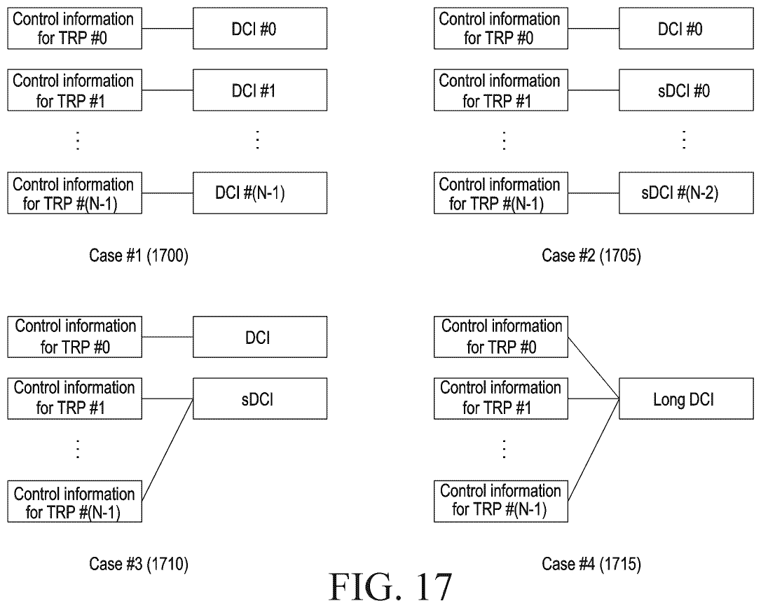

FIG. 17 illustrates an example of a configuration of DCI for NC-JT for each TRP to transmit a different PDSCH or different PDSCH layer to the UE in a wireless communication system according to an embodiment.

Referring to FIG. 17, case #1 1700 is an example in which control information for PDSCHs transmitted in (N−1) additional TRPs is transmitted independently from control information for the PDSCH transmitted in the serving TRP in the situation where (N−1) different PDSCHs are transmitted from (N−1) additional TRPs (TRP #1 to TRP #(N−1)) other than the serving TRP (TRP #0) used for single PDSCH transmission. In other words, the UE may obtain control information for the PDSCHs transmitted from different TRPs (TRP #0 to TRP #(N−1)) through independent DCIs (DCI #0 to DCI #(N−1)). Formats between the independent DCIs may be the same or different, and payloads between the DCIs may also be the same or different. The above-described case #1 may fully guarantee each PDSCH control or allocation degree of freedom, but if each DCI is transmitted in a different TRP, a difference in coverage occurs for each DCI, deteriorating reception performance.

Case #2 1705 is an example in which the DCI for (N−1) additional TRPs is respectively transmitted, and each of the DCIs is dependent upon the control information for the PDSCH transmitted from the serving TRP in the situation where (N−1) different PDSCHs are transmitted from (N−1) additional TRPs (TRP #1 to TRP #(N−1)) other than the serving TRP (TRP #0) used for single PDSCH transmission.

For example, DCI #0 which is the control information for the PDSCH transmitted from the serving TRP (TRP #0) includes all information elements of DCI format 1_0, DCI format 1_1, and DCI format 1_2, but shortened DCIs (hereinafter, sDCIs) (sDCI #0 to sDCI #(N−2)) which is are control information for the PDSCHs transmitted from the cooperative TRPs (TRP #1 to TRP #(N−1)) may include only some of the information elements of DCI format 1_0, DCI format 1_1, and DCI format 1_2. Accordingly, since the sDCI transmitting the control information for the PDSCHs transmitted from the cooperative TRPs has small payload as compared with the normal DCI (nDCI) transmitting PDSCH-related control information transmitted from the serving TRP, it is possible to include reserved bits as compared with the nDCI.

In the above-described case #2 1705, each PDSCH control or allocation degree of freedom may be limited according to the content of the information elements included in the sDCI. However, since the reception performance of sDCI becomes excellent relative to the nDCI, the probability that a difference in coverage per DCI occurs may be reduced.

Case #3 1710 is an example in which one control information for (N−1) additional TRPs is transmitted, and the DCI is dependent upon the control information for the PDSCH transmitted from the serving TRP in the situation where (N−1) different PDSCHs are transmitted from (N−1) additional TRPs (TRP #1 to TRP #(N−1)) other than the serving TRP (TRP #0) used for single PDSCH transmission.

For example, DCI #0 which is the control information for the PDSCH transmitted from the serving TRP (TRP #0) includes all information elements of DCI format 1_0, DCI format 1_1, and DCI format 1_2, and in the case of the control information for the PDSCHs transmitted from the cooperative TRPs (TRP #1 to TRP #(N−1)), only some of the information elements of DCI format 1_0, DCI format 1_1, and DCI format 1_2 may be collected and transmitted into one ‘secondary’ DCI (sDCI). For example, the sDCI may include at least one of HARQ-related information such as the frequency domain resource assignment, time domain resource assignment, and MCS of cooperative TRPs. Further, information that is not included in the sDCI, such as a BWP indicator or carrier indicator, may follow the DCIs (DCI #0, normal DCI, and nDCI) of the serving TRP.

In case #3 1710, each PDSCH control or allocation degree of freedom may be limited according to the content of the information element included in the sDCI, but the reception performance of the sDCI may be adjusted and, as compared with case #1 1700 or case #2 1705, the complexity of DCI blind decoding of the UE may be reduced.

Case #4 1715 is an example in which control information for PDSCHs transmitted in (N−1) additional TRPs is transmitted in the same DCI (long DCI) as the control information for the PDSCH transmitted from the serving TRP in the situation where (N−1) different PDSCHs are transmitted from (N−1) additional TRPs (TRP #1 to TRP #(N−1)) other than the serving TRP (TRP #0) used for single PDSCH transmission. In other words, the UE may obtain control information for the PDSCHs transmitted from different TRPs (TRP #0 to TRP #(N−1)) through a single DCI. In case #4 (N115), the complexity of DCI blind decoding of the UE may not increase, but PDSCH control or allocation degree of freedom may be reduced, like the number of cooperative TRPs being limited according to the long DCI payload limitation.

Herein, sDCI may denote various auxiliary DCIs such as shortened DCI, secondary DCI, or normal DCI (DCI formats 1_0 to 1_1 described above) including PDSCH control information transmitted in the cooperative TRP and, unless specified otherwise, the corresponding description may apply likewise to the auxiliary DCIs.

Case #1 1700, case #2 1705, and case #3 1710 where one or more DCIs (PDCCH) are used for supporting NC-JT may be identified as multiple PDCCH-based NC-JT, and case #4 1715 where a single DCI (e.g., a PDCCH) is used for supporting NC-JT may be identified as single PDCCH-based NC-JT. In multiple PDCCH-based PDSCH transmission, the CORESET where the DCI of the serving TRP (TRP #0) is scheduled and the CORESET where the DCIs of the cooperative TRPs (TRP #1 to TRP #(N−1)) are scheduled may be divided. As a method for dividing CORESETs, there may be a method for dividing through a higher layer indicator for each CORESET and a method for dividing through a beam configuration for each CORESET. The single PDCCH-based NC-JT may schedule a single PDSCH having a plurality of layers instead of scheduling a plurality of PDSCHs by a single DCI, and the plurality of layers may be transmitted from multiple TRPs. In this case, the connection relationship between the layer and the TRP transmitting the layer may be indicated through a TCI indication for the layer.

Herein, “cooperative TRP” may be replaced with various terms such as “cooperative panel” or “cooperative beam” in actual applications.

Herein, “when NC-JT applies” may be interpreted in various manners according to the context, such as “when the UE simultaneously receives one or more PDSCHs in one BWP,” “when the UE receives the PDSCH based simultaneously on two or more TCI indications in one BWP,” or “when the PDSCH received by the UE is associated with one or more DMRS port groups,” but one expression is used for convenience of description.

The radio protocol structure for NC-JT may be variously used herein according to the TRP scenarios. As an example, when there is no or little backhaul delay between cooperative TRPs, a method (e.g., a CA-like method) using a structure based on MAC layer multiplexing is possible like reference number S10 of FIG. 15. However, when the backhaul delay between cooperative TRPs is too large to be disregarded (e.g., when a time of 2 ms or longer is required for exchanging information, such as CSI, scheduling, and HARQ-ACK between cooperative TRPs), a method (e.g., a DC-like method) for securing robust characteristics using an independent structure for each TRP from the RLC layer is possible like reference number S20 of FIG. 15.

The UE supporting C-JT/NC-JT may receive, e.g., C-JT/NC-JT-related parameters or set values in the higher layer configuration and, based thereupon, set the UE's RRC parameters. For the higher layer configuration, the UE may utilize the UE capability parameter, e.g., tci-StatePDSCH. Here, the UE capability parameter, e.g., tci-StatePDSCH may define TCI states for the purpose of PDSCH transmission, and the number of TCI states may be set to 4, 8, 16, 32, 64, or 128 in FR1 and 64 or 128 in FR2, and up to eight states that may be indicated with the 3 bits of the TCI field of the DCI may be set via a MAC CE message among the set numbers.

The maximum value, 128, indicates the value indicated by the maxNumberConfiguredTCIstatesPerCC in the tci-StatePDSCH parameter included in the UE's capability signaling. As such, the series of configuration processes from the higher layer configuration to the MAC CE configuration may be applied to a beamforming indication or beamforming change instruction for at least one PDSCH in one TRP.

### Multi-DCI-Based Multi-TRP

According to an embodiment, a DL control channel for NC-JT transmission may be configured based on multi-PDCCH.

The NC-JT based on multiple PDCCHs may have CORESETs or search spaces divided per TRP when transmitting DCI for the PDSCH schedule of each TRP. The CORESET or search space for each TRP may be configured like at least one of the following cases.

Higher layer index configuration per CORESET: The CORESET configuration information configured through a higher layer may include an index value, and TRPs transmitting PDCCH in the corresponding CORESET may be divided with the configured per-CORESET index values. In other words, in a set of CORESETs having the same higher layer index value, it may be considered that the same transmits the PDCCH or that the PDCCH scheduling the PDSCH of the same TRP is transmitted. The above-described index for each CORESET may be referred to as CORESETPoolIndex, and it may be considered that the PDCCH is transmitted from the same TRP for CORESETs in which the same CORESETPoolIndex value is set. The CORESET in which no CORESETPoolIndex value is set may be regarded as having the default CORESETPoolIndex value set, and the above-described default value may be 0.

Multi-PDCCH-Config configuration: A plurality of PDCCH-Config's may be configured in one BWP, and each PDCCH-Config may include a PDCCH configuration for each TRP. In other words, a list of per-TRP CORESETs and/or a list of per-TRP search spaces may be configured in one PDCCH-Config, and one or more CORESETs and one or more search spaces included in one PDCCH-Config may be regarded as corresponding to a specific TRP.

CORESET beam/beam group configuration: The TRP corresponding to the corresponding CORESET may be identified through the beam or beam group configured per CORESET. For example, when the same TCJ state is configured in multiple CORESETs, the corresponding CORESETs may be regarded as being transmitted through the same TRP or it may be considered that the PDCCH scheduling the PDSCH of the same TRP in the corresponding CORESET is transmitted.

Search space beam/beam group configuration: A beam or beam group may be configured per search space, and the TRP for each search space may be identified thereby. For example, when the same beam/beam group or TC state is configured in multiple search spaces, in the corresponding search space, it may be considered that the same TRP transmits the PDCCH, or in the corresponding search space, it may be considered that the PDCCH scheduling the PDSCH of the same TRP is transmitted.

As described above, by identifying the CORESET or search space for each TRP, it is possible to classify the PDSCH and HARQ-ACK information for each TRP and thereby generate an HARQ-ACK codebook independently for each TRP and independently use the PUCCH resources.

The above-described configurations may be independent for each cell or for each BWP. For example, in the PCell, two different CORESETPoolIndex values are set whereas in a specific SCell, no CORESETPoolIndex may be set. In this case, it may be considered that while NC-JT transmission is configured in the PCell, no NC-JT transmission is configured in the SCell where no CORESETPoolIndex is configured.

### Single-DCI-Based Multi-TRP

According to another embodiment of the disclosure, a DL beam for NC-JT transmission may be configured based on single-PDCCH.

The single PDCCH-based NC-JT may schedule the PDSCHs transmitted by multiple TRPs with one DCI. In this case, as a method for indicating the number of TRPs transmitting the PDSCH, the number of TCI states may be used. In other words, if the number of TCI states indicated by the DCI scheduling the PDSCH is 2, it may be regarded as single PDCCH-based NC-JT transmission and, if 1, it may be regarded as single-TRP transmission. The TCI state indicated by the DCI may correspond to one or two TCI states among the TCI states activated by the MAC-CE. When the TCI states of the DCI correspond to two TCI states activated by the MAC-CE, a correlation may be established between the TCI codepoint indicated in the DCI and the TCI states activated by the MAC-CE, and it may be when the number of TCI states activated by the MAC-CE, corresponding to the TCI codepoint, is two.

The above-described configurations may be independent for each cell or for each BWP. For example, while the maximum number of activated TCI states corresponding to one TCI codepoint is two in the PCell, the maximum number of activated TCI states corresponding to one TCI codepoint may be one in a specific SCell. In this case, it may be considered that while NC-JT transmission is configured in the PCell, no NC-JT transmission is configured in the SCell.

### PHR

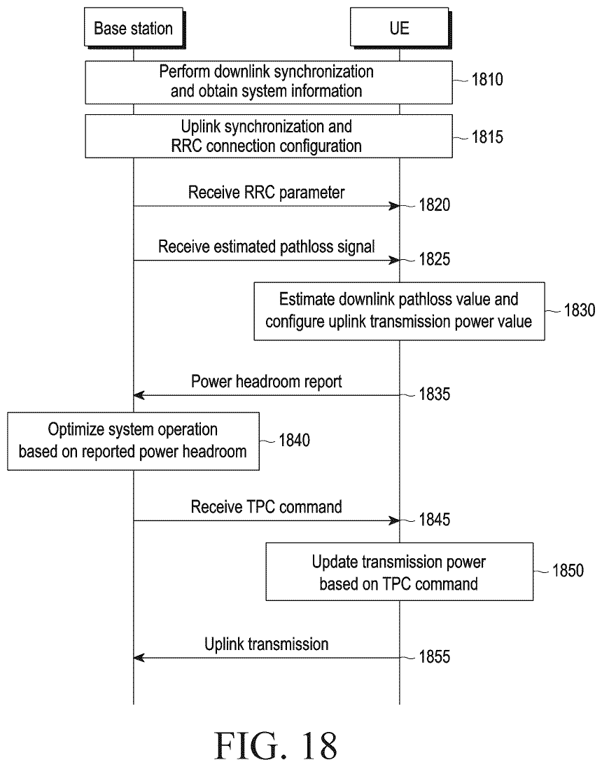

FIG. 18 illustrates a procedure of controlling UE transmission power by a BS in a cellular system.

Referring to FIG. 18, in step 1810, the UE in the coverage of the BS may perform DL synchronization with the BS and obtain SI. According to some embodiments, DL synchronization may be performed through a primary SS/secondary SS (PSS/SSS) received from the BS. The UEs performing the DL synchronization may receive an MIB and an SIB from the BS and obtain SI. In step 1815, the UE may perform UL synchronization with the BS through an RA procedure and establish an RRC connection. In the RA procedure, the UE may transmit an RA preamble and a message 3 (msg3) to the BS through the UL. In this case, UL TPC may be performed during transmission of the RA preamble and transmission of the message 3. Specifically, the UE may receive the parameters for UL TPC from the BS through the obtained SI, e.g., the SIB, or may perform UL TPC using the agreed parameters. In another embodiment of the disclosure, the UE may measure the RSRP from the estimated pathloss signal transmitted by the BS and estimate the DL pathloss value as shown below in Equation (7). Based on the estimated pathloss value, an UL transmission power value for transmission of message 3 and RA preamble may be set based on the estimated pathloss value.

DL pathloss=transmission power of BS signal−RSRP measured by UE (7)

In Equation (7), the transmission power of the BS signal indicates the transmission power of the DL estimated pathloss signal transmitted by the BS. The DL estimated pathloss signal transmitted by the BS may be a cell-specific reference signal (CRS) or an SS block (SSB). When the estimated pathloss signal is a cell-specific reference signal (CRS), the transmission power of the BS signal indicates the transmission power of the CRS, and may be transmitted to the UE through the reference SignalPower parameter of the SI. When the estimated pathloss signal is an SSB, the transmission power of the BS signal indicates the transmission power of the SSS and the DMRS transmitted to the PBCH, and may be transmitted to the UE through the ss-PBCH-BlockPower parameter of SI. In step 1820, the UE may receive RRC parameters for UL TPC through UE-specific RRC or common RRC from the BS. In this case, the received TPC parameters may be different from each other according to the type of the UL channel and the type of the signal to be transmitted through the UL. In other words, TPC parameters applied to the transmission of the PUCCH, PUSCH, and the sounding reference signal (SRS) may be different from each other. As described above, TPC parameters received by the UE through the SIB from the BS before the RRC connection establishment or TPC parameters used by the UE as previously agreed values before the RRC connection establishment may be included in the RRC parameters transmitted from the BS after the RRC connection establishment. The UE may use the RRC parameter value received from the BS after the RRC connection is established for UL TPC. In step 1825, the UE may receive an estimated pathloss signal from the BS. More specifically, the BS may configure a CSI-RS as the estimated pathloss signal of the UE after the UE's RRC connection is established. In this case, the BS may transmit information about the transmission power of the CSI-RS to the UE through the powerControlOffsetSS parameter of the UE dedicated RRC information. In this case, the powerControlOffsetSS may mean a transmission power difference (offset) between the SSB and the CSI-RS. In step 1830, the UE may estimate a DL pathloss value and set a UL transmission power value. More specifically, the UE may measure DL RSRP using CSI-RS and estimate the DL pathloss value through Equation (1) above using information about the transmission power of CSI-RS received from the BS. Based on the estimated pathloss value, UL transmission power values for PUCCH, PUSCH, and SRS transmission may be set. In step 1835, the UE may perform power headroom reporting (PHR) to the BS. The power headroom may refer to a difference between the current transmission power of the UE and the maximum output power of the UE. In step 1840, the BS may optimize the system operation based on the reported power headroom. For example, if the power headroom value reported to the BS by a specific UE is positive, the BS may increase the system throughput by allocating more resources (RB) to the corresponding UE. In step 1845, the UE may receive a TPC command from the BS. For example, if the power headroom value reported to the BS by the specific UE is negative, the BS may reduce the transmission power of the corresponding UE by allocating fewer resources to the UE or through a TPC command. Accordingly, it is possible to increase the system throughput or reduce unnecessary power consumption of the UE. In step 1850, the UE may update the transmission power based on the TPC command. In this case, the TPC command may be transmitted to the UE through UE-specific DCI or group common DCI. Accordingly, the BS may dynamically control the transmission power of the UE through the TPC command. In step 1855, the UE may perform UL transmission based on the updated transmission power.

### PUSCH Power Control

The PUSCH transmission power may be determined in Equation (8) below.

$${P}_{P U S C H} ( i , j , {q}_{d} , l ) = min \{ \begin{matrix}{P}_{CMAX , f , c} ( i ) , \\ {P}_{{0}_{PUSCH} , b , f , c} ( j ) + 10 {log}_{10} ( {2}^{π} \cdot {M}_{RB , b , f , c}^{PUSCH} ( i ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix} \} [ dbM ] \qquad ( 8 )$$

In Equation (8), P_{CMAX,f,c}(i) is the maximum transmission power set for the UE on carrier f of serving cell c at PUSCH transmission time i. P₀_{_{PUSCH}}_{,b,f,c}(j) is a reference transmission power setting value according to the activated UL BWP b of carrier f of serving cell c, and has different values depending on various transmission types j. It may have various values depending on whether the PUSCH transmission is message 3 PUSCH for random access, or whether the PUSCH is a configured grant PUSCH or a scheduled PUSCH.

$${M}_{RB , b , f , c}^{PUSCH} ( i )$$

indicates the frequency size where PUSCH is allocated. α_{b,f,c}(j) indicates the compensation ratio value for pathloss of UL BWP b of carrier f of serving cell c, and may be set by a higher signal or may have a different value according to j. PL_{b,f,c}(q_{d}) is an estimated DL pathloss value of UL BWP b of carrier f of serving cell c, which uses the value measured through the reference signal in the activated DL bandwidth section. The reference signal may be an SS/PBCH block or CSI-RS. The DL pathloss may be calculated as described above in Equation (7). In another embodiment of the disclosure, PL_{b,f,c}(q_{d}) is a DL pathloss value, which is the pathloss calculated by the UE as in Equation (7). The UE calculates pathloss based on the reference signal resource associated with the SS/PBCH block or CSI-RS, depending on whether a higher signal is set. The reference signal resource may select one of several reference signal resource sets by the higher signal or L1 signal. The UE calculates the pathloss based on the reference signal resource. Δ_{TF,b,f,c}(i) is a value determined by the modulation and coding scheme (MCS) value of the PUSCH at the PUSCH transmission time i of the UL BWP b of the carrier f of the serving cell c. f_{b,f,c}(i, l) is a power control adaptation value that may dynamically adjust the power value by TPC command.

The TPC command is divided into an accumulated mode and an absolute mode, and one of the two modes is determined by the higher signal. The accumulated mode is a form in which the currently determined power control adaptation value is accumulated to the value indicated by the TPC command, and may be increased or decreased according to the TPC command and has the relationship of f_{b,f,c}(i, l)=f_{b,f,c} (i−i₀, l)+τδ_{PUSCH,b,f,c}·δ_{PUSCH,b,f,c} is the value indicated in the TPC command. The value of the absolute mode is determined by the TPC command regardless of the currently determined power regulation adaptation value and has the relationship of f_{b,f,c}(i, l)=δ_{PUSCH,b,f,c}. Table 43 below illustrates the values that may be indicated in the TPC command.

TABLE 43

| TPC | Accumulated | Absolute |
|---|---|---|
| Command | δ_{PUSCH, b, f, c} or | δ_{PUSCH, b, f, c} or |
| Field | δ_{SRS, b, f, c} [dB] | δ_{SRS, b, f, c} [dB] |
| 0 | −1 | −4 |
| 1 | 0 | −1 |
| 2 | 1 | 1 |
| 3 | 3 | 4 |

### PUCCH Power Control

Equation (9) below is used to determine the PUCCH transmission power.

$${P}_{PUCCH , b , f , c} ( i , {q}_{u} , {q}_{d} , l ) = min \{ \begin{matrix}{P}_{CMAX , f , c} ( i ) , \\ {P}_{{0}_{PUCCH} , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + \\ {Δ}_{{F}_{PUCCH}} ( i ) + {Δ}_{TF , b , f , c} ( i ) + {f}_{b , f , c} ( i , l )\end{matrix} \} \qquad ( 9 )$$

In Equation (9), P₀_{_{PUCCH}}_{,b,f,c}(qᵤ) is a reference setting transmission power setting value, and has a different value according to various transmission types qᵤ, and the value may be changed by a higher signal such as RRC or MAC CE. When the value is changed by MAC CE, if the slot in which HARQ-ACK is transmitted for the PDSCH that received MAC CE is k, the UE determines that the corresponding value is applied from the k+k_{offset} slot. k_{offset} has different values depending on the subcarrier spacing, and may be, e.g., 3 ms.

$${M}_{RB , b , f , c}^{PUCCH} ( i )$$

is the size of the frequency resource area where PUCCH is allocated. PL_{b,f,c}(q_{d}) is an estimated pathloss value of the UE, and as described above in Equation (7), the UE calculates it based on a specific reference signal among various CSI-RSs or SS/PBCHs depending on whether a higher signal is set and the type thereof. For repeated transmission PUCCHs, the same q_{d} applies. For repeated transmission PUCCHs, the same qᵤ applies.

### HARQ-ACK: Type 1 (Semi-Static) Codebook

In a context where the number of HARQ-ACK PUCCHs transmittable by the UE in one slot is limited to one, if the UE receives the semi-static HARQ-ACK codebook higher configuration, the UE may report HARQ-ACK information for the SPS PDSCH release or receive the PDSCH in the HARQ-ACK codebook in the slot indicated by the value of the PDSCH-to-HARQ_feedback timing indicator in DCI format 0_1 or DCI format 1_1. The UE reports the HARQ-ACK information bit value, as an NACK, in the HARQ-ACK codebook in the slot not indicated by the PDSCH-to-HARQ_feedback timing indicator field in DCI format 1_0 or DCI format 1_1. If the UE reports only HARQ-ACK information for reception of one PDSCH or one SPS PDSCH release in the MA,C cases for reception of candidate PDSCHs, and the reporting is scheduled by DCI format 1_0 including the information in which the counter DACI field is indicated as 1 in the Pcell, the UE determines one HARQ-ACK codebook for the corresponding PDSCH reception or the corresponding SPS PDSCH release.

Otherwise, the following HARQ-ACK codebook determination method according to the above-described method is followed.

If the set of PDSCH reception candidates is MA,c in serving cell c, MA,c may be obtained by pseudo-code 1 steps as follows.
pseudo-code 1 starts

Step 1: Initialize j to 0 and MA,c to an empty set. Initialize k, the HARQ-ACK transmission timing index, to 0.

Step 2: Set R as a set of rows in the table including PDSCH-mapped slot information, start symbol information, symbol count, or length information. If the PDSCH-possible mapping symbol indicated by each value of R is set as a UL symbol according to the above DL and UL configuration, delete the corresponding row from R.

Step 3-1: Add one to set MA,c if the UE is able to receive one PDSCH for unicast in one slot and R is not an empty set.

Step 3-2: If the UE is able to receive more than one PDSCH for unicast in one slot, count PDSCHs allocable to different symbols in the calculated R and add them to MA,c.

Step 4: Increase k by one and restart from step 2.
pseudo-code 1 ends

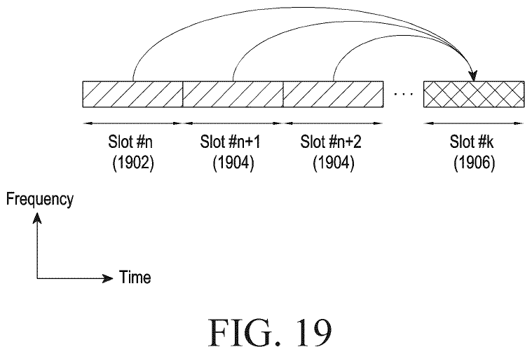

In the example of FIG. 19 for the above-described pseudo-code 1. To perform HARQ-ACK PUCCH transmission in slot #k 1908, all slot candidates capable of PDSCH-to-HARQ-ACK timing that may indicate slot #k 1908 are considered. In FIG. 19, it is assumed that HARQ-ACK transmission is possible in slot #k 1908 by a PDSCH-to-HARQ-ACK timing combination for which only PDSCHs scheduled in slot #n 1902, slot #n+1 1904, and slot #n+2 1906 are possible. The maximum number of PDSCHs schedulable per slot is derived considering the time domain resource configuration information about the PDSCH schedulable in each of slots 1902, 1904, and 1906 and information indicating whether the symbol in the slot is DL or UL. For example, assuming that maximum scheduling is possible for 2 PDSCHs in slot 1902, 3 PDSCHs in slot 1904, and 2 PDSCHs in slot 1906, the maximum number of PDSCHs included in the HARQ-ACK codebook transmitted in slot 1908 is 7 in total. This is referred to as the cardinality of the HARQ-ACK codebook.

In a specific slot, step 3-2 is described in Table 44 below (default PDSCH time domain resource allocation A for normal CP).

TABLE 44

| Row | dmrs-TypeA- | PDSCH | | | | | |
|---|---|---|---|---|---|---|---|
| index | Position | mapping type | K₀ | S | L | Ending | Order |
| 1 | 2 | Type A | 0 | 2 | 12 | 13 | 1x |
| | 3 | Type A | 0 | 3 | 11 | 13 | 1x |
| 2 | 2 | Type A | 0 | 2 | 10 | 11 | 1x |
| | 3 | Type A | 0 | 3 | 9 | 11 | 1x |
| 3 | 2 | Type A | 0 | 2 | 9 | 10 | 1x |
| | 3 | Type A | 0 | 3 | 8 | 10 | 1x |
| 4 | 2 | Type A | 0 | 2 | 7 | 8 | 1x |
| | 3 | Type A | 0 | 3 | 6 | 8 | 1x |
| 5 | 2 | Type A | 0 | 2 | 5 | 6 | 1x |
| | 3 | Type A | 0 | 3 | 4 | 6 | 1x |
| 6 | 2 | Type B | 0 | 9 | 4 | 12 | 2x |
| | 3 | Type B | 0 | 10 | 4 | 13 | 3 |
| 7 | 2 | Type B | 0 | 4 | 4 | 7 | 1x |
| | 3 | Type B | 0 | 6 | 4 | 9 | 2 |
| 8 | 2, 3 | Type B | 0 | 5 | 7 | 11 | 1x |
| 9 | 2, 3 | Type B | 0 | 5 | 2 | 6 | 1x |
| 10 | 2, 3 | Type B | 0 | 9 | 2 | 10 | 2x |
| 11 | 2, 3 | Type B | 0 | 12 | 2 | 13 | 3x |
| 12 | 2, 3 | Type A | 0 | 1 | 13 | 13 | 1x |
| 13 | 2, 3 | Type A | 0 | 1 | 6 | 6 | 1x |
| 14 | 2, 3 | Type A | 0 | 2 | 4 | 5 | 1 |
| 15 | 2, 3 | Type B | 0 | 4 | 7 | 10 | 1x |
| 16 | 2, 3 | Type B | 0 | 8 | 4 | 11 | 2x |

Table 44 is a time resource allocation table in which the UE operates by default before receiving time resource allocation through a separate RRC signal. For reference, in addition to separately indicating the row index value through RRC, the PDSCH time resource allocation value is determined by dmrs-TypeA-Position which is the UE common RRC signal. In Table 44 above, the ending column and order column are values added separately for convenience of description and, in practice, may not exist. The meaning of the ending column indicates the ending symbol of the scheduled PDSCH, and the order column indicates the code position value positioned in a specific codebook in a semi-static HARQ-ACK codebook. Table 44 is applied to the time resource allocation applied in DCI format 1_0 of the common search space of PDCCH.

The UE performs the following step to determine the HARQ-ACK codebook by calculating the maximum number of PDSCHs not overlapping in a specific slot.

Step 1: Among all of the rows of the PDSCH time resource allocation table, the PDSCH allocation value that ends first within the slot is searched. In Table 44, it may be identified that the row index 14 ends first. This is indicated as 1 in the order column. Other row indices that overlap the row index 14 by at least one symbol are indicated as 1× in the order column.

Step 2: Among the remaining row indices that are not indicated in the order column, the PDSCH allocation value that ends first is searched. In Table 44, the row with row index 7 and dmrs-typeA-Position value 3 corresponds thereto. Other row indices that overlap the corresponding row index by at least one symbol are indicated as 2× in the order column.

Step 3: The order value is increased and displayed while repeating step 2. For example, among the row indices that are not indicated in the order column in Table 44, the PDSCH allocation value that ends first is searched. The row with row index 6 and dmrs-typeA-Position value 3 corresponds thereto. Other row indices that overlap the corresponding row index by at least one symbol are indicated as 3× in the order column.

Step 4: When orders are displayed for all of the row indices, the step ends. The size of the corresponding order is the maximum number of the PDSCH that is schedulable without time overlap in the corresponding slot. Scheduling without time overlap means that different PDSCHs are scheduled in TDM.

In the order column of Table 44, the maximum value of order indicates the HARQ-ACK codebook size of the corresponding slot, and the order value indicates the HARQ-ACK codebook point where the HARQ-ACK feedback bit for the corresponding scheduled PDSCH is positioned. For example, row index 16 in Table 44 means that it exists at the second code position in a semi-static HARQ-ACK codebook of size 3. If the set of PDSCH reception candidates (occasion for candidates PDSCH receptions) in the serving cell c is M_{A,c} the U transmitting HARQ-ACK feedback may obtain M_{A,c} by the [pseudo-code 1] or [pseudo-code 2] step. M_{A,c} may be used to determine the number of HARQ-ACK bits that the U should transmit. Specifically, the HARQ-ACK codebook may be configured using the size (cardinality) of the M_{A,c} set.

As another example, the considerations for determining the semi-static HARQ-ACK codebook (or type 1 HARQ-ACK codebook) may be as shown below in Table 45.

TABLE 45
a) on a set of slot timing values K₁ associated with the active UL BWP
a) If the UE is configured to monitor PDCCH for DCI format 1_0 and is not configured to monitor PDCCH
for DCI format 1_1 on serving cell c, K₁ is provided by the slot timing values {1, 2, 3, 4, 5, 6, 7, 8} for DCI format
1_0
b) If the UE is configured to monitor PDCCH for DCI format 1_1 for serving cell c, K₁ is provided by
dl-DataToUL-ACK for DCI format 1_1
b) on a set of row indexes R of a table that is provided either by a first set of row indexes of a table that
is provided by PDSCH-TimeDomainResourceAllocationList in PDSCH-ConfigCommon or by Default PDSCH time
domain resource allocation A [6, TS 38.214], or by the union of the first set of row indexes and a second set of row
indexes, if provided by PDSCH-TimeDomainResourceAllocationList in PDSCH-Config, associated with the active DL
BWP and defining respective sets of slot offsets K₀, start and length indicators SLIV, and PDSCH mapping types for
PDSCH reception as described in [6, TS 38.214]
c) on the ratio 2^{μ}^{_{DL}}^{-μ}^{_{UL}} between the downlink SCS configuration μ_{DL} and the uplink SCS configuration
μ_{UL} provided by subcarrierSpacing in BWP-Downlink and BWP-Uplink for the active DL BWP and the active UL BWP,
respectively
d) if provided, on TDD-UL-DL-ConfigurationCommon and TDD-UL-DL-ConfigDedicated as described in
Subclause 11.1.

As another example, the pseudo-code for HARQ-ACK codebook determination may be as shown below in Table 46.

```
TABLE 46
  [pseudo-code 2 start]
  For the set of slot timing values K₁, the UE determines a set of M_{A,c} occasions for candidate PDSCH
receptions or SPS PDSCH releases according to the following pseudo-code, A location in the Type-1 HARQ-ACK
codebook for HARQ-ACK information corresponding to a SPS PDSCH release is same as for a corresponding SPS
PDSCH reception.
  Set j = O [symbol]   index of occasion for candidate PDSCH reception or SPS PDSCH release
  Set B = Ø
  Set M_{A,c} = Ø
  Set c(K₁) to the cardinality of set K₁
  Set k = 0 - index of slot timing values K_{1,k}, in descending order of the slot timing values, in set K₁ for
serving cell [symbol]
  while k < c(K₁)
            if mod(n_{O}-K_{1,k} + 1, max(2 [symbol]  , 1)) = 0
      Set n_{D} = O [symbol]   index of a DL slot within an UL slot
      while n_{D} , max(2 [symbol]  , 1)
        Set R to the set of rows
        Set c(R) to the cardinality of R
        Set r = 0 - index of row in set R
        if slot n_{U} starts at a same time as or after a slot for an active DL BWP change on serving
cell c or an active UL BWP change on the PCell and slot └(n_{U} − K_{1,k}) * 2 [symbol]  ┘ + n_{D} is before the slot for the
active DL BWP change on serving cell c or the active UL BWP change on the PCell
                continue;
            else
                while r < c(R)
                    if the UE is provided TDD-UL-DL-ConfigurationCommon or
$\begin{matrix}TDD - UL - DL - ConfigDedicated and , for at each slot from slot ⌊ ( {n}_{U} - {K}_{1 , k} ) * {2}^{{μ}_{DL} - {μ}_{UL}} ⌋ + {n}_{D} - {N}_{PDSCH}^{repeat} + 1 to slot \\ ⌊ ( {n}_{U} - {K}_{1 , k} ) * {2}^{{μ}_{DL} - {μ}_{UL}} ⌋ + {n}_{D} , at least one symbol of the PDSCH time resource derived by row r is configured as\end{matrix}$
UL where K_{1,k} is the k-th slot timing value in set K₁,
                R = R/r;
              end if
              r = r + 1;
            end while
            if the UE does not indicate a capability to receive more than one unicast PDSCH per
slot and R ≠ Ø,
              M_{A,c} = M_{A,c} ∪_{f};
              j = j + 1;
              The UE does not expect to receive SPS PDSCH release and unicast PDSCH in
a same slot;
            else
              Set c(R) to the cardinality of R
              Set m to the smallest last OFDM symbol index, as determined by the SLIV,
among all rows of R
              while R ≠ Ø
                Set r = 0
              while r < c(R)
            if S ≤ m for start OFDM symbol index S for row r
              b_{r,k,n}_{ₖ} = j; - index of occasion for candidate PDSCH
reception or SPS PDSCH release associated with row r
              R = R/r;
              B = B ∪b_{r,k,n}_{ₙ};
              end if
            r = r + 1;
            end while
            M_{A,c} = M_{A,c} ∪_{f}
            j = j + 1;
            Set m to the smallest last OFDM symbol index among all rows of R;
            end while
          end if
        end if
        n_{D} = n_{D} + 1;
      end while
    end if
    k = k + 1:
  end while
  [pseudo code 2 End] [symbol]
indicates data missing or illegible when filed
```

The position of the HARQ-ACK codebook containing HARQ-ACK information for the DCI indicating DL SPS release in the above pseudo-code 2 is based on the position where the DL SPS PDSCH is received. For example, when the start symbol where the DL SPS PDSCH is transmitted starts from the fourth OFDM symbol with respect to the slot, and its length is five symbols, the HARQ-ACK information including the DL SPS release indicating the release of the corresponding SPS assumes that the PDSCH which starts from the fourth OFDM symbol of the slot where the DL SPS release is transmitted and has a length of five symbols is mapped, and determines HARQ-ACK information corresponding thereto through the PDSCH-to-HARQ-ACK timing indicator and PUSCH resource indicator included in the control information indicating the DL SPS release. As another example, when the start symbol where the DL SPS PDSCH is transmitted starts from the fourth OFDM symbol with respect to the slot, and its length is five symbols, the HARQ-ACK information including the DL SPS release indicating the release of the corresponding SPS assumes that the PDSCH which starts from the fourth OFDM symbol of the slot indicated by the time domain resource allocation (TDRA) of the DCI which is the DL SPS release and has a length of five symbols is mapped, and determines HARQ-ACK information corresponding thereto through the PDSCH-to-HARQ-ACK timing indicator and PUSCH resource indicator included in the control information indicating the DL SPS release.

### HARQ-ACK: Type 2 (Dynamic) Codebook

The UE transmits HARQ-ACK information, transmitted in one PUCCH in slot n, based on K0 which is transmission slot position information about the PDSCH scheduled in DCI format 1_0 or 1_1 and the PDSCH-to-HARQ_feedback timing value for PUCCH transmission of HARQ-ACK information in slot n for SPS PDSCH release or PDSCH reception. Specifically, for the above-described HARQ-ACK information transmission, the UE determines the HARQ-ACK codebook of the PUCCH transmitted in the slot determined by K0 and PDSCH-to-HARQ_feedback timing based on the DAI included in the DCI indicating SPS PDSCH release or PDSCH.

The DAI is composed of a counter DAI and a total DAI. The counter DAI is information indicating the position, in the HARQ-ACK codebook, the HARQ-ACK information corresponding to the PDSCH scheduled in DCI format 1_0 or DCI format 1_1. Specifically, the value of counter DAI in DCI format 1_0 or 1_1 indicates the accumulated value of SPS PDSCH release or PDSCH reception scheduled by DCI format 1_0 or DCI format 1_1 in a specific cell c. The above-described accumulated value is set based on the serving cell and the PDCCH monitoring occasion where the scheduled DCI is present.

The total DAI is a value indicating the size of the HARQ-ACK codebook. Specifically, the total DAI value indicates the total number of PDSCH or SPS PDSCH releases scheduled before, including the time when the DCI is scheduled. The total DAI is a parameter used when the HARQ-ACK information in serving cell c in the CA context also includes HARQ-ACK information for the PDSCH scheduled in another cell including the serving cell c. In other words, in a system that operates as one cell, the total DAI parameter is not present.

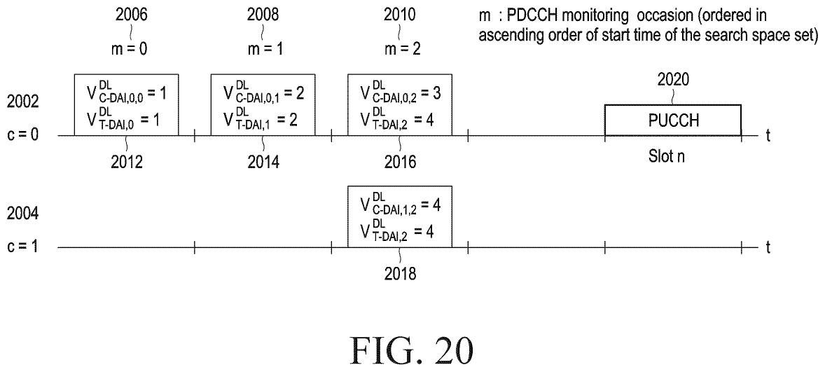

An operation example for the DAI is shown in FIG. 20. FIG. 20 illustrates changes in the values of the counter DAI (C-DAI) and total DAI (T-DAI) indicated by the DCI discovered per PDCCH monitoring occasion set for each carrier when transmitting, on the PUCCH 2020, the HARQ-ACK codebook selected based on the DAI in the nth slot of carrier 9 2002 when the UE is configured with two carriers c. First, in the DCI discovered at m=0 (2006), C-DAI and T-DAI each indicate a value of 1 (2012). In the DCI discovered at m=1 (2008), C-DAI and T-DAI each indicate a value of 2 (2014). In the DCI discovered for carrier 0 (c=0, 2002) of m=2 (2010), C-DAI indicates a value of 3 (2016). In the DCI discovered for carrier 1 (c=1, 2004) of m=2 (2010), C-DAI indicates a value of 4 (2018). In this case, if carriers 0 and 1 are scheduled on the same monitoring occasion, all T-DAIs are indicated as 4.

In FIGS. 19 and 20, HARQ-ACK codebook determination operates in the context that only one PUCCH containing HARQ-ACK information is transmitted in one slot. This is referred to as mode 1. As an example method in which one PUCCH transmission resource is determined in one slot, when PDSCHs scheduled in different DCIs are multiplexed into one HARQ-ACK codebook and transmitted in the same slot, the PUCCH resource selected for HARQ-ACK transmission is determined as the PUCCH resource indicated by the PUCCH resource field indicated in the DCI that has last scheduled the PDSCH. In other words, the PUCCH resource indicated by the PUCCH resource field indicated in the DCI scheduled before the above-described DCI is disregarded.

In the following description, HARQ-ACK codebook determination method and devices are defined in the context where two or more PUCCHs containing HARQ-ACK information may be transmitted in one slot. This is referred to as mode 2. The UE may operate only mode 1 (transmission of only one HARQ-ACK PUCCH within one slot) or only mode 2 (transmission of one or more HARQ-ACK PUCCHs within one slot). Alternatively, the UE that supports both mode 1 and mode 2 may configure the BS to operate in only one mode by higher layer signaling, or mode 1 and mode 2 may be implicitly determined by DCI format, RNTI, DCI specific field value, scrambling, etc. For example, PDSCH and associated HARQ-ACK information scheduled in DCI format A are based on mode 1, and PDSCH and associated HARQ-ACK information scheduled in DCI format B are based on mode 2. Whether the above-described HARQ-ACK codebook is semi-static or dynamic is determined by the RRC signal.

### Paging

UE paging allows the network to reach the UE in the RRC_IDLE and RRC_INACTIVE states through a paging message, and to notify the UE in the RRC_IDLE, RRC_INACTIVE and RRC_CONNECTED states of SI change, earthquake and tsunami warning system (ETWS)/commercial mobile alert service (CMAS) indications. Both paging and short messages are addressed by paging (P)-RNTI in the PDCCH, but the former is transmitted through the paging control channel (PCCH) while the latter is transmitted directly through the PDCCH.

The UE monitors the paging channel for core network (CN)-initiated paging in RRC_IDLE but, in RRC_INACTIVE, also monitors the paging channel for RAN-initiated paging. However, the UE does not need to continuously monitor the paging channel. Paging discrete reception (DRX) is defined when the UE of RRC_IDLE or RRC_INACTIVE only needs to monitor the paging channel during one paging occurrence (PO) per DRX cycle. The paging DRX cycle is configured by the network.

1. In the case of CN initiated paging, the default cycle is broadcast in the SI.

2. In the case of CN initiated paging, a UE specific cycle may be set through NAS signaling.

3. In the case of RAN-initiated paging, the UE-specific cycle is set up through RRC signaling.

The UE uses the shortest cycle of the applicable DRX cycles, i.e., the UE of RRC_IDLE uses the shortest cycle of the first two cycles above, and the UE of RRC_INACTIVE uses the shortest cycle of the three cycles. The POs of the UE for CN-initiated paging and RAN-initiated paging are based on the same UE ID, and both POs overlap. The number of different POs in the DRX cycle may be configured through SI, and the network may distribute the UE to the corresponding PO according to the ID. In the case of RRC_CONNECTED, the UE monitors the paging channel at any PO signaled in the SI for SI change instruction and public warning system (PWS) notification. In the case of BA, the UE of RRC_CONNECTED monitors only the paging channel of the active BWP with the common search space established.
Paging optimization for UE in CM_IDLE: During UE context release, the NG-RAN node may provide the AMF with a recommended cell list and an NG-RAN node as auxiliary information for subsequent paging. The AMF may provide paging attempt information constituted of paging attempt count and intended number of paging attempt, and may include the next paging area scope. When the paging attempt information is included in the paging message, each paged NG-RAN node receives the same information during the paging attempt. The paging attempt count increases by 1 when a new paging attempt is made. The next paging area scope indicates whether the AMF plans to modify the currently selected paging area at the next paging attempt. If the UE changes the state to CM CONNECTED, the UE resets the paging attempt count.
Paging optimization for UE in RRC_INACTIVE: In RAN paging, the serving NG-RAN node provides RAN paging area information. The serving NG-RAN node may also provide RAN paging attempt information. Each paged NG-RAN node receives the same RAN paging attempt information when attempting paging with content such as the paging attempt count, intended number of paging attempts, and the next paging area scope. The paging attempt count increases by 1 when a new paging attempt is made. The next paging area scope indicates whether the serving NG_RAN node plans to modify the currently selected RAN paging area at the next paging attempt. When the UE is out of the RRC_INACTIVE state, the paging attempt count is reset.

The paging information is scheduled using DCI format 1_0, including CRC scrambled with P_RNTI, and transferred from the BS to the UE, and it may be possible to schedule the resources where the paging information is transferred through the components of Table 47 below.

```
TABLE 47
DCI format 1_0 is used for the scheduling of PDSCH in one DL cell.
The following information is transmitted by means of the DCI format 1_0 with CRC
scrambled by P-RNTI:
  Short Messages Indicator - 2 bits according to [Table 48].
  Short Messages - 8 bits, according to [Table 49]. If only the scheduling
  information for Paging, and TRS availability indication if trs-ResourceSetConfig
  is configured, are carried, this bit field is reserved.
  $Frequency domain resource assignment - ⌈ {log}_{2} ( {N}_{RB}^{DL , BWP} ( {N}_{RB}^{DL , BWP} + 1 ) / 2 ) ⌉$
  bits. If only the short message, and TRS availability indication if trs-
  ResourceSetConfig is configured, are carried, this bit field is reserved.
    ${N}_{RB}^{DL , BWP} is the size of CORESET 0$
  Time domain resource assignment - 4 bits as defined in Clause 5.1.2.1 of [6,
  TS38.214]. If only the short message, and TRS availability indication if trs-
ResourceSetConfig is configured, are carried, this bit field is reserved.
  VRB-to-PRB mapping - 1 bit according to [Table 48]. If only the short message,
  and TRS availability indication if trs-ResourceSetConfig is configured, are
carried, this bit field is reserved.
  Modulation and coding scheme - 5 bits as defined in [Table 49]. If only the short message,
  and TRS availability indication if trs-ResourceSetConfig is configured, are carried, this bit
  field is reserved.
  TB scaling - 2 bits as defined in [Table 50]. If only the short message, and TRS
  availability indication if trs-ResourceSetConfig is configured, are carried, this bit
  field is reserved.
  TRS availability indication - 1, 2, 3, 4, 5, or 6 bits, where the number of bits is
  equal to one plus the highest value of all the indBitID(s) provided by the trs-
  ResourceSetConfig if configured; 0 bits otherwise.
  Reserved bits - (8 − M) bits for operation in a cell with shared spectrum channel
  access in frequency range 1 or for operation in a cell in frequency range 2-2; (6 −
  M) bits for operation in a cell without shared spectrum channel access, where the
  value of M is the number of bits for the field of ′TRS availability indication′ as defined above.
```

In Table 47 above, the reserved bits field is an unlicensed band, but 8 bits are applied to FR2-2 while 6 bits are applied to the others, and the background of adopting the reserved bits field is to match the DCI format 1_0, including CRC scrambled with other RNTI, and the DCI overall size. Among the components of Table 47, the short messages indicator field constituted of two bits is a field for identifying the type of information transmitted through the DCI format 1_0 with P-RNTI and includes the contents of Table 48 below.

TABLE 48

| Bit | |
|---|---|
| field | Short Message indicator |
| 00 | Reserved |
| 01 | Only scheduling information for Paging, and TRS availability |
| | indication if trs-ResourceSetConfig is configured, are present |
| | in the DCI |
| 10 | Only short message, and TRS availability indication if trs- |
| | ResourceSetConfig is configured, are present in the DCI |
| 11 | Both scheduling information for Paging, TRS availability |
| | indication if trs-ResourceSetConfig is configured and short |
| | message are present in the DCI |

As for the paging information, according to Table 48, when the corresponding bit field indicates ‘01’ or ‘11’, paging-related scheduling information may be transferred from the BS to the UE through the corresponding DCI format. When indicating ‘10’, paging-related scheduling information is not transferred, and in this case, only the short messages information described in Table 49 below is transferred.

The short messages field constituted of 8 bits may or may not be transmitted along with paging information. If it is transmitted, it is transmitted based on the contents of Table 49. Bit 1 is the most significant bit (MSB).

TABLE 49

| Bit | Short Message |
|---|---|
| 1 | systemInfoModification |
| | If set to 1: indication of a BCCH modification other than SIB6, SIB7, SIB8 and |
| | posSIBs. |
| 2 | etwsAndCmasIndication |
| | If set to 1: indication of an ETWS primary notification and/or an ETWS |
| | secondary notification and/or a CMAS notification. |
| 3 | stopPagingMonitoring |
| | This bit can be used for only operation with shared spectrum channel access |
| | and if nrofPDCCH-MonitoringOccasionPerSSB-InPO is present. |
| | If set to 1: indication that the UE may stop monitoring PDCCH occasion(s) for |
| | paging in this Paging Occasion as specified in TS 38.304 [20], clause 7.1. |
| 4 | systemInfoModification-eDRX |
| | If set to 1: indication of a BCCH modification other than SIB6, SIB7, SIB8 and |
| | posSIBs. This indication applies only to UEs using IDLE eDRX cycle longer |
| | than the BCCH modification period. |
| 5-8 | Not used in this release of the specification, and shall be ignored by UE if |
| | received. |

Table 50, Table 51, and Table 52 below may be configured as follows.

Table 50 shows an example of VRB-to-PRB mapping, Table 51 shows an example of MCS index table 1 for PDSCH, and Table 52 shows an example of the scaling factor of Ninfo for P-RNTI.

TABLE 50

| Bit field mapped to index | VRB-to-PRB mapping |
|---|---|
| 0 | Non-interleaved |
| 1 | Interleaved |

TABLE 51

| MCS Index | Modulation | Target code Rate | Spectral |
|---|---|---|---|
| IMCS | Order Qm | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

TABLE 52

| TB scaling field | Scaling factor S |
|---|---|
| 00 | 1 |
| 01 | 0.5 |
| 10 | 0.25 |
| 11 | — |

### Description of Satellite Communication Structure

The characteristics of satellite communication are described below. Satellites for communication may be classified into low Earth orbit (LEO), middle Earth orbit (MEO), and geostationary Earth orbit (GEO) according to the orbit of the satellite. In general, a GEO may refer to a satellite with an altitude of about 36000 km, an MEO refers to a satellite with an altitude of 5000 to 15000 km, and an LEO refers to a satellite with an altitude of 500 to 1000 km. Of course, it is not limited to the examples described above. According to an embodiment, The period of orbiting the Earth varies depending on each altitude. The GEO has an orbital period of about 24 hours, the MEO with an orbital period of about 6 hours, and the LEO with an orbital period of about 90 to 120 minutes. LEO (below 2,000 km) satellites may have an advantage over geostationary orbit (36,000 km) satellites in terms of propagation delay (which may be understood as the time it takes for a signal transmitted from a transmitter to reach a receiver) and loss at their relatively low altitude.

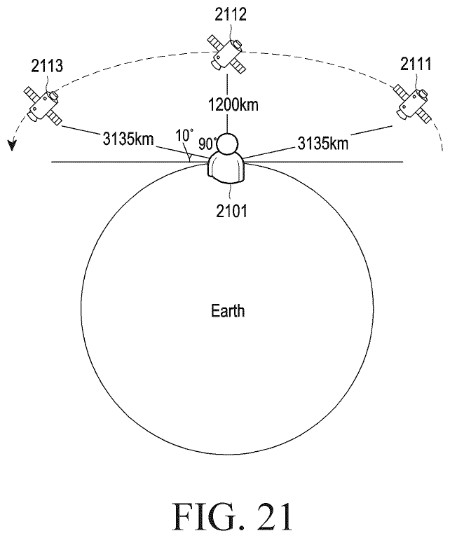

FIG. 21 illustrates the Earth orbital period of a communication satellite depending on the altitude or height of the satellite according to an embodiment.

Referring to FIG. 21, assuming that the UE 2101 communicates with a satellite positioned at an altitude of 1200 km, e.g., the distance between the UE and the satellite may vary according to the altitude angle between the satellite and the UE. For example, when the altitude angle between the satellite and the UE 2101 is 90 degrees (2112), the distance between the UE and the satellite is 1200 km, but when the altitude angle between the satellite 2101 is 10 degrees (2111 and 2113), the distance between the UE and the satellite is about 3135 km. Therefore, in satellite communication, even when the UE is fixed, the distance between the satellite and the UE may vary due to the satellite that periodically orbits like a low-orbit satellite.

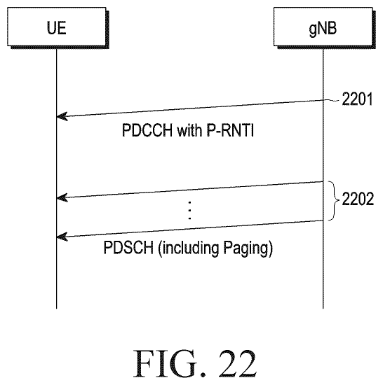

In general, satellite communication has a lower received signal strength than the ground network because the distance between the satellite and the UE is significantly farther than the ground network. Therefore, if the UE has data to transmit through the UL, the UE may perform UL communication by moving to an environment where satellite communication may be performed better, such as a line of sight (LOS) environment or a place where there are no obstacles around. However, the circumstance where the UE receives data transmitted from the satellite through the DL may not guarantee that it is always in an environment where satellite communication is smooth due to difficulty in determining when DL data is transmitted/received to/from the satellite. For example, the UE may be in a home in a remote environment or the UE may be stored in the user's belonging. Even in this situation, the satellite should be able to send data to the UE for DL data transmission. When the UE is in the RRC_IDLE state, paging triggers the RRC state switch to RRC_CONNECTED for DL data transmission/reception, and after receiving the paging from the satellite, the UE learns that DL data is coming to the UE. Therefore, satellite communication may require more reliable paging information transmission due to the above-described circumstances. Accordingly, in the disclosure, various methods for repeatedly transmitting paging as illustrated in FIG. 22 are described.

FIG. 22 illustrates an example of a method for repetitively transmitting UE paging information according to an embodiment. Referring to FIG. 22, the BS transmits a PDCCH having a P-RNTI to the UE in step 2201. In this case, information related to paging repetition may be provided to the UE through the PDCCH having the P-RNTI. In step 2202, the BS may repeatedly transmit the PDSCH including the paging to the UE based on the information indicated in step 2201. The information related to the paging repetition is illustrated in detail in the following embodiments.

Conventionally, in order for the UE to receive a paging signal, the UE identifies the synchronization of frequency and time resources by receiving one or more SSs. According to the identified time and frequency resources, the UE receives the paging signal transmitted by the BS. The paging signal includes control information and data information. If it is determined that the UE has data to receive through a DL through paging information reception, the UE switches from the RRC_IDLE state to the RRC_CONNECTED state. In a satellite communication environment, when the UE is present in a channel state where it is difficult to meet the control information and data information requirements for receiving the paging signal, it may be possible to separately consider when the SS may be received and when even the SS may not be received. When the UE may receive the SS, it may be possible for the UE to identify frequency and time resource synchronization through the SS and receive an independently reliable alert (notification) signal other than the above-described paging signal. Alternatively, when the UE may not receive the SS, the UE may receive a notification signal having a structure similar to or different from the SS. The notification signal may include at least one of a control signal, a data signal, or a SS. When the UE receives the notification signal, it may be possible to give the UE an alarm that there is DL data to send. The alarm information may be of a type such as a text message or pop-up information. After receiving the alarm, the UE may move to a place having a good channel state to perform the intended paging signal reception and then receive DL data. Alternatively, as is described below, the alarm signal may be included in the conventional paging signal and transferred from the BS to the UE.

In the following embodiments, the configuration information related to the repeated transmission of paging and the related DCI (e.g., DCI format 1_0 with P-RNTI) may be transmitted from the BS of the satellite or the ground BS to the UE. As an alternative embodiment, at least some of the configuration information and DCI related to repeated transmission of paging may be provided from the ground BS. The UE may receive configuration information and related DCI related to repeated transmission of paging from at least one BS, and receive paging repeatedly transmitted from the BS in the satellite. In the disclosure, the BS may be a satellite BS or a ground BS that relays data transmission/reception between the satellite and the UE.

### First Embodiment

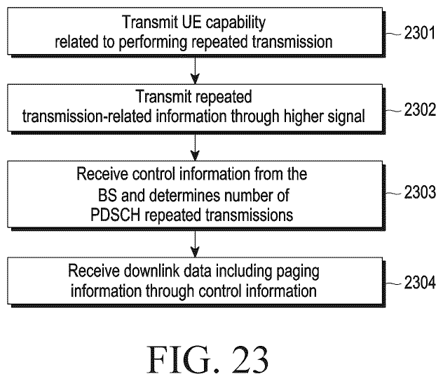

The first embodiment does not allow simultaneous configuration of TRS-related higher signal trs-ResourceSetConfig and paging information repeated transmission configuration-related higher signal paging repetition (or nᵣₑₚₑₜᵢₜᵢₒₙ) If trs-ResourceSetConfig is set in the DCI format 1_0 with P-RNTI, the paging repetition is not set, and in this case, the PDSCH including the paging information scheduled through the DCI format 1_0 is transmitted/received only once. In the DCI format 1_0 with P-RNTI, as in the embodiment of FIG. 23 to be described below, when paging repetition is set, the PDSCH including the paging information scheduled through the corresponding DCI format 10 repeatedly transmits the PDSCH containing the paging information as much as the number of slots (or the number of resources in a predetermined unit such as symbols/subframes/paging frames) of the value indicated through the paging repetition factor field set through the paging repetition. Specifically, it may be possible to change some of the components of DCI format 1_0 described above in Table 47 to include a paging repetition factor as shown in Table 53 below. The example in Table 53 is a method of subtracting the number of reserved bits by the number of bits used in the paging repetition factor. For example, if the paging repetition factor uses 2 bits, the number of reserved bits becomes 4 bits. If the paging repetition factor is set to 2 bits, the value of the paging repetition factor is indicated as 00, 01, 10 or 11 as shown below in Table 54, it may be possible to apply the number of paging repeated transmissions, such as 00 as one transmission of paging, 01 as repeated twice, 10 as repeated four times, 11 as repeated eight times, etc. Table 54 shows that the value indicated by the paging repetition factor may be determined by the value set by the higher signal paging repetition. As an alternative embodiment, it may be possible to fix the paging repetition factor to 1, 2, 4, or 8 instead of the example in Table 54. The corresponding method may be applied only in the first embodiment, or may be applied equally or similarly to other embodiments.

TABLE 53
. . .
TRS availability indication - 1, 2, 3, 4, 5, or 6 bits, where the number of bits is equal
to one plus the highest value of all the indBitID(s) provided by the trs-
ResourceSetConfig if configured; 0 bits otherwise.
Paging repetition factor - 1, . . . , X bits, where the number of bits is equal to
┌log₂(nᵣₑₚₑₜᵢₜᵢₒₙ)┐ where nᵣₑₚₑₜᵢₜᵢₒₙ is the number of repetition level by higher
layers if configured; 0 bits otherwise.
Reserved bits - (8 - M) bits for operation in a cell with shared spectrum channel
access in frequency range 1 or for operation in a cell in frequency range 2-2; (6 - M)
bits for operation in a cell without shared spectrum channel access, where the value
of M is the number of bits for the field of ‘TRS availability indication’ as defined
above; (6 - X) bits for operation in a cell without shared spectrum channel access,
where the value of X is the number of bits for the field of ‘Repetition factor’ as
defined above.

TABLE 54

| Index | Value |
|---|---|
| 00 | 1st value configured by high layer |
| | signaling paging repetition |
| 01 | 2nd value configured by high layer |
| | signaling paging repetition |
| 10 | 3rd value configured by high layer |
| | signaling paging repetition |
| 11 | 4th value configured by high layer |
| | signaling paging repetition |

### Second Embodiment

The second embodiment allows simultaneous configuration of TRS-related higher signal trs-ResourceSetConfig and paging information repeated transmission configuration-related higher signal paging repetition (or nᵣₑₚₑₜᵢₜᵢₒₙ). Since it is possible for TRS availability indication to use all of 6 bits of the licensed band, it may be possible to use the reserved bits field in a limited manner or to use fields other than the reserved bits field, and it may be possible to consider at least one or more of the following methods.

Method A-1: This is a method in which the sum of the number of bits of the TRS availability indication field set by TRS-related higher signal trs-ResourceSetConfig and the number of bits of the paging repetition factor field set by the paging information-related higher signal paging repetition does not exceed, e.g., 6 bits set as reserved bits. For example, if the number of bits in the TRS availability indication field is set to 4 bits, the number of bits in the paging repetition factor field is set only to a maximum of 2 bits. In this case, when the number of bits in the paging repetition factor field is 2 bits, it may be possible to apply the method described in the first embodiment. If the sum of the number of bits of the TRS availability indication field set by the TRS-related higher signal trs-ResourceSetConfig and the number of bits of the paging repetition factor field set by the paging information-related higher signal paging repetition exceeds 6 bits, the UE may consider this an error case, or may prioritize the TRS availability indication field or the paging repetition factor field. Prioritizing the TRS availability indication field may mean, e.g., that when the number of bits of the TRS availability indication field set by the TRS-related higher signal trs-ResourceSetConfig is set to 4, and the number of bits of the paging repetition factor field set by the paging information-related higher signal paging repetition is set to 3, the UE may assume that the number of bits of the TRS availability indication field is 4, and determine that the number of bits of the paging repetition factor field is actually 2. In other words, the number of bits of the paging repetition factor field may be determined so that the sum of the number of bits of the TRS availability indication field and the number of bits of the paging repetition factor field set by the paging information-related higher signal paging repetition does not exceed the number of reserved bits. In this case, the number of bits of the TRS availability indication field may be determined first or the number of bits of the paging repetition factor field may be determined first within the range of the sum of the numbers of bits. For example, the number of bits of the paging repetition factor field is set to 3, but in practice, only the first two bits (or the last two bits) are used to determine the paging repetition factor. Prioritizing the paging repetition factor field may mean, e.g., that when the number of bits of the TRS availability indication field set by the TRS-related higher signal trs-ResourceSetConfig is set to 4, and the number of bits of the paging repetition factor field set by the paging information-related higher signal paging repetition is set to 3, the UE may assume that the number of bits of the TRS availability indication field is actually 3, and determine that the number of bits of the paging repetition factor field is 3. In this case, the number of bits of the TRS availability indication field is set to 4, but in practice, the first three bits (or last three bits) are used to determine the TRS (group) resource information. When the number of bits of the TRS availability indication field is 4, four different TRS (group) resources may be configured, and four bits may be used to indicate whether to apply each. When fewer bits than four bits are used, the TRS (group) resource corresponding to the corresponding deactivated bit may be determined as always used (or scheduled) or as not used.

Method A-2: This is a method of providing a paging repetition factor using the MCS field in the DCI format 1_0 with P-RNTI other than the reserved bits field. For example, only 3 bits of the MCS field constituted of 5 bits indicate the MCS index corresponding to first MCS 0 to 7, and the remaining 2 bits are used to apply the paging repetition factor as shown above in Table 54. As another example, only 4 bits of the MCS field constituted of 5 bits indicate the MCS index corresponding to first MCS 0 to 7, and the remaining 1 bit is used to apply the paging repetition factor in a method similar to that of Table 54. For example, when the paging repetition factor is “0”, paging repetition is not performed, and when the paging repetition factor is “1”, paging repetition may be performed a predetermined number of times. As another example, when the paging repetition factor is “0”, paging repetition may be performed a predetermined first number of times, and if the paging repetition factor is “1”, paging repetition may be performed a predetermined second number of times.

Method A-3: This is a method of providing a paging repetition factor using anotherTDRA field in the DCI format 1_0 with P-RNTI other than the reserved bits field. For example, it may be possible to additionally provide a repetition factor value to be applied for each row index, in addition to providing the time resources of PDSCH in which paging information is transmitted/received through the conventional DCI format 1_0 with P-RNTI through the TDRA field. For example, conventionally, as shown below in Table 55, a specific row index indicated as the TDRA value together indicated ‘dmrs-TypeA-Position’ meaning DMRS symbol position information, ‘PDSCH mapping type’ indicating the PDSCH mapping type, offset ‘K0’ between the slot where the PDSCH is scheduled and the slot where the PDCCH indicating the corresponding PDSCH information is transmitted/received, start symbol ‘S’ of the PDSCH time resource, and PDSCH time resource length ‘L’. When paging information-related higher signal paging repetition configuration information is provided, the same value may be applied to each row index or different values may be applied separately. As shown in Table 55, the UE supporting this may receive a ‘repetition factor’ including the repeated transmission value of the PDSCH in which paging information is transmitted/received in addition to the conventional value and determine whether the PDSCH resource including paging information is repeatedly transmitted and the number thereof. In this case, the repeated transmission is slot level repeated transmission. In other words, the start symbol and the length of the PDSCH are the same for each repeatedly transmitted slot. Table 55 is a modification of the above Table 44 example according to an embodiment to include the ‘repetition factor’ including the repeated transmission value of the PDSCH. The example values (“a” to “j”) of the ‘repetition factor’ in Table 55 represent an example, and various values (or indexes corresponding to the values) may be indicated based on a higher signal (configuration information) related to repeated transmission of paging information.

TABLE 55

| Row | dmrs-TypeA- | PDSCH | | | | Repetition |
|---|---|---|---|---|---|---|
| index | Position | mapping type | K₀ | S | L | factor |
| 1 | 2 | Type A | 0 | 2 | 12 | a |
| | 3 | Type A | 0 | 3 | 11 | b |
| 2 | 2 | Type A | 0 | 2 | 10 | c |
| | 3 | Type A | 0 | 3 | 9 | d |
| 3 | 2 | Type A | 0 | 2 | 9 | e |
| | 3 | Type A | 0 | 3 | 8 | f |
| 4 | 2 | Type A | 0 | 2 | 7 | g |
| | 3 | Type A | 0 | 3 | 6 | h |
| 5 | 2 | Type A | 0 | 2 | 5 | i |
| | 3 | Type A | 0 | 3 | 4 | j |
| . . . | . . . | . . . | . . . | . . . | . . . | . . . |

Method A-4: This is a method of providing a paging repetition factor using anotherTDRA field in the DCI format 1_0 with P-RNTI other than the reserved bits field. This differs from method A-3 in that for the TDRA field conventionally constituted of four bits, only three or two bits are used while the other one or two bits are used to provide the paging repetition factor. Since the TDRA field is reduced from four bits as conventional to two bits or three bits, the indicatable row index range is reduced, so that it needs be defined which row index value is indicated. Simply, when the TDRA field has two bits, it is possible to indicate row index 1 to 4 and, when the TDRA field has three bits, it is possible to indicate row index 1 to 8. Alternatively, it is possible to first select the row index with the largest L value to reconfigure Table 55.

Method A-5: This is a method of providing a paging repetition factor using another TB scaling field in the DCI format 1_0 with P-RNTI other than the reserved bits field. As in Table 52 above, ‘11’ of the existing TB scaling field is not currently used so that the corresponding value may be used to indicate the repetition factor. For example, if the TB scaling field is indicated as ‘11’, it is possible to determine that the PDSCH including paging information by the value in which the higher signal repetition factor is set is repeatedly transmitted/received.

Method A-6: This is a method of providing a paging repetition factor using another short message field in the DCI format 1_0 with P-RNTI other than the reserved bits field. As in Table 49 above, since a total of four bits from the fifth bit to the eighth bit of the existing short message field are not currently used, the corresponding value may be used to indicate the repetition factor. For example, it is possible to indicate four repetition factors using two bits thereof. In this case, it is possible to use the fifth and sixth bits or the seventh or eighth bits. The bit value may be determined considering the number of repeated transmissions set by the higher signal repetition factor and may be set and indicated as described in the first embodiment.

FIG. 23 is a flowchart illustrating a procedure of receiving PUSCH repeated transmission including paging information according to an embodiment. In the example of FIG. 23, it is assumed that the UE receives DL data including paging information from a satellite. In the example of FIG. 23, the BS may be a satellite BS or a ground BS. As an alternative embodiment, at least some or all of the repeated transmission-related configuration information and DCI for paging information may be provided to the UE from the ground BS, and the UE capability information related to repeated transmission of paging may be transmitted to the satellite BS or the ground BS. It is also possible for the satellite BS and the ground BS to interwork for repeated paging transmission to the UE.

Referring to FIG. 23, in step 2301, the UE reports corresponding UE capability information to the BS when supporting at least one of the methods proposed in the first to second embodiments described above. The UE capability information may be transmitted by the UE to the satellite BS or the ground BS. Operation 2301 may be selectively performed. Thereafter, in step 2302, the UE receives, from the BS, higher signal configuration information related to repeated transmission of paging information. In the example of FIG. 23, it is illustrated that step 2302 is performed after step 2301, but the operation sequence of the disclosure is not limited thereto. Step 2302 may be performed first, and step 2301 may be performed.

In step 2303, if the UE receives the DCI format 1_0 with P-RNTI from the BS and determines that the DCI format contains paging information through, e.g., a short message indicator, the UE determines the number of PDSCH repeated transmissions containing paging information by at least one, or a combination of some, of the methods described in the first and second embodiments. That is, the base station indicates whether repeatedly transmit downlink data including paging information through downlink control information. In step 2304, the UE receives DL data from the BS in the PDSCH resource area indicated by the control information and detects paging information. Accordingly, the UE may determine whether UE information thereof is included or whether there is information to be received by the UE.

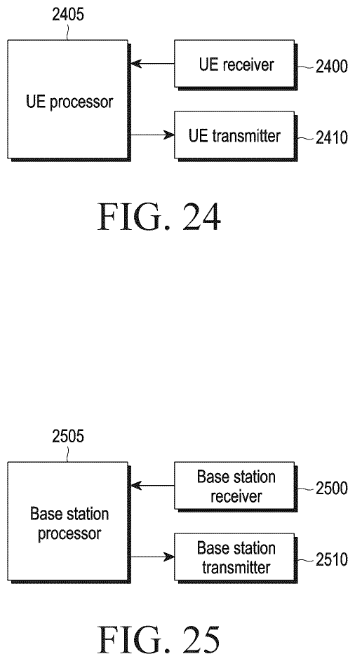

FIG. 24 illustrates a structure of a UE in a wireless/satellite communication system according to an embodiment.

Referring to FIG. 24, a UE may include a transceiver including a UE receiver 2400 and a UE transmitter 2410, memory (not shown), and a UE processing unit 2405 (or a UE controller or processor). According to at least one of the communication methods described in FIGS. 1 to 23 of the UE, the transceiver 2400 and 2410 of the UE, the memory and the UE processor 2405 may operate. However, the components of the UE are not limited thereto. For example, the UE may include more or fewer components than the above-described components. The transceiver, memory, and processor may be implemented in the form of one chip.

The transceiver may transmit or receive signals to/from the BS. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver.

The transceiver may receive a signal through a radio channel, output it to the processor, and transmit a signal output from the processor through the radio channel.

The memory may store programs and data necessary for the operation of the UE. The memory may store control information or data that is included in the signal transmitted/received by the UE. The memory may include a storage medium, such as read-only memory (ROM), random access memory (RAM), hard disk, compact disc (CD)-ROM, and digital versatile disc (DVD), or a combination of storage media. There may be provided a plurality of memories.

The processor may control a series of processes so that the UE may operate according to at least one of the embodiments of FIGS. 1 to 23. For example, the processor may control UE operations of receiving DCI and repeated transmission-related configuration information about paging information from the BS in the satellite communication system and receiving the repeatedly transmitted paging information based on the configuration information and the DCI. There may be a plurality of processors. The processor may perform control operations on the component(s) of the UE by executing a program stored in the memory.

FIG. 25 illustrates a structure of a BS in a wireless/satellite communication system according to an embodiment. The BS of FIG. 25 may be a satellite BS or a ground BS. The BS may be a ground BS that receives data from the satellite and relays it to the UE.

Referring to FIG. 25, the BS may include a transceiver including a BS receiver 2500 and a BS transmitter 2510, memory (not shown), and a BS processing unit 2505 (or a BS controller or processor). According to of the communication methods described above in FIGS. 1 to 23 of the BS described above, the transceiver 2500 and 2510 of the BS, the memory and the BS processor 2505 may operate. However, the components of the BS are not limited thereto. For example, the BS may include more or fewer components than the above-described components. The transceiver, memory, and processor may be implemented in the form of one chip.

The transceiver may transmit or receive signals to/from the UE. The signal may include control information and data. To that end, the transceiver may include an RF transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver.

The transceiver may receive a signal through a radio channel, output it to the processor, and transmit a signal output from the processor through the radio channel.

The memory may store programs and data necessary for the operation of the BS/satellite. The memory may store control information or data that is included in the signal transmitted/received by the BS/satellite. The memory may include a storage medium, such as ROM, RAM, hard disk, CD-ROM, and DVD, or a combination of storage media. There may be provided a plurality of memories.

The processor may control a series of processes for the BS to operate according to the above-described embodiments. For example, the processor may control operations of transmitting, to the UE, DCI and repeated transmission-related configuration information about paging information from the BS in the satellite communication system and repeatedly transmitting paging information to the UE based on the configuration information and the DCI. Each component of the BS may be controlled. There may be a plurality of processors. The processor may perform control operations on the component(s) of the BS by executing a program stored in the memory.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in RA memories, non-volatile memories including flash memories, ROMs, electrically erasable programmable read-only memories (EEPROMs), magnetic disc storage devices, compact-disc ROMs, DVDs, or other types of optical storage devices, or magnetic cassettes. The programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

As used herein, the singular forms “a,” “an,” and “the” are intended to include the plural forms as well, unless the context clearly indicates otherwise.

The embodiments described herein may be practiced in combination. For example, the BS and the UE may be operated in a combination of parts of an embodiment and another embodiment. For example, some of the first and second embodiments of the disclosure may partially be combined and be operated by the BS and the UE. Although the above-described embodiments are suggested based on the FDD LTE system, other modifications based on the technical spirit of the above-described embodiments may be implemented in other systems, such as TDD LTE systems or 5G or NR systems.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method by a user equipment (UE) in a satellite communication system, the method comprising:
receiving, from a network, first configuration information related to repeated transmission of paging information;
receiving, from the network, downlink control information indicating the repeated transmissions of the paging information and a number of the repeated transmissions based on the first configuration information; and
receiving, from the network, the paging information repeatedly transmitted by the number of the repeated transmissions based on the DCI.

2. The method of claim 1, wherein the network includes at least one of a base station of a satellite and a base station on a ground.

3. The method of claim 1, further comprising transmitting, to the network, UE capability information indicating whether to support the repeated transmissions of the paging information.

4. The method of claim 1, wherein the first configuration information is not simultaneously configured for the UE with second configuration information related to a tracking reference signal.

5. The method of claim 1, wherein the DCI includes a paging repetition field in a determined DCI format using a paging-radio network temporary identifier (P-RNTI),
wherein the paging repetition field is allocated using at least some of reserved bits in the DCI format, and
wherein a number of paging repetitions corresponds to a value of the paging repetition field among a plurality of repetitions indicatable in the first configuration information.

6. The method of claim 1, wherein the first configuration information is simultaneously configurable for the UE with second configuration information related to a tracking reference signal (TRS),
wherein the DCI includes a paging repetition field in a determined DCI format using a P-RNTI,
wherein the determined DCI format includes a TRS-related field indicating TRS availability, and
wherein a number of bits of the paging repetition field is determined so that a sum of a number of bits of the paging repetition field and a number of bits of the TRS-related field is less than or equal to a number of reserved bits.

7. The method of claim 1, wherein the DCI includes a paging repetition field in a determined DCI format using a paging-radio network temporary identifier (P-RNTI), and
wherein the paging repetition field is allocated using some of bits of a modulation coding scheme field in the determined DCI format or a time domain resource assignment field in the determined DCI.

8. A user equipment (UE) in a satellite communication system, the UE comprising:
a transceiver; and
at least one processor configured to:
receive, from a network, first configuration information related to repeated transmission of paging information,
receive, from the network, downlink control information (DCI) indicating the repeated transmissions of the paging information and a number of the repeated transmissions based on the first configuration information, and
receive, from the network, the paging information repeatedly transmitted by the number of the repeated transmissions based on the DCI.

9. The UE of claim 8, wherein the network includes at least one of a base station of a satellite and a base station on a ground.

10. The UE of claim 8, wherein the processor is further configured to transmit, to the network, UE capability information related to whether to support the repeated transmission of the paging information.

11. The UE of claim 8, wherein the first configuration information is not simultaneously configured for the UE with second configuration information related to a tracking reference signal.

12. The UE of claim 8, wherein the DCI includes a paging repetition field in a determined DCI format using a paging-radio network temporary identifier,
wherein the paging repetition field is allocated using at least some of reserved bits in the DCI format, and
wherein a number of paging repetitions corresponds to a value of the paging repetition field among a plurality of numbers of repetitions indicatable in the first configuration information.

13. The UE of claim 8, wherein the first configuration information is simultaneously configurable for the UE with second configuration information related to a tracking reference signal (TRS),
wherein the DCI includes a paging repetition field in a determined DCI format using a paging-radio network temporary identifier (P-RNTI),
wherein the determined DCI format includes a TRS-related field indicating TRS availability, and
wherein a number of bits of the paging repetition field is determined so that a sum of a number of bits of the paging repetition field and a number of bits of the TRS-related field is less than or equal to a number of reserved bits.

14. The UE of claim 8, wherein the DCI includes a paging repetition field in a determined DCI format using a paging-radio network temporary identifier, and
wherein the paging repetition field is allocated using some of bits of a modulation coding scheme field in the determined DCI format or a time domain resource assignment (TDRA) field in the determined DCI.

15. A method by a base station in a satellite communication system, the method comprising:
transmitting, to a user equipment (UE), first configuration information related to repeated transmission of paging information;
transmitting, to the UE, downlink control information (DCI) indicating the repeated transmissions of the paging information and a number of repeated transmissions based on the first configuration information; and
repeatedly transmitting, to the UE, the paging information by the number of repeated transmissions based on the DCI.

16. The method of claim 15, further comprising receiving, from the UE, UE capability information indicating whether to support the repeated transmissions of the paging information.

17. The method of claim 15, wherein the base station includes at least one of a base station of a satellite and a base station on a ground.

18. A base station (BS) in a satellite communication system, the BS comprising:
a transceiver; and
at least one processor configured to:
transmit, to a user equipment (UE), first configuration information related to repeated transmission of paging information,
transmit, to the UE, downlink control information (DCI) indicating the repeated transmissions of the paging information and a number of repeated transmissions based on the first configuration information, and
repeatedly transmit, to the UE, the paging information by the number of repeated transmissions based on the DCI.

19. The BS of claim 18, wherein the processor is further configured to receive, from the UE, UE capability information indicating whether to support the repeated transmissions of the paging information.

20. The BS of claim 18, wherein the base station includes at least one of a base station of a satellite and a base station on a ground.
